(19) United States
(12) Patent Application Publication
(10) Pub. No.: US 2011/0302412 A1
(43) Pub. Date: Dec. 8, 2011

(54) PSEUDONYMOUS PUBLIC KEYS BASED AUTHENTICATION

(76) Inventors: Leiwen Deng, Redmond, WA (US); Aleksandar Kuzmanovic, Evanston, IL (US)

(21) Appl. No.: 13/154,125

(22) Filed: Jun. 6, 2011

Related U.S. Application Data
(63) Continuation-in-part of application No. 12/569,401, filed on Sep. 29, 2009.
(60) Provisional application No. 61/103,672, filed on Oct. 8, 2008.
(60) Provisional application No. 61/351,721, filed on Jun. 4, 2010.

(51) Int. Cl. H04L 9/32

(52) U.S. Cl. 713/159; 713/155

(57) ABSTRACT

Systems and methods for pseudonymous public keys based authentication are described that enable an authentication to achieve pseudonymity and non-repudiation, for example, at the same time. Pseudonymity may provide, for example, that a user can show to different parties different digital identifiers for authentication instead of, for example, always using a single digital identifier everywhere, which may lead to a breach of privacy. Non-repudiation may provide, for example, that the authentication data at the server side can be used, for example, to verify a user's authentication request, but not to generate an authentication request, which might lead to user impersonation. A user may use a physical token to generate the authentication request corresponding to the user's identity to pass the authentication.

### CROSS-REFERENCE TO RELATED APPLICATIONS/INCORPORATION BY REFERENCE

This patent application is a continuation-in-part of U.S. patent application Ser. No. 12/569,401, filed Sep. 29, 2009, which claims priority to and claims benefit from U.S. Patent Application No. 61/103,672, filed Oct. 8, 2008.

This patent application claims priority to and claims benefit from U.S. Patent Application No. 61/351,721, filed Jun. 4, 2010.

The above-referenced applications are hereby incorporated by reference herein in their entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Some aspects of some embodiments of the present invention may relate to pseudonymous public keys and, in particular, pseudonymous public keys based authentication.

### BRIEF SUMMARY OF THE INVENTION

Some embodiments according to the present invention may provide, for example, pseudonymous public keys based authentication that enables an authentication to achieve pseudonymity and non-repudiation, for example, at the same time. In some embodiments, pseudonymity may provide, for example, that a user can show to different parties different digital identifiers for authentication instead of, for example, always using a single digital identifier everywhere, which may lead to a breach of privacy. In some embodiments, non-repudiation may provide, for example, that the authentication data at the server side can be used, for example, to verify a user's authentication request, but not to generate an authentication request, which might lead to user impersonation. In some embodiments, for example, only the user who owns a specific physical token can generate the authentication request corresponding to his or her identity to pass the authentication.

Some embodiments according to the present invention may provide, for example, enablement of pseudonymity. Single sign-on solutions such as, for example, OpenID, Windows CardSpace, and VeriSign unified authentication and Google single sign-on provide that each user show the same user identifier (e.g., the OpenID identifier) to all places. A concern for such an approach is the potential breach of user privacy when this approach is widely used. When the same user identifier is widely used at many places, it may become trivial to disclose a user's real identity. Although the user identifier does not directly disclose a user's real identity, it may become equivalent to a user's real identity in practice. Once a mapping between this single user identifier and the user's real identity is available online, the user's real identity then becomes disclosed everywhere. Because the single user identifier is widely used at many places, it may be too easy to have the above mapping leaked to the Internet under some situations such as intentional attacks by criminals or unintentional technical mistakes.

In some embodiments according to the present invention, retaining pseudonymity may be useful for a single sign-on solution to be practical if it is targeted to be widely adopted on the Internet. In some embodiments, for example, a user may be allowed to show different identifiers to different places. The different identifiers for the same user may be unlinkable to each other. Thus, even if a mapping between a specific user identifier, for example, at a specific place and the user's real identity is leaked online, it will not lead to the disclosure of the user's real identity at any other places, thereby protecting the user's privacy. Some embodiments may provide, for example, a unique solution that achieves this pseudonymity property for authentication.

Some embodiments according to the present invention may provide, for example, enablement of independency. Single sign-on solutions follow the “identity provider and relying parties” model in which a user registers at a trusted third party, called an identity provider, and then becomes capable to authenticate to many sites that are the relying parties of this identity provider. Indeed, when a user authenticates to a relying party, the user gets redirected to the identity provider. In some embodiments, the actual authentication is performed at the identity provider. The relying party may depend on the identity provider for each authentication transaction.

The above dependency may be undesirable for a site, for example, that acts as the relying party, and even unacceptable in many situations, e.g., for e-Commerce sites. Such sites want the full control of the user authentication process instead of having each authentication transaction intervened by a third party (e.g., the identity provider). Therefore, a solution that can make independency and single sign-on coexist may be desirable.

Some embodiments according to the present invention may provide, for example, that independency and single sign-on coexist. Some embodiments may provide, for example, that each relying party gains full control of every authentication transaction without the intervention of any third party while it can still use the single sign-on.

Some embodiments according to the present invention may provide, for example, enablement of high security. In a single sign-on, for example, the single account that a user registers becomes the user's “master key” with which the user has the access to everywhere. But this also implies that if this “master key” is getting compromised, everything is compromised. Therefore, single sign-on should demand much higher security requirements for the “master key” due to the sensitivity of the key in comparison with a traditional user account. In some embodiments, the pseudonymous public keys cryptography enables non-repudiation and high security for the authentication, while retaining pseudonymity at the same time.

Some embodiments according to the present invention may provide, for example, high scalability without compromising high security. In some embodiments, to improve online service scalability, replica servers are added. IDnet Mesh, for example, follows this approach to achieve high scalability for its authentication service. However, the replica server approach could be at a cost of reduced security if the authentication data replicated to these servers are sensitive. The more replica servers added, the higher the chance that sensitive data might be compromised and the lower the security.

Some embodiments according to the present invention provide, for example, assistance to IDnet Mesh, for example, to solve such conflicts, thereby making authentication data stored on replica servers to be insensitive. In some embodiments, such data might be used to verify a user's identity, but not to generate authentication messages, for example, that can pass such a verification. Therefore, criminals are unable to use such data for user impersonation when the data are compromised. Furthermore, such data do not reveal any information about who a user is and are highly insensitive. Accordingly, the IDnet Mesh's authentication service can easily scale to serve, for example, billions of Internet users through large scale replication. It can also be made resilient to distributed denial-of-service (DDoS) attacks due to this high scalability.

Some embodiments according to the present invention may provide, for example, low cost. The insensitivity of the authentication data stored on replica servers also makes it possible to use cheap computing resources to deploy the IDnet Mesh's authentication system. For example, some embodiments use inexpensive commodity servers or rent cheaper computing resources provided by third parties, e.g., leased servers or the Amazon Elastic Compute Cloud (Amazon EC2). The low deployment cost is an attractive property of the system in practice.

Some embodiments according to the present invention may provide, for example, all of the above properties and/or features at the same time. Some embodiments may provide, for example, the enablement of at least the above five properties. These properties typically conflict easily with each other especially when enabled at the same time, thereby making such an approach quite challenging. However, some embodiments that enable at least the above five properties provide, for example, enablement of an Internet-wide user authentication solution that characterized by, for example, pseudonymity, high security, and high scalability, all at the same time.

Some embodiments according to the present invention may find application in, for example, secure online payment systems, other eCommerce systems, eID systems, cross-realm authentication, and/or large scale Internet-wide authentication systems.

Some embodiments according to the present invention may find employment in, for example, online payment industry, eCommerce and/or eID industry, ISPs, and/or cloud computing providers.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 shows pseudonymous authentication in IDnet Mesh according to some embodiments of the present invention.

FIG. 2 shows accountable accounts, unique accounts and home accounts according to some embodiments of the present invention.

FIG. 3 shows scalable authentication architecture of an IDnet according to some embodiments of the present invention.

FIG. 4 shows forming the IDnet Mesh according to some embodiments of the present invention.

FIG. 5 shows trustee, trust and validation areas according to some embodiments of the present invention.

FIG. 6 shows Internet passport implementation examples according to some embodiments of the present invention.

FIG. 7 shows offline and online validations according to some embodiments of the present invention.

FIG. 8 shows IDnet protocols according to some embodiments of the present invention.

FIG. 9 shows a processing time benchmark for identity validation algorithm according to some embodiments of the present invention.

FIG. 10 shows a processing time benchmark for another identity validation algorithm according to some embodiments of the present invention.

FIG. 11 shows an Internet passport implementation according to some embodiments of the present invention.

FIG. 12 shows a Feitian .NET smart-card according to some embodiments of the present invention.

FIG. 13 shows a format of IDnet protocol messages according to some embodiments of the present invention.

FIG. 14 shows message bodies of IDnet system protocol messages according to some embodiments of the present invention.

FIG. 15 shows message bodies of identity validation messages according to some embodiments of the present invention.

FIG. 16 shows client software—AuthAgent—according to some embodiments of the present invention.

FIG. 17 shows an exemplary login page according to some embodiments of the present invention.

FIG. 18 shows an exemplary system structure according to some embodiments of the present invention.

FIG. 19 shows an exemplary web interface for managing IDnet A's user database at IDnet A according to some embodiments of the present invention.

FIG. 20 shows an exemplary web interface for managing IDnet A's user database at edge agent A₁ according to some embodiments of the present invention.

FIG. 21 shows an exemplary web interface for managing IDnet A's user database at edge agent A₂ according to some embodiments of the present invention.

FIG. 22 shows an exemplary web interface for managing IDnet A's user database at IDnet C according to some embodiments of the present invention.

FIG. 23 shows an exemplary web interface for managing IDnet A's user database at edge agent C₁ according to some embodiments of the present invention.

FIG. 24 shows an exemplary summary of Internet passport features according to some embodiments of the present invention.

### DETAILED DESCRIPTION OF THE INVENTION

Some embodiments according to the present invention provide, for example, Internet architectures that hide a user's real identity by design, which is a factor contributing to the Internet's great success. However, as the Internet is quickly moving towards the mainstream of the societies, it is also raising tremendous problems on a daily basis because there are no effective means to enable user accountability. Some embodiments according to the present invention provide, for example, the building of a trust zone on the Internet, in which Internet-wide user accountability can be enabled for applications where the trust and true collaboration among individuals outweigh other values. In addition, some embodiments also provide for preserving user privacy on the Internet.

Some embodiments according to the present invention provide, for example, IDnet Mesh. According to some embodiments, IDnet Mesh provides a distributed Internet-wide user authentication infrastructure that serves as the gateway to the trust zone. It offers to validate two types of user accountability as the basis of trust. The first type of accountability allows an anonymous user to be deanonymized to his or her real identity when a dispute (e.g., a crime) arises; it can help to enforce global policies, including laws and other commonly accepted policies. The second type of accountability offers to counter Sybil attacks; it can help to enforce non-global policies, including subjective policies specific to each application provider. Meanwhile, to be qualified as a basic Internet-wide infrastructure, the IDnet Mesh is also designed to provide high service scalability and reliability, including: (i) to be scalable to serve potentially billions of Internet users, (ii) to withstand high volumes of service requests, and (iii) to be resilient to distributed denial-of-service (DDoS) attacks. In addition, the deployment of the IDnet Mesh can be fully incremental. Accordingly, some embodiments of the present invention provide that no changes to the existing Internet infrastructure and protocols are required and that modifications stay at the application layer.

Preface

“One account per user” can change the cyber-world. One account per user at a system is a powerful policy that numerous Web sites desire. For example:

Sites like Threadless.com that use voting to get the consensus of individuals can make their voting results much more trustworthy if the one account per user policy can be applied, since no single user would be able to subvert a result by registering a large number of accounts for the voting.

Likewise, sites like Amazon and eBay that rank products by averaging the scores provided by public reviewers can use this policy to ensure that their results are not biased.

Social networking sites like Facebook and MySpace can use this policy to effectively deter cyber bullies, spammers, and vandals, thereby significantly improving the quality of their services. On one hand, the one account per user policy makes it much easier to identify a rogue user (e.g., a cyber bully, spammer, or vandal) since the rogue user can no longer separate his acts across many different accounts in order to avoid triggering the alarm. On the other hand, once an identified rogue user is blocked by the site, he is really blocked, since it is impossible for him to create another account to bypass the blocking due to the enforcement of one account per user.

Though tempting, no existing solutions on the Internet so far can enforce this powerful policy for such sites. Some embodiments according to the present invention provide, for example, IDnet Mesh which provides, for example, a novel platform for Web sites to trade unique accounts of users. Hence, the one account per user policy can be enforced for each of the sites as a result of their common effort. This is somewhat akin to the way P2P creates the miracle of high performance file sharing as a result of individuals' common effect. For example, suppose there are 1000 sites; each site creates 100 unique accounts and contributes them to the platform; as a result, each of them can acquire as many as 99,900 additional unique accounts in return. Each site creates the unique account of a user by performing rigorous verification on a user's real identity to ensure that a single physical user can only create one such account. While creating unique accounts for all 100,000 users by a site itself is an enormous job that few would think possible, to create unique accounts for only a small subset, e.g., 100 of the 100,000 users, is usually an achievable task.

Some embodiments according to the present invention provide, for example, IDnet Mesh which can make possible lots of advanced applications including one or more of the following: an application that enables trust between online employees and employers so work can be found and performed online without having to expose identity information to either party; an application that enables entrepreneurs to find and contract with trusted subject matter experts (SMEs) in other countries without ever meeting them face-to-face; an application that enables peace of mind when an online relationship becomes a real life date; an advanced social networking service, for example, a virtual real society, where the trust and true collaboration among people who never met before become possible; an application that enables the protection of teenagers from online predators; an application that enables the suppression of online job scams; an application that preserves Internet user anonymity and enforces Internet user liability; and a common service that protects Web sites from distributed denial-of-service (DDoS) attacks.

Enforcing one account per user is just one example of the powerful functionalities that the IDnet Mesh can provide according to some embodiments of the present invention. Some embodiments of the present invention provide, for example, the IDnet Mesh provides one or more of the following: forensic evidence of liable users such that it can effectively deter online crimes; preservation of each user's pseudonymity unless he or she is involved in a crime; enablement of secure Internet single sign-on tools so that a user no longer needs to create and remember different passwords for different sites, but instead, the user can easily log in to many different sites using a cheap, secure, and easy to use smart-card based Internet passport; the IDnet Mesh platform that is a reliable distributed system that offers high system fault tolerance; the IDnet Mesh platform that is highly scalable—it can scale to serve billions of Internet users, for example; the IDnet Mesh's service that is highly resilient to distributed denial-of-service (DDoS) attacks; the IDnet Mesh's service that is highly secure and/or resilient to eavesdropping, man-in-the-middle attacks, replay attacks, and/or IP spoofing attacks; non-repudiation for user authentication; and the IDnet Mesh's deployment that can be fully incremental in which there are no changes to the existing Internet infrastructure and protocols and in which modifications stay at the application layer.

Some embodiments according to the present invention provide, for example, IDnet Mesh for use in enabling advanced applications in a trust zone such as, for example, a virtual real society, online jobs, advanced online gaming, and advanced knowledge sharing and online research and education systems.

Overall, these advanced applications can branch from their existing counterparts on the current Internet and evolve towards a very different direction from that of their counterparts. These advanced applications can form a new cyber-world, namely, a trust zone. The trust zone can exist in parallel with the legacy Internet. For example, the applications that remain in the legacy Internet can focus on features that rely heavily on censorship-free speech and creativity of individuals. See, e.g., Lawrence Lessig, The Future of Ideas: The Fate of the Commons in a Connected World, Random House Inc., October 2001; Lawrence Lessig, Free Culture: How Big Media Uses Technology and the Law to Lock Down Culture and Control Creativity, The Penguin Press, March 2004) whereas the ones in the trust zone evolve towards brand new applications that rely heavily on collaboration of individuals and trust. See, e.g., Lisa Alfredson and Nuno Themudo, Virtual trust: Challenges and strategies in internet based mobilization, in International Studies Association 48th Annual Convention, Chicago, Ill., February 2007, http://www.allacademic.com/meta/p178920_index.html; A. Abdul-Rahman and S. Hailes, Supporting trust in virtual communities, in Hawaii International Conference on System Sciences, Maui, Hi., January 2000; J. Carter and A. A. Ghorbani, Towards a formalization of trust, Web Intelligence and Agent Systems, 2004; J. Donath, Identity and deception in the virtual community, M Smith and P. Kollock (Eds.), Communities in Cyberspace, 1998; S. Grabner-Krauter and E. A. Kaluscha, Empirical research in on-line trust: A review and critical assessment, International Journal of Human Computer Studies, vol. 58, no. 6, pp. 783-812, 2003; H. Lee, Privacy, publicity, and accountability of self-presentation in an on-line discussion group, Sociological Inquiry, vol. 76, no. 1, pp. 1-22, 2006; Y. D. Wang and H. H. Emurian, An overview of online trust: concepts, elements and implications, Computers in Human Behavior, vol. 21, no. 1, pp. 105-125, 2005.

Some embodiments according to the present invention provide, for example, a virtual real society that evolves from the current social networking service. It solves at least two problems that popular social networking sites are currently facing—age check and interoperability.

There has been mounting pressure from law enforcement and parents on age check at social networking sites, e.g., Facebook and MySpace. Such sites have grown exponentially in recent years, with teenagers making up a large part of their membership. This has created a new venue for sexual predators who lie about their ages to lure young victims and for cyber bullies who send threatening and anonymous messages. However, social networking sites are facing significant difficulty to implement the age check. See, e.g., MySpace to tighten security, http://www.knoxnews.com/news/2008/Jan/15/myspace-to-tighten-security/; Conn. bill would force MySpace age check, http://www.msnbc.msn.com/id/17502005/. With the IDnet Mesh, such sites can effectively enforce the regulation of age check in the trust zone.

There are also mounting demands for interoperability among social networking sites. A recent World Wide Web Consortium (W3C) report (see, e.g., W3C: Interoperability key to social networking) pointed out that the growth of social networking sites is hindered by a lack of interoperability, including the ability to share user profiles and data across networks, such that companies can offer new Web 2.0 applications. The IDnet Mesh can provide a comprehensive solution to the interoperability.

In addition, this application can gradually incorporate more and more elements from the real society due to the regulation feasibility provided by the IDnet Mesh. As such, it could eventually enable real society features in the virtual world where users can experience in parallel diversified types of innovative social modes and relations.

Some embodiments according to the present invention provide, for example, can be used to facilitate online jobs.

The Internet creates a large number of online job opportunities where people can enjoy the convenience of working at home, e.g., customer support jobs at lots of online stores, rewarded online survey, and online tutoring, etc. At the same time, however, there are also lots of concerns relating to scams. See, e.g., Work-at-home job scams, http://money.cnn.com/2009/02/12/pf/saving/toptips_jobscams_willis/index.htm; and Too good to be true?, http://edition.cnn.com/2006/US/Careers/10/02/cb.scams/. A worker that wants to show an employer his trustworthiness (e.g., to trust that he will take responsibility of the job) may have to disclose his real identity information. But by doing this, he could take the risk that the employer might turn out to be a malicious party who makes use of the worker's real identity for crimes. See, e.g., Internet crime schemes—Reshipping, http://www.ic3.gov/crimeschemes.aspx#item-16; and Online job scammers steal millions, http://www.msnbc.msn.com/id/3730401/.

The IDnet Mesh provides a solution that allows a worker to show his trustworthiness to an employer without having to disclose any real identity information to the employer. This may facilitate online jobs to flourish. Online jobs can be a complement to the traditional jobs. They are particularly suitable for volatile jobs, e.g., to temporarily recruit a large number of Internet workers to help deter the quick spread of a copyright infringing object or to clean a piece of fake news that has been widely republished at a large number of websites. For example, an almost finished copy of the popular movie, X-Men Origins: Wolverine, was leaked online a month before its cinema release recently. And the copies were found to propagate at such a swift rate that the digital cops could not keep up in an effort to deter the spread.

Some embodiments according to the present invention provide, for example, advanced online gaming.

Policies that address virtual economy and virtual crimes in online games (e.g., Second Life) tend to be imperative since the virtual assets are no longer virtual—they can be traded for real world money. See, e.g., Trade Second Life currencies via the VirWox API, http://blog.programmableweb.com/2009/01/02/trade-second-life-currencies-via-the-virwoxapi/; Sean F. Kane, Virtual wealth management, New Jersey Law Journal, September 2006, http://www.virtualjudgment.com/images/stories/NJ_Law_Journal November_{—}2006.pdf.; Virtual knockoffs, http://www.insidecounsel.com/Issues/2008/March%202008/Pages/Virtual-Knockoffs.aspx. The IDnet Mesh can facilitate such policies at online game providers.

Moreover, by facilitating user management, the IDnet Mesh allows online game providers to add brand new features in their games aggressively (which results in more chances of bugs) without worrying much about that a potential bug would cause a severe outcome. A bug in an online game might be deliberately abused by many players to disrupt the fairness of game (hence a severe outcome) if there are no effective solution to react to liable players out of the game. The IDnet Mesh makes such out-of-game liability possible.

For example, a bug in EverQuest II (see EverQuest II, http://everquest2.station.sony.com/) made possible for players to duplicate valuable virtual items. Before the bug could be stamped out, the resulting glut of counterfeit goods swamped the game's internal market and drove inflation of its currency up by 20%. See, e.g., Counterfeit goods rock virtual world, http://www.newscientist.com/article/dn7846.

Some embodiments according to the present invention provide for advanced knowledge sharing and online research and education systems, for example.

Search engines (e.g., Google and Bing) make the Internet an indispensable knowledge retrieval platform. The rising Web 2.0 based knowledge market applications (e.g., Yahoo! Answers) exploit the abundant human resources available online to distribute knowledge in a more effective way than relying mainly on computer AIs. The IDnet Mesh enables an advanced knowledge market that allows people to share knowledge resources in very effective and creative ways through interactive collaboration. Spammers and vandals in such collaborative systems can be deterred. People can take duties for their respective roles in the system to contribute knowledge resources and to manage the collaboration. Related to this and the above online jobs discussions, the IDnet Mesh can fundamentally redefine the online consulting area.

The IDnet Mesh can also have a tremendous impact on large-scale shared online systems for academic research and education. See, e.g., NSF: Cyberinfrastructure: A grand convergence, http://www.nsf.govinews/special_reports/cyber/agrand.jsp. Such infrastructures allow experiments with human participants to move out of the small-group laboratory into the cyberlab with the possibility of thousands of participants interacting across different countries and cultures. IDnet Mesh's ability to accurately tie human identities in real and cyber-worlds can dramatically reduce the cost of such labs.

In addition, it also makes possible online systems for a multi-stakeholder engagement process (see, e.g., Karlson Charlie Hargroves et al, The Natural Advantage of Nations (Vol. I): Business Opportunities, Innovation and Governance in the 21st Century—Chapter 23: Achieving Multi-stakeholder Engagement, Earthscan/James & James, January 2005) for topics. Such a process usually faces challenges from three aspects: (i) it requires contributions from all parties—research communities of different areas (e.g., natural science and technology, sociology, law, etc), governments, businesses, civil societies, and international bodies; (ii) it creates unprecedented demands for learning, thinking, planning and decision-making (e.g., through voting); and (iii) initiatives seeking a solution are often doing so under a sense of time urgency, with limited resources. Time and/or money should not go to waste on suboptimal solutions or difficult-to-achieve agreements.

Some embodiments according to the present invention provide, for example, single sign-on which might be much more than a single registration.

Single sign-on, or unified authentication, is the authentication approach that allows a user to register only once and then become capable to authenticate to many different systems; ideally, it would be register once and authenticate to everywhere. In this way, the user no longer wastes time on registration at different systems; meanwhile he no longer needs to remember and type in different usernames and passwords when he logins at different systems. This improves Internet users' online experience. However, what underlies single sign-on is much more than the above single registration concept. In order to make a single sign-on solution practical, at least three properties should be addressed as shown below.

High security. In single sign-on, the single account that a user registers becomes his master key with which he has the access to everywhere. But this also implies that if this master key is compromised, everything is compromised. Therefore, single sign-on demands much higher security requirements for this master key due to the sensitivity of this key comparing with a traditional user account.

Pseudonymity. Existing single sign-on solutions such as OpenID (see, e.g., OpenID, http://openid.net/) have each user show the same user identifier (e.g., the OpenID identifier) to all places. A concern for such an approach is the potential breach of user privacy when this approach is widely used. When the same user identifier is widely used at many places, it becomes trivial to disclose a user's real identity. Although the user identifier itself does not directly disclose a user's real identity, it could become equivalent to a user's real identity in practice. Once a mapping between this single user identifier and the user's real identity is available online, the user's real identity then becomes disclosed everywhere. Because this single user identifier is widely used at many places, it can be easy to have the above mapping leaked to the Internet under situations such as, for example, either intentional attacks by criminals or unintentional technical mistakes at some places.

As such, retaining pseudonymity is useful for a single sign-on solution to be practical if it is targeted to be widely adopted on the Internet. That is, a user should be allowed to show different identifiers to different places and these different identifiers for the same user should be unlinkable to each other. In this way, even a mapping between a specific user identifier (at a specific place) and the user's real identity is leaked online, it will not disclose the user's real identity at any other places, thereby protecting the user's privacy.

Independency. Existing single sign-on solutions such as OpenID all follow the identity provider and relying parties model—a user registers at a trusted third party called identity provider and then becomes capable to authenticate to many sites who are the relying parties of this identity provider. Indeed, when a user authenticates to a relying party, he gets redirected to the identity provider. The actual authentication is always performed at the identity provider. This means that the relying party is always depending on the identity provider for each authentication transaction.

Sometimes such a dependency is undesirable for a site (e.g., that plays as the relying party) and even unacceptable in many situations, e.g., for e-Commerce sites. Such sites want the full control of the user authentication process instead of having each authentication transaction intervened by a third party (e.g., the identity provider). If the above dependency is a trade-off that a site has to take in order to benefit from the single sign-on, this section would not be written here. According to some embodiments of the present invention, the IDnet Mesh technology proposed in this application achieves a technical breakthrough that allows the independency and the single sign-on to coexist—each relying party can gain full control of every authentication transaction without the intervention of any third party while it can still use the single sign-on.

The IDnet Mesh provides a unique physical-token-based single sign-on solution that achieves all the above three properties at the same time. In some embodiments according to the present invention, the above three properties are essential. In addition, the IDnet Mesh offers the following two properties that make the solution practical to deploy.

High scalability without compromising high security. A common approach to improve online service scalability is to add replica servers. IDnet Mesh follows this approach to achieve high scalability for its authentication service. However, the replica server approach could be at a cost of reduced security if the authentication data replicated to these servers are sensitive. The more replica servers added, the higher the chance that sensitive data might be compromised, hence the lower the security.

The IDnet Mesh solves the above conflict through a cryptographic design of the authentication algorithm, thereby making authentication data stored on replica servers to be insensitive. Such data can be used to verify a user' identity (e.g., only to verify a user's identity), but not to generate authentication messages that can pass such a verification. Therefore, criminals are unable to use such data for user impersonation when the data are compromised. Furthermore, such data even do not reveal any information about who a user is, hence are highly insensitive. Due to this property, the IDnet Mesh's authentication service can easily scale to serve millions or billions of Internet users through large scale replication. It can also be made resilient to distributed denial-of-service (DDoS) attacks due to this high scalability.

Low cost. The insensitivity of the authentication data stored on replica servers also makes it possible to use cheap computing resources to deploy the IDnet Mesh's authentication system. For example, inexpensive commodity servers can be used or cheaper computing resources provided by third parties, e.g., leased servers or the Amazon Elastic Compute Cloud (Amazon EC2). See, e.g., Amazon elastic compute cloud (Amazon EC2), http://aws.amazon.com/ec2/. The low deployment cost is another attractive property of the IDnet Mesh system in practice.

### 1. PREFACE AND INTRODUCTORY REMARKS

On the Internet, nobody knows you're a dog, states Peter Steiner's famous New Yorker cartoon. See, e.g., New Yorker, http://www.unc.edu/depts/jomc/academics/dri/idog.html.) Sixteen years have passed since this cartoon was first published, and things have not changed. Indeed, the Internet architecture hides a user's real identity by design. Such a design, though fostered the great success of the Internet, is also raising tremendous problems on a daily basis as the Internet is quickly moving towards the mainstream of the societies.

For example, social-networking sites such as Facebook and MySpace have grown exponentially in recent years. However, as teenagers are making up a large part of their membership, these sites have created a new venue for online predators to lure young victims and for cyber bullies to send threatening and anonymous messages. Although there has been mounting pressure from law enforcement and parents for years, social-networking sites are experiencing tremendous technical difficulties to protect youngsters. See, e.g., MySpace to tighten security, http://www.knoxnews.com/news/2008/Jan/15/myspace-to-tighten-security/; Conn. bill would force MySpace age check, http://www.msnbc.msn.com/id/17502005/.

Online scamming is another example. An alert email sent from your bank asking for your response to unusual activities in your credit account could turn out to be a forged email that is trying to phish your credit card information. Numerous scams occur in the online job area (see, e.g., Work-at-home job scams, http://money.cnn.com/2009/02/12/pf/saving/toptips_jobscams_willis/index.htm; Too good to be true?, http://edition.cnn.com/2006/US/Careers/10/02/cb.scams/) though the Internet does create many real online job opportunities which allow people to enjoy the convenience of working at home (e.g., customer support jobs at a large number of online stores). For example, an online employer who registered a worker's real identity may turn out be a malicious party who makes use of the worker's real identity for crimes. See, e.g., Internet crime schemes—Reshipping, http://www.ic3.gov/crimeschemes.aspx#item-16.

The rising Web 2.0 applications (see, e.g., Tim O'Reilly, What is Web 2.0, O'Reilly Network, September 2005) are also hindered by the Internet's design for their growth. Vandals and spammers could pose significant threats to blogs or Wikis. Reviews at a shopping site can be easily forged or biased as a result of flogs. See, e.g., What we should learn from Sony's fake blog fiasco, http://adage.com/smallagency/post?article_id=113945. True collaboration among users at a site is hard to foster due to the difficulty of trust. Overall, the Internet lacks a way to hold a user accountable.

Some embodiments according to the present invention contemplate designing and deploying a global-scale user accountability solution for the Internet.

Some embodiments according to the present invention contemplate enabling user accountability at the global scale while preserving user pseudonymity at the same time on the Internet.

Some embodiments according to the present invention contemplate being scalable, reliable, and secure at the same time in practice.

Some embodiments according to the present invention contemplate that a clean-slate new Internet is not required and some embodiments according to the present invention contemplate a deployment that can be fully incremental on the current Internet.

A version of today's Internet model, which fosters complete user anonymity without any accountability, will always be present in some form in the future. However, there is a demand for a new Internet (e.g., the trust zone), the one in which true collaboration among people that never met in person becomes reality, in which children are protected from online predators and cyber bullies, or in which it is possible to sign anonymous business agreements to show your trustworthiness and engage in online jobs without fear of scams.

For sure users will be given the freedom to choose between the two worlds, and the aim of my research is to provide an entrance to the new one, e.g., the trust zone. The IDnet mesh technology is a “key” to this entrance. In some embodiments according to the present invention, the IDnet Mesh takes incremental deployability as a first-order criterion in its design. It aims to deploy a trust zone on the legacy Internet and to allow the deployment to be fully incremental—no changes to the existing Internet infrastructure and protocols are required and modifications stay at the application layer. Some embodiments of the present invention contemplate that the trust zone coexists in parallel with the legacy Internet and that users can freely choose applications across the two worlds on the fly.

Some embodiments according to the present invention contemplate a distributed internet-wide user authentication infrastructure for accountability.

In some embodiments, IDnet Mesh is a distributed Internet-wide user authentication infrastructure. It provides to the public a common identity validation service. This service, at a first glance, looks similar to unified authentication services such as OpenID (see, e.g., OpeniD, http://openid.net/), Google single sign-on (see, e.g., SAML single sign-on (SSO) service for Google apps, http://code.google.com/apis/apps/sso/sam1_reference_implementation.html), Windows CardSpace (see, e.g., Introducing Windows CardSpace, http://msdn.microsoft.com/en-us/library/aa480189.aspx), VeriSign unified authentication (see, e.g., VeriSign unified authentication (white paper), http://www.verisign.com/static/016549.pdf), and Kerberos cross realm authentication (see Kerberos, http://web.mit.edu/Kerberos/). However, it differs from these counterparts in a number of ways including its authentication semantics. Instead of authenticating a user for access permission to a specific application, the identity validation service authenticates for a claim that is commonly required by applications in the trust zone, that is, whether a user is accountable. Whereas, further access permission to each application can be authenticated independently from the identity validation. The IDnet Mesh defines at least two types of accountability of a user as will be discussed below. Such accountability serves as the basis to trust a user.

In addition, as the identity validation service plays such a substantial role (e.g., a common gateway to all applications) for the trust zone, it ensures a very high service scalability and reliability. This includes (i) to be scalable to authenticate potentially millions or billions of Internet users, (ii) to withstand therefore high volumes of service requests, and (iii) to be resilient to distributed denial-of-service (DDoS) attacks.

Some embodiments according to the present invention contemplate that the IDnet Mesh system defines at least two types of accountability as the basis of trust: type-1 accountability and type-2 accountability.

Type-1 accountability—deanonymizability. Type-1 accountability contemplates that a user's identity can be deanonymized to his or her real identity. In normal cases, a user shows up at an application provider with a one-time temporary identity, TID, and is thereby kept anonymous after the identity validation. When a dispute (e.g., a crime) arises, the TID however can be used as the forensic evidence, from which the user can be deanoymized to his or her real identity with the cooperation of the IDnet Mesh.

Type-2 accountability—Sybil resiliency. Type-2 accountability contemplates the assurance that a user cannot perform Sybil attacks (see, e.g., John Douceur, The Sybil attack, in IPTPS 2002), for example, to register a large number of accounts to circumvent the blacklist at an application provider. To achieve this, an application provider can acquire from the IDnet Mesh a Sybil resilient alias of the user in addition to the TID. The Sybil resilient alias for the same user at the same application provider is guaranteed to be quasi-unique, e.g., the same user can only have a very limited number of such aliases.

One distinct advantage of type-2 accountability over type-1 accountability is that it can support non-global policies, including even subjective policies specific to each application provider. This is because an application provider can react to a user in question based on its policy without the cooperation of third parties in the IDnet Mesh. For example, it can simply blacklist the user using the Sybil resilient alias. By contrast, type-1 accountability is likely to be used only to enforce global policies, including laws and other commonly accepted polices since the deanonymization requires the cooperation of third parties in the IDnet Mesh.

Some embodiments according to the present invention contemplate a central technical approach.

At a low level, two innovative techniques constitute the central technical approach, pseudonymous authentication, of the IDnet Mesh system. The pseudonymous authentication makes feasible for the first time an Internet-wide user authentication solution that asks for pseudonymity, high security, and high scalability all at the same time. First, a cryptographic-hash-based approach offers efficient prescreen for the pseudonymous authentication. Secondly, a novel public key cryptography scheme called pseudonymous public keys proposed in this dissertation enables non-repudiation for the pseudonymous authentication and makes possible high scalability of the authentication without compromising high security. This technique of using pseudonymous public keys is in itself a substantial contribution to modern cryptography.

The rest of the written description will introduce the basic design of the IDnet Mesh system and analyze the system's security. Meanwhile, it is respectfully submitted that the aforementioned pseudonymous public keys technique can add strict non-repudiation to the identity validation service while preserving a user's pseudonymity at the same time. The written disclosure also evaluates the performance of the IDnet Mesh in terms of scalability, efficiency, and reliability. The evaluation is based on a prototype implementation of the IDnet Mesh system and the analytical model of a very large scale IDnet Mesh. The IDnet Mesh system is also evaluated by comparing with a related work. Prototype implementation details, evaluation methodology details, and IDnet Mesh's real identity binding approaches in practice are also disclosed.

### 2. IDnet MESH FRAMEWORK

In this section, the basic design of the IDnet Mesh system is described. Some embodiments according to the present invention contemplate the system's central technical approach—pseudonymous authentication (Section 2.1). Exploitation of this approach (1) enables the user accountability within the IDnet Mesh system itself (Section 2.2) and (ii) builds a scalable and reliable authentication architecture with low cost (Section 2.3). Next an IDnet Mesh is described that can be formed by gradually merging systems of independent parties based on the pseudonymous authentication approach (Section 2.4). After that, the identity validation service that the IDnet Mesh provides is introduced. The user accountability to applications that use this service (Section 2.5) is described. Finally, the IDnet Mesh's protocols (Section 2.6) are described.

2.1. Pseudonymous Authentication

Some embodiments according to the present invention contemplate that IDnet Mesh uses a central technical approach—pseudonymous authentication. It enables unified user authentication in a similar way to solutions such as OpeniD—a user can register an account at a single system while gain access to many other independent systems with the same account. Meanwhile, it is able to protect user privacy by preserving a user's pseudonymity. To do this, it disables (e.g., by default) the identifiability (e.g., linkability) on the same user's digital identities across different places. For easy understanding, here it is explained in contrast with the OpenID's authentication approach (see, e.g., OpeniD, http://openid.net/). A more detailed explanation relating to preserving pseudonymity is can be found in Section 3.1.1.

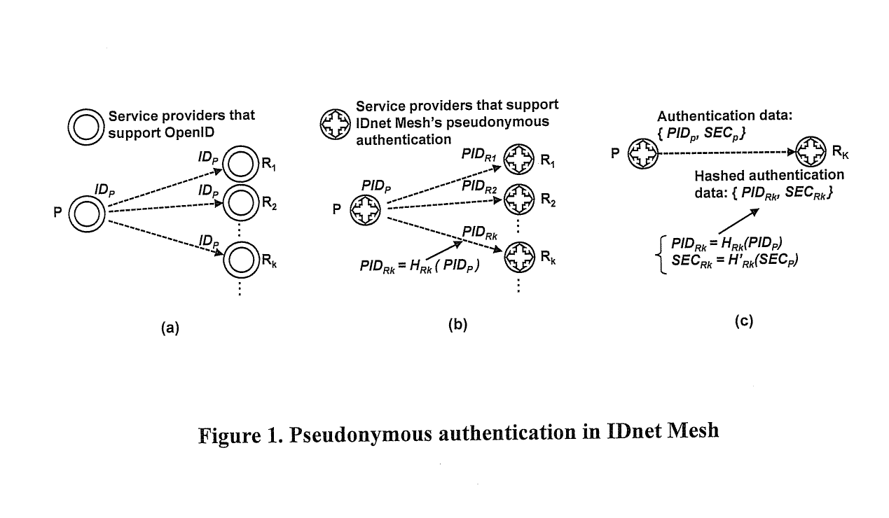

FIG. 1(a) shows the OpenID scenario. A user has registered an account at an identity provider P. P issues the user an OpenID identifier IDp, with which the user can login to a number of P's relying parties Rₖ (k=1, 2, . . . ). During the login, the user shows each relying party the same digital identity, e.g., IDp. This implies that after the login the relying parties automatically acquire the identifiability on this user—they can easily identify this user among them based on IDp. This property is undesirable when the same account is widely used at many places since it is too easy to link together the user's actions thereby breaching his or her privacy.

FIG. 1(b) shows the IDnet Mesh scenario. Similar to the OpenID, with an account registered at the identity provider P, the user can login to any relying parties of P. For the IDnet Mesh scenario, the login actually means to pass the identity validation. However, the difference here is that the user shows up at each relying party Rₖ with a different digital identity, therefore the identifiability is disabled by default. Denote by PIDp (stands for permanent identity) the user's digital identity at P. Likewise, denote by PIDRₖ the user's digital identity at each relying party Rₖ. PIDRₖ is derived from PIDp (as shown in the figure) by applying a cryptographic hash function HRₖ. The hash function HRₖ for each different relying party Rₖ is different. In addition, when HRₖ is based on a conflict-free (with a very high probability) hash function such as SHA-1, PIDRₖ can bear a one-to-one mapping with PIDp. This is the basis to enable the identifiability later when it is used, e.g., to trace back a criminal.

Another essential difference is the place where a user does the actual authentication. In the OpenID scenario, when a user logins to a relying party Rₖ, Rₖ has to redirect the user to the identity provider P and the actual authentication is always performed at P. However, in the IDnet Mesh scenario, the authentication can also be performed at the relying party Rₖ locally without any involvement of P.

To achieve this, P exports to Rₖ in advance a hashed version of the user's authentication data. As shown in FIG. 1(c), the user's authentication data at P are in form of the 2-tuple {PID_{P}, SEC_{P}}. Here, SEC_{P} is the user's secret code (e.g., functions like a password). Likewise, the user's hashed authentication data exported to Rₖ are in form of the 2-tuple {PIDRₖ, SECRₖ}. SECRₖ is derived from SEC_{P} the same way as PIDRₖ is derived from PIDp except that a different hash function H′Rₖ is used. With the hashed authentication data, Rₖ can perform the user authentication locally. A user authentication algorithm of this approach will be described in Section 2.5.

Indeed, by importing the hashed authentication data from P, Rₖ has actually created accounts at its own place for users. Let's call such accounts the linked accounts of the corresponding accounts at P; or alternatively, we say that they are linked from those accounts at P.

2.2. Enabling the Accountability.

It is now described how the accountability within the IDnet Mesh system is enabled by exploiting the pseudonymous authentication approach. This is a basis for the IDnet Mesh to further provide the accountability to those applications in the trust zone that use its identity validation service.

2.2.1. The Model Assumption—Home IDnet.

Call each administratively independent party that supports the IDnet Mesh system an IDnet. The assumption of my model to enable the accountability of a specific user is that there exists an IDnet that holds the user's real identity. This IDnet is then called the user's home IDnet. And the user is called the IDnet's home user. In practice, a home IDnet could be a city clerk's office, any business (e.g., a bank, a phone company) that does real identity registration for their customers, or any community (e.g., a school) that does rigorous identity verification for their members, etc. A more detailed explanation on how a home IDnet can acquire a user's real identity in practice is described in Section 6.3.

2.2.2. Three Types of User Accounts.

My model involves the concepts of three types of user accounts: unique accounts, home accounts, and accountable accounts.

Unique accounts are the type of accounts that follow the one account per user rule, e.g., each physical user can only have one unique account at an IDnet P. Home account is a user's account at his or her home IDnet. Home accounts are the basis of unique accounts. First, a home account of P is a unique account of P. The uniqueness can be enforced based on the user's real identity. Secondly, the home accounts of P can have their linked accounts at a relying party R. These linked accounts are also unique accounts of P (note: not unique accounts of R).

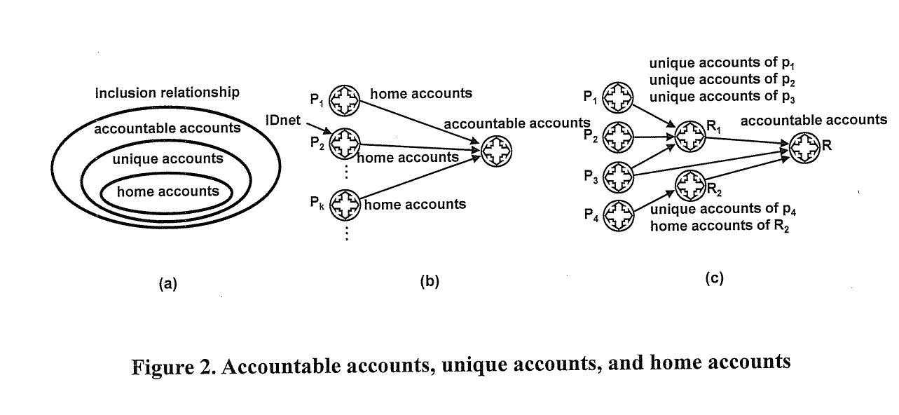

Accountable accounts are derived from unique accounts. For a specific IDnet R, its accountable accounts include (i) the unique accounts of R and (ii) accounts linked from other IDnets' unique accounts. For example, in FIG. 2(b), R is a relying party of several other IDnets Pₖ (k=1, 2, . . . ). Pₖ each has some home accounts (which are its unique accounts as well). Then the accounts at R linked from the home accounts of Pₖ can constitute the accountable accounts of R.

FIG. 2(c) shows a slightly different example, in which R's accountable accounts consist of (i) linked accounts of P₁, P₂, and P₄'s unique accounts and (ii) linked accounts of P₃ and R₂'s home accounts. P₁ and P₂'s unique accounts are provided by R₁ in form of linked accounts of P₁ and P₂'s home accounts. P4's unique accounts are provided by R2 in a similar way. The accountable accounts of R may also include R's own home accounts. Moreover, in this example, R₁ also have P₃'s unique accounts, and R can have linked accounts of them. But R does not include these linked accounts as its accountable accounts in order to eliminate duplicates since it already has linked accounts of P₃'s unique accounts via P₃ itself.

2.2.3. Supporting Type-1 Accountability.

Because accountable accounts are (either directly or indirectly) linked from home accounts, they support type-1 accountability (e.g., deanonymizability). (Recall that link implies a one-to-one mapping between a pair of accounts as introduced in Section 2.1.) Using an accountable account as the forensic evidence, a user can be deanoymized to his or her real identity with the cooperation of the home IDnet.

2.2.4. Supporting Type-2 Accountability.

The accountable accounts at an IDnet are not necessarily unique; however, they will be quasi-unique in most cases. They therefore support the type-2 accountability (e.g., Sybil resiliency) as well. The reason that they will be quasi-unique is because each user can only have a very limited number of accountable accounts and this number is bounded by the number of his or her home IDnets. Since a home IDnet requires a user to do real identity registration, the user will only select parties that it trusts most as the home IDnets. The number of such parties is very limited. Meanwhile, different home IDnets may collaborate to identify home accounts that belong to the same user based on the user's real identity. Such collaboration can help improve the uniqueness of the accountable accounts that are linked from these home accounts.

2.3. Robust Authentication Architecture with Low Cost.

The pseudonymous authentication approach also enables an IDnet to deploy a robust authentication system with low cost. This is a basis to meet the IDnet Mesh's design criteria of providing high service scalability and reliability as introduced in Section 1. The robustness includes (i) to allow an IDnet to be scalable to register potentially a large number (e.g., up to billions) of users and provide authentication service for them, (ii) to withstand therefore high volumes of service requests, and (iii) to be resilient to DDoS attacks.

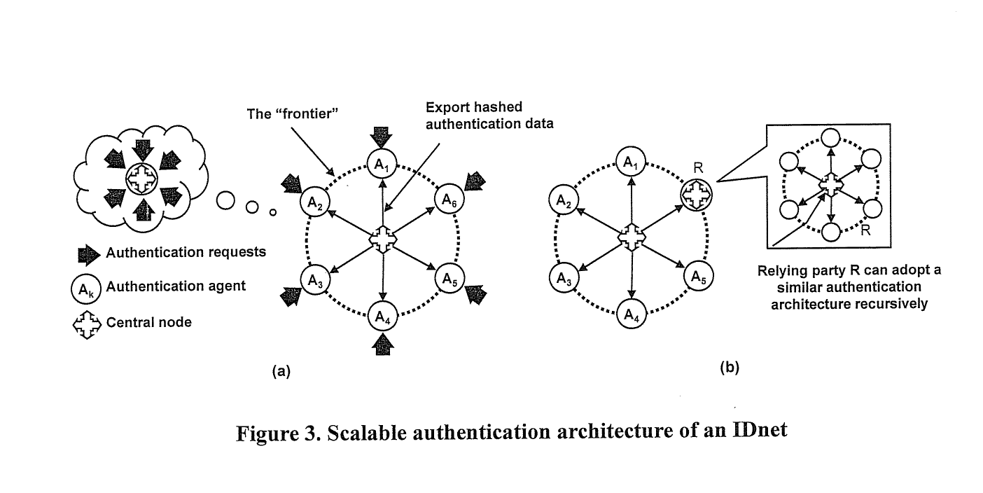

At each IDnet, the authentication requests (e.g., the identity validation requests) from the public are handled at an authentication agent, which can scale from a single server to a datacenter consisting of a large-scale server farm. In general, an IDnet can deploy multiple authentication agents. As shown in FIG. 3(a), these authentication agents can form a frontier that is capable to withstand large volumes of untrusted service requests (including those from DDoS attacks) and only let trusted service traffic (associated with the accountable accounts) to go through to access the trust zone (details of this process will be explained in Section 2.5 and 3.2). Each authentication agent Aₖ stores a different hashed copy of all users' authentication data, with which it can authenticate the users. In addition to the scalability, the adoption of multiple authentication agents also offers a high service availability through the system redundancy.

Since the authentication agents only store hashed authentication data, the data sensitivity is significantly reduced (this will be explained in more details in Section 3.1.3). Therefore, it is highly feasible for an IDnet to deploy its authentication front ends in large scales using cheaper computing resources provided by, for example, leased servers or the Amazon Elastic Compute Cloud (Amazon EC2) (see, e.g., Amazon elastic compute cloud (Amazon EC2), http://aws.amazon.com/ec2/). In particular, as shown in FIG. 3(b), an IDnet can even use the relying parties as its authentication agents and each relying party can adopt a similar authentication architecture recursively. This substantially raises the service scalability and reliability. Thus, the IDnet can deploy a robust authentication system with very low cost.

2.4. Forming the IDnet Mesh.

2.4.1. IDnet Merging.

The IDnet Mesh is formed by gradually merging IDnets. There are at least two types of merging.

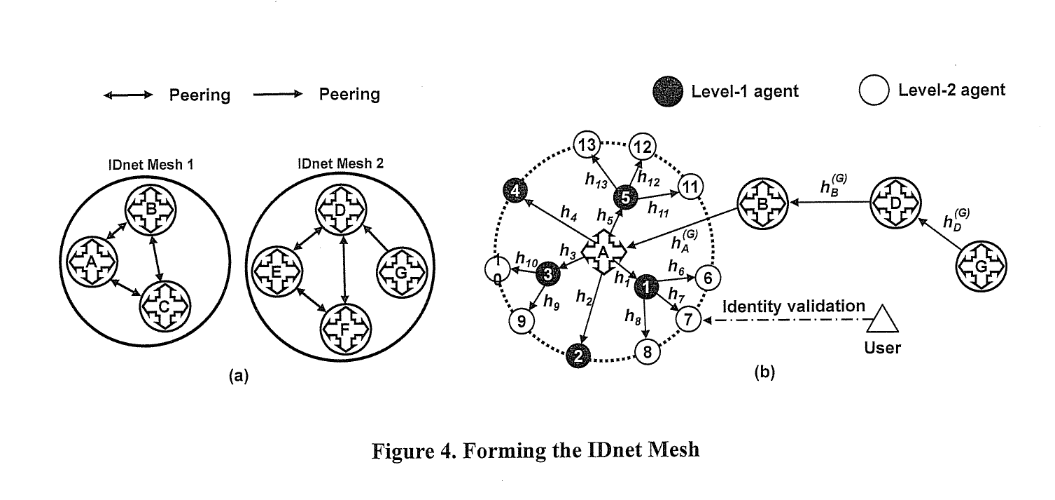

Peering. The first type is peering, in which two IDnets export to each other the hashed authentication data such that they can share (all or part of) the accountable accounts that each has. Such accountable accounts can be the home accounts of their own and accounts that are linked from other IDnets. For example, in FIG. 4(a), IDnets A, B, and C each peer with the others, thereby forming IDnet Mesh 1. IDnet Mesh 1 is further merged with IDnet Mesh 2 through the peering between IDnets B and D, and the peering between IDnets C and F, thereby forming a larger IDnet Mesh.

Feeding. The second type of merging is feeding, in which the exporting of authentication data is unilateral rather than being mutual as in the peering scenario. The merging from IDnet G to IDnet D in FIG. 4(a) shows such an example. Consider that G is a party such as a bank, a city clerk's office, or a school that is specialized in managing users' real identities and therefore can have a large number of home users. However, G does not have its own scalable authentication architecture. Therefore, it chooses to export hashed authentication data to IDnet D, which provides such an authentication architecture professionally. In this way, G can offer scalable authentication service for its home users by using D's infrastructure while D benefits from acquiring a lot of accountable accounts by linking from G's home accounts.

2.4.2. Exporting Across IDnets.

When exporting the hashed authentication data, a pair of hash functions are used, one for hashing the permanent identity PID, the other for hashing the secret code SEC. Referring to FIG. 4(b), suppose that the authentication data at G for each home user are {PID_{G}, SEC_{S}}, and G uses the pair of hash functions {h_{D}^{(G)}, h′_{D}^{(G)}} to export the data to D. Then the hashed authentication data at D become {h_{D}^{(G)}, (PID_{G}), h′_{D}^{(G)}(SEC_{G})}.

Next, D can further export the data to B, and B can further export the data to A. For simplicity, only consider PID here. Suppose the corresponding hash functions used for the exporting are as marked in FIG. 4(b), e.g. h_{D}^{(G)} from G to D, h_{B}^{(G)} from D to B, h_{A}^{(G)} from B to A. Denote by PID_{A7}^{(G)} the PID at A for an account linked from G, then PID_{A7}^{(G)}=h_{A}^{(G)}h_{B}^{(G)}h_{D}^{(G)}(PID_{G}). SEC is computed the same way except that a different hash chain is used.

2.4.3. Exporting Within an IDnet.

When authentication data reach the central node of an IDnet, they are further exported to all authentication agents of the IDnet in order to support identity validation. In a general model, the authentication agents are organized in a hierarchical structure. Taking IDnet A in FIG. 4(b) for example, it has a two-level hierarchy. The authentication data are therefore exported by following this hierarchy—from the central node to level-1 agents, and from each level-1 agent to its downstream level-2 agents. Each exporting uses a different pair of hash functions and each agent therefore receives a different hashed copy of the authentication data.

For example, suppose the hash functions for exporting PID are as marked in FIG. 4(b), denote by PID_{A7}^{(G)} the PID received at agent 7 of the IDnet A for an account linked from IDnet G, then: PID_{A7}^{(G)}=h₇h₁(PID_{A}^{(G)}=h₇h₁ h_{A}^{(G)}h_{B}^{(G)}h_{D}^{(G)}(PID_{G}). Note that a hash function used on an edge to export data within an. IDnet (e.g., h₇) keeps the same regardless of which home IDnet the accounts are linked from. By contrast, hash functions used to export data across IDnets (e.g., h_{A}^{(G)} are defined on a per-home-IDnet basis. For accounts linked from different home IDnets, the hash functions used between the same pair of IDnets in the same direction can be different.

2.5. Identity Validation.

When authentication data are exported to authentication agents of an IDnet, the IDnet can provide identity validation service to the public at its edge agents, e.g., the edge-most authentication agents in the hierarchy as depicted in FIG. 4(b). In this section, it is explained how an edge agent performs the identity validation.

2.5.1. Resolving the Validation Agent.

Denote by a a user. Denote by b a principal (either a user or an application provider) who uses the IDnet Mesh to perform identity validation on user a, e.g., to verify whether a is accountable. It is first introduced how user a and principle b can find a proper edge agent to perform this task. This edge agent is called the validation agent of a for b. The validation agent can satisfy two criteria: (i) it can be exported with user a's authentication data; (ii) it can be trusted by b (e.g., for the identity validation results).

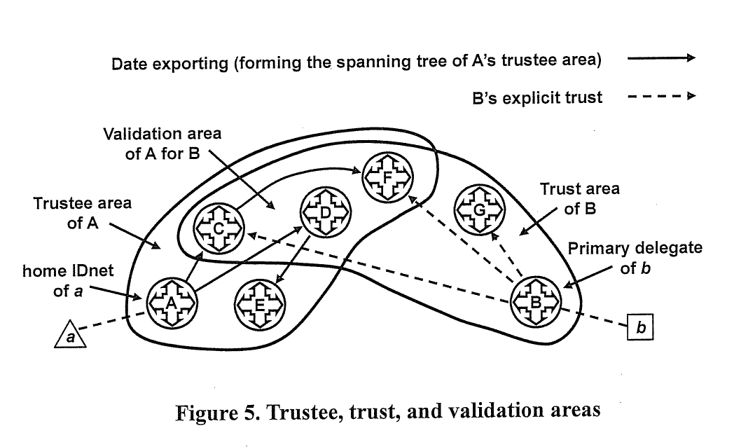

Trustee area. Suppose IDnet A is user a's home IDnet. The trustee area of A includes all IDnets that have been exported with the hashed authentication data of A's home users (including user a). The exporting routes follow a spanning tree rooted at A to all other IDnets, e.g., there is a unique exporting route from A to each IDnet. For example, in FIG. 5, A's trustee area consists of IDnet C, D, E, and F.

Trust area. Suppose IDnet B is the IDnet that principal b trusts most and is therefore called the primary delegate of b. The trust area of B includes all IDnets that B trusts. B explicitly expresses its trust by endorsing the public keys of these IDnets. In FIG. 5, B explicitly trusts IDnet C, D, F, and G, thereby defining its trust area. Note that to avoid the uncertainty of trust during trust revocation, the IDnet Mesh prohibits the implicit transitive trust (e.g., if A trusts B and B trusts C, we conclude that A trusts C as well) as used in solutions such as OpenPGP (see, e.g., RFC 4880: OpenPGP message format, November 2007, http://www.ietf.org/rfc/rfc2440.txt). However, the transitive trust can be used as an external mechanism to help establish the explicit trust.

Validation area and validation agent. Next, the validation area of A for B is described. Referring to FIG. 5, this is the overlapped area between A's trustee area and B's trust area. This area includes all IDnets through which principals (including b) who select B as the primary delegate can perform identity validation on A's home users. Assume b trusts all IDnets that B trusts (for the identity validation results). Therefore, any edge agent of any IDnet within the validation area of A for B can be selected as the validation agent of a for b.

2.5.2. Core Algorithm and Internet Passport.

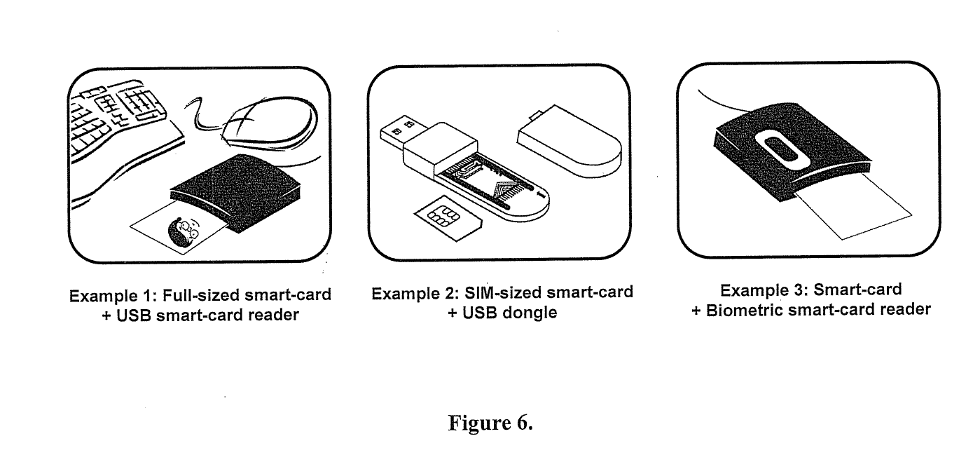

A core algorithm of how a validation agent performs identity validation on a user is described. In order to support strong authentication (see, e.g., What is two factor authentication?, http://www.tech-faq.com/two-factor-authentication.shtml) that is resilient to identity theft, a tamper-resistant user device called Internet passport is described. In some embodiments according to the present invention, the Internet passport is a smart-card based USB device (as exemplified in FIG. 6) that can be plugged into a user's computer. (Implementation details can be found in Section 4.2.) The access to the Internet passport is protected by a password or the user's biometric property (e.g., fingerprint). The Internet passport can securely store the user's root version of authentication data {PIDᵣₒₒₜ, SEGᵣₒₒₜ}, for example, the authentication data at the user's home IDnet.

Denote by v a selected validation agent. Denote by {PIDᵥ, SECᵥ} the hashed version of authentication data stored at validation agent v for the user. Denote by {Hᵥ, H′ᵥ} the pair of hash chains with which {PIDᵥ, SECᵥ} are derived from {PIDᵣₒₒₜ, SEGᵣₒₒₜ}. Denote by PubKeyᵥ and PriKeyᵥ a pair of public and private keys of v assigned by the IDnet that v belongs to. The core algorithm of identity validation can be formulated by Equations (2.1)-(2.5) as shown in the following table.

PIDᵥ=Hᵥ(PIDᵣₒₒₜ) (2.1)

SECᵥ=H′ᵥ(SECᵣₒₒₜ) (2.2)

passcode= [symbol] (SECᵥ,nonce) (2.3)

TID= [symbol] (PIDᵥ∥nonce∥ . . . ,PubKeyᵥ) (2.4)

(PIDᵥ∥nonce∥ . . . )= [symbol] (TID,PriKeyᵥ) (2.5)
∥—concatenation.
[symbol] —a keyed cryptographic hash algorithm such as HMAC that takes the first argument as the key and the second argument as the value to hash.
[symbol] , [symbol] —the encryption and decryption functions of a public key cryptographic algorithm such as RSA or an elliptic curve (ECC, [36]) based algorithm.
nonce—a nonce generated based on time and other parameters.
“ . . . ”—additional data encrypted in TID.

First, the user's computer inputs to the Internet passport the hash chains {Hᵥ, H′ᵥ} (which are resolved using IDnet protocols as will be introduced in Section 2.6). The Internet passport then computes PID, and a one-time passcode using Equation (2.1)-(2.3) as the output. After that, the computer generates a one-time temporary identity, TID, by encrypting PIDᵥ, a nonce field, and some other data (using Equation (2.4)). Next, the TID and passcode are sent to the validation agent v. From the TID, v can recover PIDᵥ, (using Equation (2.5)), which in turn helps to retrieve SECᵥ, (by querying its database). Then v verifies the passcode by regenerating it the same way as the user does (Equation (2.3)). Details of the whole algorithm in my prototype implementation can be found in Section 6.1.3.

2.5.3. Two Types of Identity Validation Services

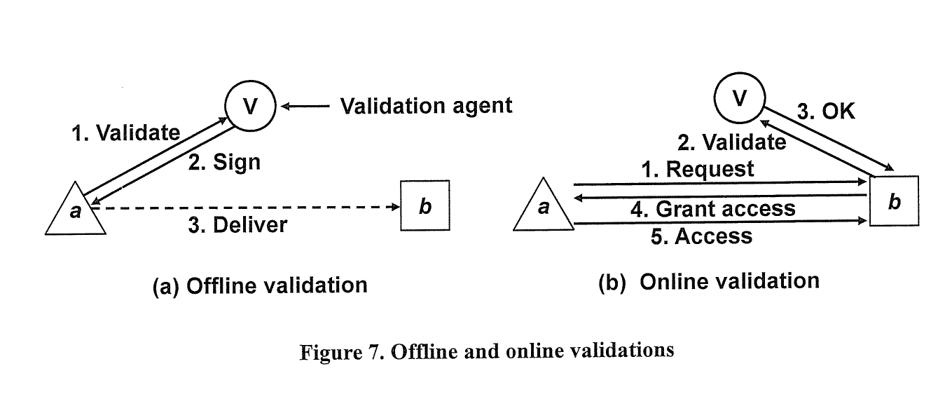

The IDnet Mesh provides two types of identity validation services: offline validation and online validation. In both services, assume a common scenario as shown in FIG. 7: Principal b performs identity validation on user a through validation agent v.

2.5.3.1. Offline Validation.

Offline validation can be used for applications such as Email or content delivery. In such applications, there is no online communication between a and b; a wants to deliver a data object to b, and b wants to validate the accountability of the object sender. To do this, a encodes the data object's digital fingerprint (e.g., using SHA-1) as an additional part of data encrypted in the TID (see Equation (2.4)). Then a asks the validation agent v to validate TID and passcode. If the validation is successful, v returns a a digital signature that certifies the association between TID and the object's digital fingerprint (decrypted from TID).

Next, a delivers the data object together with the signature, TID, and v's information (including v's public key). b can then verify the sender's accountability by checking the consistency among the signature, the object's digital fingerprint, and the TID.

For example, b could be a user who wants to only read Emails from accountable users (such that he can effectively counter SPAMs). Then an Email user a can use the offline validation to show his accountability.

2.5.3.2. Online Validation.

Online validation can be used for applications where there is an online session between user a and principal b. For example, b could be a Web site and a could be one of its users; b can use online validation to acquire the accountability on users to ease the user management.

As shown in FIG. 7(b), in online validation, a first sends his or her validation data (TID and passcode) along with the service request to principal b. Then b validates a's accountability through v by relaying a's validation data to v. If the validation is successful, b grants access permission to a (e.g., by sending a ticket to a). a can then access the application provided by b.

2.5.4. Offline Validation vs. Online Validation.

Offline and online validations are compared below.

2.5.4.1. Use offline Validation for “Online” Applications.

Those familiar with authentication solutions such as OpenID or Windows Cardspace (see, e.g., Introducing Windows CardSpace, http://msdn.microsoft.com/en-us/library/aa480189.aspx) might find that their authentication models are quite similar to the offline validation. However, such solutions can also serve for the online applications (e.g., where there are online sessions between a and b) rather than only restricting to the offline applications (e.g., where there are no online sessions). For example, in OpenID, a user obtains a digitally signed XML token from the identity provider after authentication, and then uses this signed token to open an online session with the application provider. Indeed, the offline validation can also serve for online applications by using a similar method as OpenID does.

2.5.4.2. DDoS Resilient Online Validation.

However, does this means that online validation is unnecessary since offline validation can do all the jobs? The answer is No. The online validation provides in its design a very useful feature that the offline validation does not have. It allows an application provider to easily counter DDoS attacks by exploiting the IDnet Mesh's high DDoS resiliency. Before knowing that user a is accountable, an application provider b does not have to perform any expensive operations (including the public key cryptography and database operations) or maintain any state for user a. It therefore becomes resilient to DDoS attacks that attempt to deplete its CPU, memory, or disk access resources.

Consider the typical case of secure Web access, for example (which is based on SSL and known as HTTPS). When online validation is adopted, a secure channel between a and b to exchange secret authentication information can be established by exploiting the TID. Encrypted into the TID a symmetric key sym_key, which is used to encrypt secret data exchanged between a and b before user a passes the identity validation. The decryption of TID is performed at the validation agent v. Therefore, b actually pushes the expensive public key decryption operation to the IDnet Mesh rather than doing it by itself as in the traditional solution that uses SSL. b can get the sym_key from v through the online validation response.

In addition, b does not have to maintain any state for a before a passes the validation. Since SSL (hence TCP) is not relied upon, UDP can be used for the authentication messages exchanged between a and b, thereby making it stateless comparing with TCP. Meanwhile, b can embed a cookie field into the message that it sends to v. The cookie encodes the session state. Therefore, b does not have to store the state in its memory when waiting for the validation response from v. The cookie will be send back from v after the validation to help b restore the state. After a passes the validation, a and b can switch from UDP to TCP.

2.5.5. Acquiring the Accountability.

How can a principal b acquire the two types of accountability on user a from the IDnet Mesh through the offline and online validations?

2.5.5.1. Acquire Type-1 Accountability.

It is trivial to acquire the type-1 accountability. Since principal b knows the TID and information of v in both offline and online validations, it can simply record them to acquire the type-1 accountability. With TID and the information of v, b can deanonymize user a to his or her real identity with the cooperation of the IDnet Mesh when a dispute (e.g., a crime) arises.

2.5.5.2. Acquire Type-2 Accountability.

To acquire the type-2 accountability is a non-trivial task. To support it, the validation agent v should additionally provide to b a Sybil resilient alias, UIDᵥ^{(b)}, of user a after the identity validation. b can then use UIDᵥ^{(b)} as a permanent identifier of a at its place. Assume b is an application provider. Denote by name_{b} a publicly known and unique name of b (e.g., b's domain name). Denote by sec_key a secret key known by all edge agents (including v) of the same IDnet. Denote by [symbol] a keyed cryptographic hash algorithm such as HMAC that takes the first argument as the key and the second argument as the value to hash. UIDᵥ^{(b)} is defined as follows:

UIDᵥ^{(b)}= [symbol] (PIDᵥ⊕sec_key,name_{b}) (2.6)

However, with such a definition, we can find that UIDᵥ^{(b)} will be different if b uses a different validation agent. So UIDᵥ^{(b)} will not be Sybil resilient if a large number of different agents can be used because UIDᵥ^{(b)} is not quasi-unique for the same user. Nevertheless, if we restrict b to choose only a small number of validation agents to favor the quasi-uniqueness, the scalability and DDoS resiliency benefit of the system would be limited. To solve this, the following two approaches may be taken:

First, the same hash is applied to PID when exporting it from an IDnet's central node to its different edge agents; each edge agent therefore stores the same PID (but different SEC) for the same user UIDᵥ^{(b)} for the same user. Indeed, although the system allows each edge agent to store a different hashed copy of PID, it does not have to. We only need to prevent the identifiability on a user across independent parties (in order to preserve the user's pseudonymity); it is not necessary to also prevent such identifiability within the same party (e.g., the same IDnet).

Second, the validation agent v also provides to b user a's home IDnet identifier home_id With home_id, b can apply a policy to enforce a to use a specific IDnet for the identity validation of the first time. For example, b can announce a list of IDnets ordered by its preference. b requires a to use the first eligible IDnet (e.g., IDnet that falls in the trustee area of a's home IDnet) in the list for the identity validation of the first time. After passing the validation for the first time, b records the received UIDᵥ^{(b)} as a's primary alias at its place. The primary alias is a Sybil resilient alias of a. Later, if a prefers to use other IDnets for the validation, he or she can register beforehand at b the UIDᵥ^{(b)} generated by other IDnets as secondary aliases. b binds a's secondary aliases with the primary alias such that it can identify a using any of them.

UIDᵥ^{(b)} and home_id are sent from the validation agent v to b directly in online validation. Whereas in offline validation, they are first signed by v together with the data object's digital fingerprint, and then relayed to b through a.

Note that the system only offers type-2 accountability to application providers but not to end users. This is because an end user b usually does not have a publicly known unique name name_{b} that is required in order to generate UIDᵥ^{(b)}. However, an end user b may acquire the type-2 accountability of another user indirectly through an application provider.

2.6. IDnet Protocols.

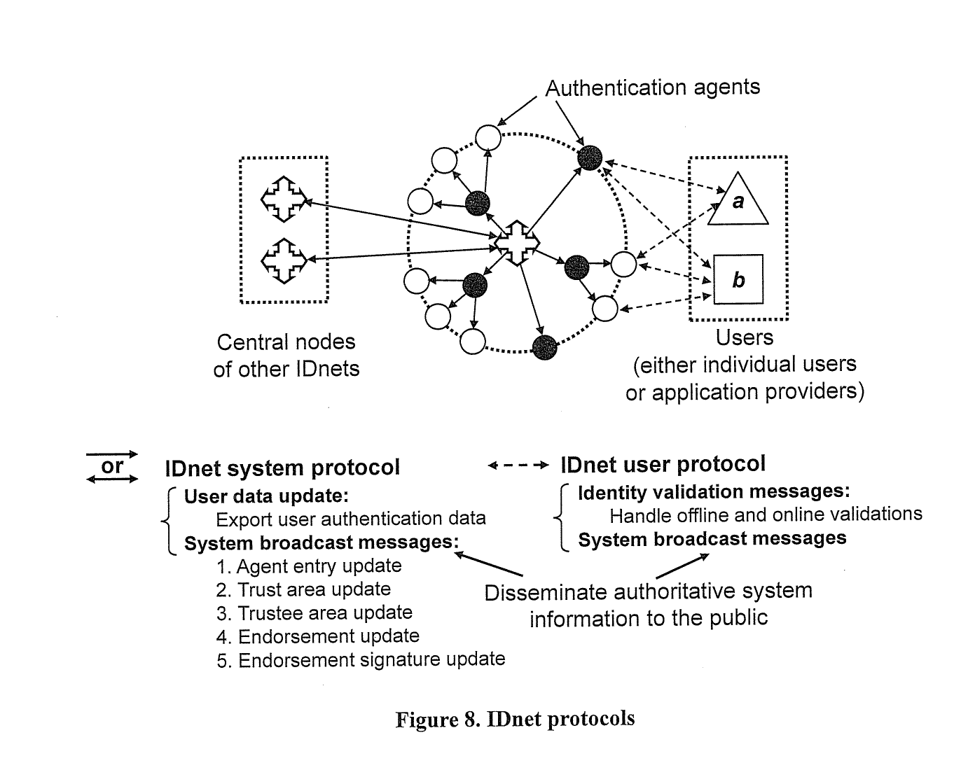

In this section, the IDnet protocols that support the IDnet Mesh's architecture and identity validation service are described. As shown in FIG. 8, there are two types of IDnet protocols: (i) IDnet system protocol, which functions between the central node of an IDnet and its agents, and between the central nodes of different IDnets, and (ii) IDnet user protocol, which operates between edge agents and users. Users here contemplate application providers and/or the individual users.

2.6.1. IDnet System Protocol.

The IDnet system protocol defines two categories of protocol messages—user data update message and system broadcast messages. The user data update message is designed to export and update hashed copies of users' authentication data from an IDnet's central node to its edge agents and to the central nodes of other IDnets. The system broadcast messages are designed to disseminate to edge agents the authoritative system information (including information about edge agents, trust area, and trustee area) from the central node of an IDnet. Such information will later be broadcasted to users from edge agents through the IDnet user protocol. All such information is signed by the IDnet to ensure authenticity. In this way, an IDnet broadcasts to the public its authoritative system information by reusing its scalable authentication architecture.

There are five types of system broadcast messages: (i) agent entry update, which broadcasts authoritative information of each edge agent, including the edge agent's public key and hash chains used; (ii) trust area update, which broadcasts the IDnet's trust area definition; (iii) trustee area update, which broadcasts the IDnet's trustee area definition as well as the cross-IDnet hash chains; (iv) endorsement update, which announces and certifies the public information of each IDnet in the trust and trustee areas, including each IDnet's identifier, domain name, public key, etc.; and (v) endorsement signature update, which is a compact version of the endorsement update. Details of these protocol messages in a prototype implementation will be described in Section 6.1.4.1.

2.6.2. IDnet User Protocol.

The IDnet user protocol defines two categories of protocol messages—identity validation messages and system broadcast messages. The identity validation messages define the request and response formats for offline and online validations. The system broadcast messages enable users to fetch an IDnet's authoritative system information from any edge agent of the same IDnet. Details of these protocol messages in a prototype implementation will be described in Section 6.1.4.2.

### 3. SECURITY

In this section, the security properties of the IDnet Mesh system evaluated (Section 3.1). A novel cryptographic technique, pseudonymous public keys, is described (Section 3.2) which can add strict non-repudiation for the identity validation service while preserving a user's pseudonymity at the same time.

3.1. Evaluation.

3.1.1. Pseudonymity.

Preserving a user's pseudonymity is a property (e.g., an essential property) of the Internet: although a user may always use the same username to access an application provider, this username is just a pseudonym at this provider; the user can have different usernames at different providers such that others cannot link together the same user's actions at different places. In this way, the user's privacy is protected.

Existing unified authentication solutions such as OpenID (see, e.g., OpeniD, http://openid.net/) have each user show the same user identifier (e.g., the OpenID identifier) to all places. In this way, they inherently breach a user's pseudonymity in order to offer the convenience of unified authentication. Such a breach significantly limits their feasibility towards Internet-wide deployment. When the same user identifier is widely used at many places, it becomes trivial to disclose a user's real identity. Although the user identifier itself does not directly disclose a user's real identity, it could become equivalent to a user's real identity in practice. Once a mapping between this single user identifier and the user's real identity is available online, the user's real identity then becomes disclosed everywhere. Because this single user identifier is widely used at many places, it can be too easy to have the above mapping leaked to the Internet under situations such as either intentional attacks by criminals or unintentional technical mistakes at some place.

The IDnet Mesh takes pseudonymity as a basic design criterion while offering unified authentication at the same time. First, the Sybil resilient aliases that application providers acquire from the IDnet Mesh preserve the pseudonymity. Even if different application providers use the same validation agent v, the Sybil resilient aliases UIDᵥ^{(b)} they acquire from v for the same user are different. This is because the generation of UIDᵥ^{(b)} takes each application provider's unique name as a parameter (as shown in Equation (2.6)). Secondly, for the IDnet Mesh itself, the pseudonymity is also retained across IDnets. Each IDnet is exported with a different hashed copy of authentication data for the same user which breaks the identifiability by default.

3.1.2. Attacks.

The identity validation service's resiliency to several types of attacks are analyzed below.

3.1.2.1. Eavesdropping and man-in-the-middle Attacks.

The identity validation service is resilient to eavesdropping attacks since all sensitive data are encrypted either directly in the temporary identity TID or indirectly using a symmetric key encrypted in the TID. Only the validation agent v can decrypt the data. The service is also resilient to man-in-the-middle attacks since v's public key cannot be forged. This is because v's public key is certified by the IDnet that v belongs to (via signature in the agent entry update as introduced in Section 2.6.1); and this IDnet's public key is further certified by the user's home IDnet (via signature in the endorsement update).

3.1.2.2. Replay Attacks.

The nonce field (in Equations (2.3) and (2.4)) can be exploited to prevent replay attacks that use the same validation data {TID, passcode}. In addition to a timestamp, the nonce can also encode an identifier of the validation agent such that the same validation data can only be used at a specific validation agent. The validation agent then records the user's latest timestamp encoded in the nonce, with which it can check the freshness of the nonce, hence prevent replay attacks.

One subtlety is that if the validation agent is a datacenter that includes many servers (with separate databases) rather than a single server. It may be inefficient for all servers to synchronize the recorded timestamp for the same user. In some embodiments according to the present invention, each server records the timestamp independently. To achieve this, a load balancer (e.g., a proxy server) at the datacenter selects a server based on the passcode such that the same validation data will always be forwarded to the same server.

3.1.2.3. Identity Theft.

The adoption of the smart-card based Internet passport makes the identity validation service resilient to identity theft. The tamper-resistant advantage of a smart-card prevents others from reading, altering, or duplicating the secret data stored on the card without being detected. To steal the secret data to impersonate a user, others have to get the Internet passport itself. The Internet passport is further protected by a second factor, for example, a password or the user's biometric property. Therefore, even if others could get the Internet passport, they still cannot use it to impersonate the user.

3.1.2.4. Agent Spoofing Attack.

In online validation, a misbehaving user may spoof a validation agent's IP to send a fake validation response to an application server that he attempts to cheat. However, we can effectively counter such attacks by exploiting the online validation request/response's two-way communication property. The application server can encode certain data only known by itself into a cookie field of the online validation request, such that only the validation agent who receives the request can provide a response with the same cookie. The server can therefore easily filter fake responses based on the cookie's validity.

3.1.3. Recovery Cost of Compromised Databases.

The IDnet Mesh is designed to localize the impact of a compromised database at a system element (an edge agent or even the central node of an IDnet), thereby minimizing the recovery cost. In this way, a very large scale deployment of the IDnet Mesh system becomes possible.

3.1.3.1. Compromised Edge Agent.

A compromised database at an edge agent v of a specific IDnet V will not affect the databases of other IDnets. But for other edge agents of the same IDnet V, the permanent identities PID of users that they store are exposed since they share the same PID with v for each user. (Recall that a user's PIDs stored at all agents of the same IDnet are generated by applying the same hash function on the user's PID at the central node as described in Section 2.5.5.2.)

To recover, V's central node repopulates to v a new SEC for each affected user by applying a new hash function h′. However, a new PID need not be repopulated. If we do repopulate, we have to repopulate it to all V's edge agents, which may be costly. Indeed, the only affect of the exposed PID is that different application providers that use v may acquire the identifiability on the same user across them if the secret key sec_key (in Equation (2.6)) of v is compromised as well. This is because they can now compute the user's aliases UIDᵥ^{(b)} by themselves. Therefore, if the sec_key is compromised, we change it (but keep all users' PID unchanged); if not, we do not have to. When changing it, the new sec_key is updated to all edge agents of V since they share the same sec_key (in order to provide the same user alias to the same application provider as explained in Section 2.5.5.2).

If v's private key is also compromised, we change it as well. The public key associated with the new private key and the new hash function h′ will be disseminated to the public via the system broadcast messages of the IDnet protocols as introduced in Section 2.6.1 and 2.6.2.

3.1.3.2. Compromised Central Node.

A worst case that could happen is that the database of an IDnet's central node is compromised. Of course, the recovery cost for such a case is much higher than a compromised edge agent. But it is still quite limited comparing with the scale of the IDnet Mesh. Denote by C the compromised IDnet. The affected IDnets only include C and its (direct or indirect) relying parties, e.g., IDnets who have been exported hash copies of the authentication data from C.

To recover, C's central node will be repopulated with a new version of authentication data {PID, SEC} for each affected user. There are two cases here: (i) If the compromised authentication data are for C's home accounts, the new {PID, SEC} will be generated by C itself and need to be updated to the corresponding home users' Internet passports. (ii) Otherwise, for example, the compromised authentication data are exported from another IDnet B, the new {PID, SEC} will be exported from B by applying a new pair of (cross-IDnet) hash functions {h_{B→C}^{(A)}, h′_{B→C}^{(A)}}. Here, suppose A is the home IDnet corresponding to the compromised authentication data. Note that IDnet A and IDnet B might be the same one but not necessarily; in general cases, IDnet B is just the direct predecessor of IDnet C in the spanning tree of IDnet A's trustee area. The new hash functions {h_{B→C}^{(A)}, h′_{B→C}^{(A)}} will be announced to the public by A using system broadcast messages.

After C's central node gets the new authentication data, it further exports hashed copies of these data to all its edge agents and to all the relying parties. Moreover, in case that C or any of the relying parties does not perform the recovery, such an IDnet can be removed by A from A's trustee area in order to recover the system. The change of the trustee area definition can be announced to the public by A using system broadcast messages.

3.1.4. Non-Repudiation.

IDnet Mesh can quickly recover from a compromised database once it is detected. But before it is detected and recovered, attackers can impersonate a user using the compromised authentication data. Moreover, we cannot ensure that all IDnets are honest, especially if we want to deploy the IDnet Mesh in a very large scale (hence a large number of IDnets could be involved). A rogue IDnet may impersonate a user using the authentication data it has. Therefore, it is useful to provide the non-repudiation in which no one can impersonate a user using the authentication data.

To address this, one expediency is to validate a user using two (or more) independent validation agents and require the user to pass identity validation at both places. This can significantly raise the bar against impersonation because the chance that both validation agents become compromised or dishonest is significantly reduced comparing with the case of a single agent. However, this expediency adds complexity to the system. Meanwhile, it can only approximate non-repudiation rather than to ensure strict (100%) non-repudiation.

Some embodiments according to the present invention offer strict non-repudiation. Some embodiments according to the present invention contemplate a novel cryptographic technique. With the non-repudiation achieved, it can become highly feasible to apply large-scale replication to deliver high scalability and high reliability for the IDnet Mesh's identity validation service.

3.2. Pseudonymous Public Keys (PPK).

In this section, pseudonymous public keys, a proposed cryptographic technique that can enable strict non-repudiation for identity validation service, are described. This technique allows, inter alia, the IDnet Mesh to store improved authentication data, which can only be used to validate a user, but not to impersonate a user. This can significantly improve the feasibility to distribute authentication data in large scales.

3.2.1. Pseudonymous Signature Scheme.

A type of digital signature scheme based on the public key cryptography can be used to achieve non-repudiation. Unique to this scheme is that it is able to preserve a user's pseudonymity. The scheme can be described as follows:

It can generate multiple public keys for the same private key s. Using any of these public keys, we can verify the signature generated using s.

Without knowing the private key, it is cryptographically hard to infer whether two different public keys are associated with the same private key.

This is called the pseudonymous signature scheme.

3.2.2. Constructing Pseudonymous Public Keys

A pseudonymous signature scheme using a variant of bilinear pairing based signature schemes is described. See, e.g., Dan Boneh, Ben Lynn, and Hovav Shacham, Short signatures from the Weil pairing, in Advances in Cryptology-Asiacrypt 2001, LNCS 2248, pp. 514-532; Fangguo Zhang, Reihaneh Safavi-naini, and Willy Susilo, An efficient signature scheme from bilinear pairings and its applications, in PKC 2004, LNCS 2947, 2004, pp. 277-290. In a typical bilinear pairing based signature scheme such as the ZSS scheme (see, e.g., Fangguo Zhang, Reihaneh Safavi-naini, and Willy Susilo, An efficient signature scheme from bilinear pairings and its applications, in PKC 2004, LNCS 2947, 2004, pp. 277-290), the private and public keys are generated as follows:

Denote by G a finite group of order q for some large prime q. Choose a random generator PεG. P can be regarded as a publicly known system parameter. Select a random sεZ*_{q} and set Q=sP. Then s is the private key and Q is the corresponding public key.

Unlike the typical schemes, the pseudonymous signature scheme treats P as a part of the public key instead of a system parameter. Therefore, with a different P, we can generate a different public key for the same s. To generate different P and hence different public keys, we can use a method similar to the way that ID-based cryptography (see, e.g., Dan Boneh and Matthew Franklin, Identity-based encryption from the Weil pairing, SIAM Journal on Computing, vol. 32, no. 3, pp. 586-615, 2003) generates different private keys:

Denote by ID an arbitrary identifier. Denote by [symbol] a map-to-point hash function (see, e.g., Dan Boneh, Ben Lynn, and Hovav Shacham, Short signatures from the Weil pairing, in Advances in Cryptology-Asiacrypt 2001, LNCS 2248, pp. 514-532; Paulo Barreto, Hae Y. Kim, and Scopus Tecnologia S. A, Fast hashing onto elliptic curves over fields of characteristic 3, in Cryptology ePrint Archive, Report 2001/098, http://eprintiacr.org/2001/098/), [symbol] : {0, 1}*→G. We compute P_{ID}= [symbol] (ID) and Q_{ID}=sP_{ID}. Then {P_{ID}, Q_{ID}} becomes a public key associated with ID.

It is verifiable that such public keys also satisfy the second condition of the scheme. For example, it is cryptographically hard to infer whether two public keys are associated with the same s. Such public keys may be called the pseudonymous public keys (PPK).

3.2.3. Using Pseudonymous Public Keys.

In the IDnet Mesh system, to preserve a user's pseudonymity across different IDnets, each IDnet's identifier (a self-certifying flat name) can be sued as the ID to generate a pseudonymous public key PPK for the same user at each IDnet. Note that throughout application, the notation PPK (in math font) is used to indicate the data field, e.g., the public key, while the notation PPK (in normal font) is used to denote the corresponding cryptographic approach, e.g., the pseudonymous public keys approach. Different IDnets will then have different PPKs for the same user while the edge agents of the same IDnet use the same PPK. In practice, the PPK for each user only needs to include Q_{ID}, but not P_{ID}. This is because P_{ID} is a hash of ID. It takes the same value for a given IDnet regardless of the users. It therefore can be stored as a system parameter of this IDnet rather than as a part of each user's PPK.

To generate and distribute the PPKs, there are at least two options. In the first option, the private key s is stored both in the user's Internet passport and at the home IDnet. Then the home IDnet can generate the PPK of the user for each IDnet in the trustee area and then distribute the PPK. In such a setting, the home IDnet escrow the private key s and the non-repudiation can be guaranteed upon the premise that the home IDnet securely stores s and is always honest. However, although to escrow the key s at the home IDnet could be helpful for certain circumstances, in most cases it would be desirable to remove the key escrow such that even the home IDnet cannot impersonate the user, hence the complete non-repudiation.

In the second option, once the home IDnet has generated and distributed the PPKs to all IDnets within the trustee area, it can destroy s. Later, if there are new IDnets added to the trustee area, it can have the user to generate the corresponding PPKs (if the user wants to use these new IDnets) and send to it. Of course, the home IDnet will validate the user before accepting the PPKs that the user gives, and the validation can be done using the user's PPK for the home IDnet. The home IDnet then distributes these PPKs to the new IDnets. In this way, the key escrow problem is removed and the complete non-repudiation is achieved.

3.2.4. Improved Identity Validation Algorithm.

The integration of the pseudonymous signature scheme into the identity validation algorithm to achieve non-repudiation is described.

First, the user's Internet passport will store the private key s in addition to the root version of authentication data {PIDᵣₒₒₜ, SECᵣₒₒₜ}. Besides generating TID and passcode using Equation (2.1)-(2.4) as listed in Section 2.5.2, the user will also have the Internet passport generate a signature using Equation (3.1) shown below. Here S is the signing algorithm of a pseudonymous signature scheme. It takes nonce as the message to sign. ID is the identifier of the IDnet that the validation agent v belongs to. After generating signature, the user sends the signature together with the TID and passcode to v.

signature=S(nonce,ID,s) (3.1)

At the validation agent v, the authentication data that it stores additionally include the user's PPK. So they are now in form of the 3-tuple {PID, SEC, PPK} for each user. Upon receiving TID, passcode, and signature, v first performs the identity validation the same way as in Section 2.5. Note that since the SEC based validation (Equation (2.3)) is much more faster than the bilinear pairing based signature verification, this step is now used as an efficient preliminary validation (e.g., to prescreen the DDoS attack attempts). Next, if the user passes the preliminary validation, v further verifies signature using the user's PPK by performing the bilinear pairing based signature verification. If the verification succeeds, the user passes the identity validation, otherwise not.

3.2.5. Pseudonymous Public Keys with Point Adaptation

Some embodiments of the present invention contemplate that the above approach to construct the PPKs is not restricted to the bilinear pairing based signature schemes. It is applicable for any elliptic curve based signature schemes that are developed upon the difficulty of the ECDLP (e.g., elliptic curve discrete logarithm problem). Besides the bilinear pairing based schemes, the ECDSA (elliptic curve digital signature algorithm) scheme (see, e.g., Don Johnson and Alfred Menezes, The elliptic curve digital signature algorithm (ECDSA), Tech. Rep., 1999) is another typical example of this kind.

In all such elliptic curve based schemes, the private and public keys are generated the same way as the bilinear paring based schemes as described in Section 3.2.2. Therefore, the same approach of generating the PPKs by adapting the generator point P can be used. This approach is called the PPK with point adaptation, to differentiate it from another PPK-constructing approach that is based on the private key adaption which will be introduced in the next section.

In a prototype implementation (Section 6.1) of the IDnet Mesh system, an ECDSA is built based PPK implementation into the system in terms that ECDSA is much more standardized than the bilinear pairing based schemes. Meanwhile, a performance evaluation that compares the ECDSA based implementation and the bilinear pairing based implementation is provided in Section 4.3.

3.2.6. Pseudonymous Public Keys with Private Key Adaptation.

By exploiting the elliptic curve based signature schemes, there is another way to construct the PPKs. Instead of adapting the generator point P to construct different PPKs, we can also adapt the private key s to achieve the same goal. This new approach is therefore called PPK with private key adaptation.

3.2.6.1. The Approach.

This approach works as follows:

Select a random sεZ. Denote by ID an arbitrary identifier. Denote by [symbol] a function that takes two arguments, [symbol] : Z×{0, 1}*→Z*_{q}. We compute ŝ_{ID}= [symbol] (s, ID) and Q_{ID}=ŝ_{ID}P. Then s is the private key and Q_{ID} is a pseudonymous public key associated with ID.

The function [symbol] can be constructed based on a hash function such as HMAC. As such, one apparent advantage of the private key adaptation comparing with the point adaptation is that we no longer need a map-to-point hash function. Instead, we can simply use a regular hash function. As studied in (see, e.g., Dan Boneh, Ben Lynn, and Hovav Shacham, Short signatures from the Weil pairing, in Advances in Cryptology-Asiacrypt 2001, LNCS 2248, pp. 514-532; Fangguo Zhang, Reihaneh Safavi-naini, and Willy Susilo, An efficient signature scheme from bilinear pairings and its applications, in PKC 2004, LNCS 2947, 2004, pp. 277-290; Paulo Barreto, Hae Y. Kim, and Scopus Tecnologia S. A, Fast hashing onto elliptic curves over fields of characteristic 3, in Cryptology ePrint Archive, Report 2001/098, http://eprint.iacr.org/2001/098/), a map-to-point is probabilistic and generally inefficient. By replacing with a regular hash function, the efficiency of the algorithm and ease of its implementation are improved.

3.2.6.2. A Failed Example.

There could be many other choices of the function [symbol] , However, the choice of [symbol] should satisfy the second criterion of the pseudonymous signature scheme, e.g., without knowing the private key, it is cryptographically hard to infer whether two different public keys are associated with the same private key. To understand this, a failed example is illustrated that results from a careless choice of [symbol] .

Suppose we use a bilinear pairing based signature scheme, for example, the ZSS scheme. We do the private key adaptation to generate different PPKs corresponding to different IDs. Suppose we construct function [symbol] based on the scalar multiplication and a regular hash function h as follows:

ŝ_{ID}= [symbol] (s,ID)=s·h(ID)

Now consider the PPKs associated with two different IDs—ID₁ and ID₂. Denote by Q_{ID1} and Q_{ID2} the two corresponding PPKs, then:

$$\{ \begin{matrix}{Q}_{{ID}_{1}} = {\hat{s}}_{{ID}_{1}} P = s \cdot h ( {ID}_{1} ) \cdot P \\ {Q}_{{ID}_{2}} = {\hat{s}}_{{ID}_{2}} P = s \cdot h ( {ID}_{2} ) \cdot P\end{matrix}$$

Because a bilinear pairing based scheme is used, there exists a bilinear pairing operation e: G₁×G₁→G₂, in which G₁ and G₂ are two groups of order q for some large prime q. As we know, the bilinear pairing has the property that e(a,X,bY)=e(X, Y)^{ab}, for all X, Y G₁, a, b_{q}. See, e.g., Dan Boneh, Ben Lynn, and Hovav Shacham, Short signatures from the Weil pairing, in Advances in Cryptology-Asiacrypt 2001, LNCS 2248, pp. 514-532; Fangguo Zhang, Reihaneh Safavi-naini, and Willy Susilo, An efficient signature scheme from bilinear pairings and its applications, in PKC 2004, LNCS 2947, 2004, pp. 277-290. Therefore, we can compute the bilinear pairing of Q1D₁ and Q_{ID2}, and can infer that:

e(Q_{ID}_{₁},Q_{ID}_{₂})=e(s·h(ID₁)·P, s·h(ID₂)·P)=e(P,P)^{s}^{²}^{·h(ID}^{₁}^{)h(ID}^{₂}⁾

Now let's apply a field exponentiation to the above pairing using the exponent 1/h(ID₁)h(ID₂). We can get:

$${e ( {Q}_{{ID}_{1}} , {Q}_{{ID}_{2}} )}^{\frac{1}{h ( {ID}_{1} ) h ( {ID}_{2} )}} = {e ( P , P )}^{{s}^{2} \cdot h ( {ID}_{1} ) h ( {ID}_{2} ) \cdot \frac{1}{h ( {ID}_{1} ) h ( {ID}_{2} )}} = {e ( P , P )}^{{s}^{2}}$$

Since e(P,P)^{s}^{²} is a fixed value corresponding to each private key s, the above result implies that we are able to infer whether multiple (≧3) PPKs are associated with the same private key s, even though we do not know s. This violates the second criterion of the pseudonymous signature scheme.

3.2.6.3. Private Key Adaptation Beyond Elliptic Curve.

In addition to elliptic curve based schemes, the PPK with private key adaptation approach can also be applied to ElGamal-like (see, e.g., Taher El Gamal, A public key cryptosystem and a signature scheme based on discrete logarithms, in CRYPTO '84 on Advances in cryptology, Santa Barbara, Calif., 1985, pp. 10-18) signature schemes such as DSA (digital signature algorithm) (see, e.g., FIPS-186-3, the third and current revision to the official DSA specification, http://csrc.nist.gov/publications/fips/fips186-3/fips_{—186}-3.pdf), for example, schemes based on the difficulty of the DLP (discrete logarithm problem).

Take DSA for example. In the original DSA scheme, the private and public keys are generated as follows: Denote by q a large prime. Choose a prime p such that p−1 is a multiple of q. Denote by g a randomly chosen number whose multiplicative order modulo p is q. Select a random sε and set y=g^{s} mod p. Then s is the private key and y is the corresponding public key.

To apply the PPK with private key adaptation to DSA, we do the following: Denote by ID an arbitrary identifier. Denote by [symbol] a function that takes two arguments, [symbol] : Z×{0, 1}*→. Compute ŝ_{ID}= [symbol] (s, ID) and y_{ID}=g^{ŝID} mod p. The s is the private key and y_{ID} is a pseudonymous public key associated with ID.

In the prototype implementation (Section 6.1) of the IDnet Mesh system, in addition to the ECDSA based implementation, a DSA based implementation for the PPK module is also provided. Meanwhile, a performance evaluation that compares the DSA based implementation, the ECDSA based implementation, and the bilinear pairing based implementation is provided in Section 4.3.

### 4. PERFORMANCE AND IMPLEMENTATION

In this section, evaluation of the system's performance is described in terms of (i) scalability of the identity validation service (Section 4.1), (ii) feasibility to implement the smart-card based Internet passport (Section 4.2), (iii) tradeoff among different choices of signature schemes that underlie the PPK approach (Section 4.3), and (iv) the system's responsiveness to the revocation (or change) of a user's credential and to the change of authoritative system information (Section 4.4).

4.1. Service Scalability.

The scalability of the identity validation service is first analyzed. This evaluation needs the benchmark result on the processing speed of the identity validation algorithm running at the edge agent. This benchmark result is acquired through a prototype implementation of the IDnet Mesh system.

4.1.1. Processing Speed Benchmark.

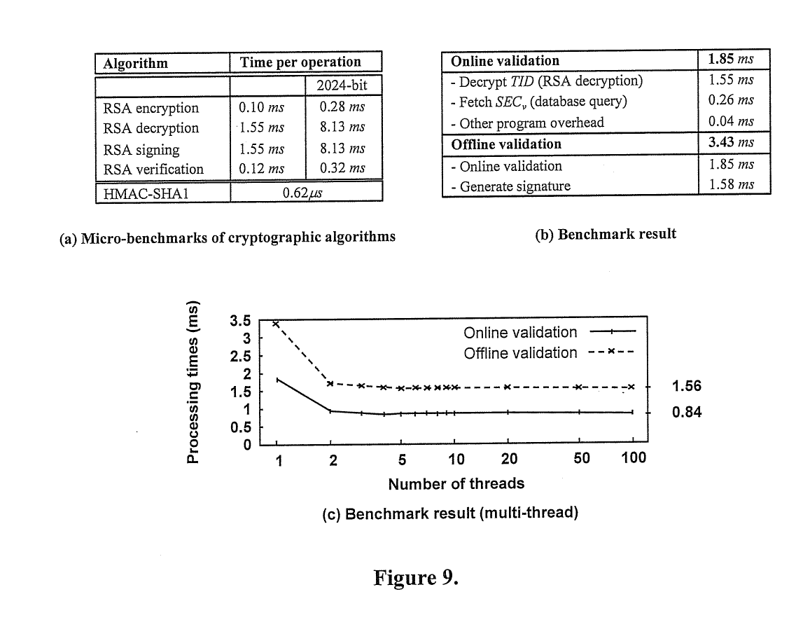

FIG. 9 shows the benchmark result. The benchmark is performed on a test machine with two dual-core 64-bit Intel Xeon 2.8 GHz processors. A user database (using MySQL) is set up on this machine that consists of 4.8 million user entries. Each entry corresponds to the authentication data of a user. These entries are distributed across three tables, with each table containing 1.6 million entries. 10,000 entries are randomly selected from the database and their TIDs and passcodes are precomputed as the input for the benchmark. RSA algorithm with 1024-bit keys is used for the encryption/decryption of TID in this prototype implementation. The HMAC-SHA1 is used as the keyed hash function for computing the passcode. The codes of programs are written in C++ and use the Crypto++ library (see, e.g., Crypto++ library, http://www.cryptopp.com/) for cryptographic functions.

FIG. 9(b) shows the average processing time of online and offline validations for the 10,000 entries. It also itemizes the processing time of major steps that constitute the identity validation algorithm. For reference, micro-benchmark results are listed on the same machine for basic cryptographic algorithms in FIG. 9(a). The processing speed of the identity validation algorithm is mainly bounded by the RSA operations—an RSA decryption in the online validation and an additional RSA signing in the offline validation.

Since RSA operations are CPU-bound, the processing speed via multi-threading on a multi-processor machine is improved. FIG. 9(c) shows the processing time benchmark when multi-threading is used. The processing time on this two-due-core-CPU machine converges quickly to 0.84 ms for online validation and 1.56 ms for offline validation as the number of threads increases, which is more than doubling the processing speed of a single thread.

The benchmark results also reveal that if we can improve the RSA operation speed at edge agents by an order of magnitude (see, e.g., using dedicated hardware (see Soner Yesil, A. Neslin Ismailoglu, Yusuf Cagatay Tekmen, and Murat Askar, Two fast RSA implementations using high-radix montgomery algorithm., in ISCAS (2), 2004, pp. 557-560), the processing speed will no longer be bounded by RSA, but by the database query operations.

4.1.2. Scalability Analysis.

Based on the benchmark results, we can estimate the identity validation service's scalability by assuming the following (aggressive) workload for all Internet users:

According to Internet world stats (see, e.g., Internet world stats, http://www.internetworldstats.com/stats.htm), there are 1,668 million Internet users in the world as of Jun. 30, 2009.

Assume that each user on average performs 50 online validations and 50 offline validations every day.

Assume the worldoad at the peak time of a day is twice as the average workload.

Then, to meet the peak time workload for all Internet users, the system should be capable to process up to 1.93 million online validations and 1.93 million offline validations every second. Using the benchmark results—0.84 ms for online validation and 1.56 ms for offline validation, we get that each edge agent server can serve 360,000 users on average and we need only 4,633 servers in total to serve all the 1,668 million users of the current Internet. If the actual worldoad is even more aggressive than what is assumed here, we can simply increase the number of servers needed linearly with the actual worldoad to meet the scalability demand.

4.1.3. Consider the PPK

The scalability analysis above has not yet include the pseudonymous public keys (PPK¹) based validation step that is introduced in the improved identity validation algorithm (Section 3.2.4). Note that throughout this dissertation, the notation PPK (in math font) is used to indicate the data field, e.g., the public key, while the notation PPK (in normal font) is used to denote the corresponding cryptographic approach, e.g., the pseudonymous public keys approach. In this section is described how much the above scalability analysis result will change if the PPK based validation is added.

For the signature schemes that underlie the PPK based validation, at least three options are considered: DSA, ECDSA, and the ZSS scheme. The processing time of the corresponding PPK based signature verification (which is supposed to run on each edge agent server) is evaluated. For ECDSA and ZSS, we can use either point adaptation or private key adaptation to construct the public key PPK. Nevertheless, regardless of point adaptation or private key adaptation, the processing time of PPK based signature verification is the same, since it is the same as that of the original ECDSA or ZSS scheme. For DSA, only private key adaptation is applicable.

The first line of Table 4.1 shows the processing time of PPK based signature verification performed on the same test machine as used in Section 4.1.1. Each processing time corresponds to one of the three schemes—DSA, ECDSA, and ZSS. The key size of each scheme is chosen in the way that it provides approximately the same level of security as the 1024-bit RSA. For DSA and ECDSA, the processing time is acquired through the benchmark of my prototype implementation which uses the Crypto++ library. For the ZSS scheme (see, e.g., Fangguo Zhang, Reihaneh Safavi-naini, and Willy Susilo, An efficient signature scheme from bilinear pairings and its applications, in PKC 2004, LNCS 2947, 2004, pp. 277-290), the processing time based on related work is inferred in the following way:

The signature verification algorithm of the ZSS scheme includes two operations—one bilinear pairing operation and one point multiplication. Suppose that the implementation of the bilinear pairing follows the way proposed in (see, e.g., Michael Scott, Implementing cryptographic pairings, in Okamoto (Eds.) Pairing-Based Cryptography: Pairing 2007. LNCS 4575, pp. 177-196) and the η_{T} pairing on a specific elliptic curve is chosen. Using the benchmark result provided in (see, e.g., Michael Scott, Implementing cryptographic pairings, in Okamoto (Eds.) Pairing-Based Cryptography: Pairing 2007. LNCS 4575, pp. 177-196), the processing time of the signature verification using the ZSS scheme is estimated to be about three times that of a RSA decryption operation, for approximately the same level of security.

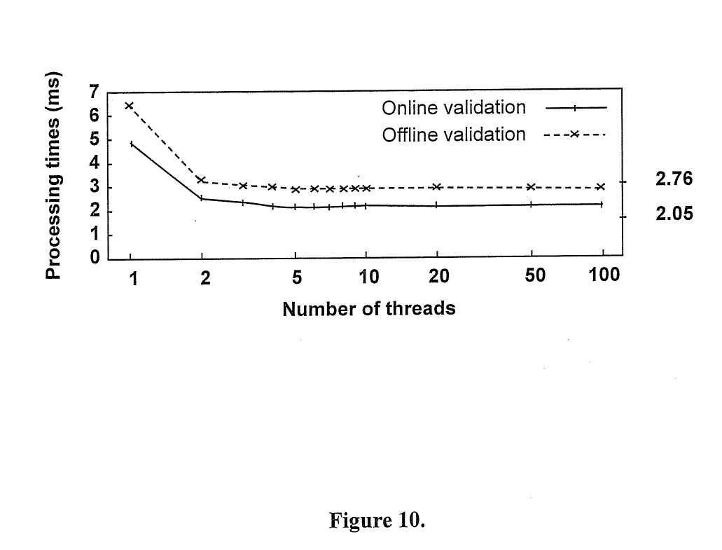

As shown in Table 4.1, the ZSS scheme gives the largest (worst) processing time among all the three schemes. However, even if the ZSS scheme is chosen, although the above scalability analysis result will change a bit when the PPK based validation is added, it will still be on the same order of magnitude. FIG. 10 shows an example of the entire processing time of the improved identity validation algorithm in the same format as in FIG. 9(c). This example is acquired based on the benchmark of my prototype implementation and uses ECDSA as the underlying signature scheme.

TABLE 4.1
Evaluation on PPK based identity validation

| | DSA | ECDSA | ZSS scheme |
|---|---|---|---|
| | (1024-bit) | (160-bit) | (160-bit) |
| Processing time of verification | 0.736 ms | 2.89 ms | 4.65 ms* |
| Processing time of signing | n/a | 4.24 ms* | 4.41 ms* |
| (with point adaptation) | | In practice: | In practice: |
| | | 1.30 ms | 1.47 ms* |
| Processing time of signing | 0.636 ms | 1.30 ms | 1.47 ms* |
| (with private key adaptation) | | | |
| Size of public key | n/a | 40 B | 40 B |
| (with point adaptation) | | In practice: | In practice: |
| | | 20 B** | 20 B** |
| Size of public key | 128 B | 20 B | 20 B |
| (with private key adaptation) | | | |
| Size of signature | 40 B | 42 B | 20 B |
| Size of private key | 20 B | 20 B | 20 B |

*The processing times for the ZSS scheme and for those involving the map-to-point hash function are inferred results based on Fangguo Zhang, Reihaneh Safavi-naini, and Willy Susilo, An efficient signature scheme from bilinear pairings and its applications, in PKC 2004, LNCS 2947, 2004, pp. 277-290; Paulo Barreto, Hae Y. Kim, and Scopus Tecnologia S. A, Fast hashing onto elliptic curves over fields of characteristic 3, in Cryptology ePrint Archive, Report 2001/098, http://eprint.iacr.org/2001/098/; Michael Scott, Implementing cryptographic pairings, in Okamoto (Eds.) Pairing-Based Cryptography: Pairing 2007. LNCS 4575, pp. 177-196.
**As explained in Section 3.2.3, when using PPK with point adaptation in practice, we do not have to include the generator point P_{ID} as a part of the public key, therefore the public key size will be the same as in PPK with private key adaptation.

4.2 Smart-Card Performance.

4.2.1 Prototype Implementation.

A prototype implementation of the Internet passport has been developed using a type of .NET smart-card (see, e.g., Feitain .net smart card, http://ftsafe.com/products/dotNet-Card.html) to get some understanding of the performance. The implementation shows that its processing speed for the user side algorithm in the identity validation is bounded by the H.MAC-SHA1 operation. The processing speed of this on-card implementation is a bit slow—each HMAC-SHA1 operation takes about 0.35 second. This is because its on-card program is compiled as the .NET framework IL (see, e.g., Introduction to IL assembly language, http://www.codeproject.com/KB/msil/ilassembly.aspx) on a virtual machine, which runs hundreds of times slower than the smart-card's native code. Therefore, if a native code implementation is adopted, the processing time can be expected to be negligible.

4.2.2. Consider the PPK.

The on-card implementation does not include the function for the PPK based validation. When this function is added, the operation on the smart-card will change from the HMAC-SHA1 to the PPK signing. However, an affordable processing time can still be expected.

Table 4.1 shows the processing time of PPK signing in the second and third lines. The worst processing time among all five shown cases is given by the ZSS scheme with point adaptation. Note that although the processing time shown here is based on the benchmark on a computer rather than on a smart-card, the above property holds on a smart-card as well. We therefore focus on the ZSS scheme with point adaptation for the processing time evaluation on the smart-card.

Suppose we choose the η_{T} pairing for the ZSS scheme, then the operation of the PPK signing includes one point multiplication and one map-to-point hashing. If using the method proposed in Dan Boneh, Ben Lynn, and Hovav Shacham, Short signatures from the Weil pairing, in Advances in Cryptology-Asiacrypt 2001, LNCS 2248, pp. 514-532; Paulo Barreto, Hae Y. Kim, and Scopus Tecnologia S. A, Fast hashing onto elliptic curves over fields of characteristic 3, in Cryptology ePrint Archive, Report 2001/098, http://eprint.iacr.org/2001/098/for the map-to-point hash function, the processing time of the map-to-point hashing will be typically bounded by one or more point multiplications. The average number of the point multiplications needed is 2. Therefore, the processing time of the PPK signing is about that of three point multiplications on average. According to the benchmark result of an on-card implementation (see, e.g., Michael Scott, Neil Costigan, and Wesam Abdulwahab, Implementing cryptographic pairings on smartcards, in CHES 2006. LNCS 4249) using the native code running on a contemporary 32-bit smart-card, the processing time of a point multiplication can be as small as 0.1 sec. Therefore, the processing time of the entire PPK signing is about 0.3 sec on average.

In practice, the map-to-point hashing can usually be avoided in the PPK signing. The map-to-point hashing is used to compute the adapted generator point P_{ID} (Section 3.2.2) by hashing from an IDnet's identifier ID. P_{ID} remains the same all the time for a given IDnet and therefore can be precomputed or be announced by the corresponding IDnet as public information. In this way, the PPK signing in practice no longer needs to include the step of map-to-point hashing. The processing time therefore can be as small as 0.1 sec, which is quite affordable.

4.3. Comparing DSA-, ECDSA-, and Bilinear Pairing Based PPK.

In this section, the performance is compared of the PPK approaches that correspond to different underlying signature schemes—DSA, ECDSA, and the bilinear pairing based schemes. For the bilinear pairing based schemes, reference is made to the ZSS scheme as the example in mind.

The ECDSA and the bilinear pairing based schemes fall in the category of elliptic curve cryptography (ECC). As we can see from Table 4.1, comparing with the DSA, the two types of ECC based schemes have the apparent advantage of shorter key sizes. This advantage will become more dramatic as the key sizes grow over time for increased security. Table 4.2 compares the required public key sizes of DSA and ECC for equivalent security levels. As we can see, the key sizes for ECC scale linearly with the security, while DSA does not.

TABLE 4.2
NIST guidelines for public-key sizes with equivalent security levels

| Protection lifetime (recommended | | | |
|---|---|---|---|
| by RSA Laboratories (see TWIRL and | | Required | |
| RSA key size, | | size (bits) of | |
| http://www.rsa.com/ | | public keys | |
| rsalabs/node.asp?id=2004)) | Security (bits) | DSA | ECC |
| Present-2010 | 80 | 1024 | 160 |
| Present-2030 | 112 | 2048 | 224 |
| Present-2031 and beyond | 128 | 3072 | 256 |

As we can also see from Table 4.1, the DSA has the major advantage over the two types of ECC based schemes in its processing time of both the signing and verification. However, this is due to that the current implementation assumes to provide just 80-bit security, e.g., using 1024-bit DSA key and 160-bit ECC key. As the required key sizes grow for increased security, we can expect this advantage to quickly diminish. This is because the relative computational cost of ECC versus DSA is not proportional to the key sizes but to the cube of the key sizes. So going from 1024-bit DSA key to 3072-bit DSA key requires about 27 times (3³) as much computation, while ECC would only increase the computational cost by just over 4 times (1.6³).

Although the ECC based schemes have significant advantages, they have not been analyzed as long time and as rigorously as the DSA; and they are also far less standardized than the DSA. Therefore, the DSA is much more robust and convenient to use than the ECC based schemes for the current implementation.

For the two types of ECC based schemes, their biggest difference lies in the signature size. The bilinear pairing based schemes give shorter signature size—about half the size of the ECDSA. Another difference is that the signature verification of ECDSA runs faster than that of the bilinear pairing based schemes (e.g., ZSS scheme) as we can see from Table 4.1. Moreover, ECDSA is more standardized than bilinear pairing based schemes.

4.4. System Protocol Performance.

In this section, the performance is evaluated of the IDnet system protocol (Section 2.6.1) in terms of the system's responsiveness to data updates. For example: (i) When a user's home account has been revoked or modified, how fast can all accountable accounts linked from it be revoked or updated such that the change can take effect in the entire IDnet Mesh system? (ii) When an IDnet's authoritative information such as trustee or trust area definition has changed, how fast the change can be broadcasted to the public?

4.4.1. Responsiveness Upper Bounds.

To represent such responsiveness, the measure responsiveness upper bound may be described. This measure quantifies the system's guaranteed responsiveness to data changes. It is described as the time upper bound that outdated data could remain in the system in the worst case. The shorter the value, the better.

In this section, the responsiveness upper bounds that can be achieved in the prototype implementation is explained. Then in Section 4.4.2 and 4.4.3, the factors for achieving such responsiveness upper bounds are evaluated.

4.4.1.1. Responsiveness Upper Bound to User Data Changes—Two Hours.

When a user's home account is revoked or modified by the home IDnet, the change needs to be exported to all IDnets within the home IDnet's trustee area using the user data update message of the IDnet system protocol as introduced in Section 2.6.1. In the prototype implementation, the sending of the user data updates created at the home IDnet is paced at one-hour intervals. Whereas all remaining IDnets within the trustee area will immediately forward the received user data updates to edge agents and to downstream IDnets. During the forwarding, the corresponding hash functions will be applied to all {PID, SEC} tuples contained in the message. The entire forwarding process to all edge agents of all IDnets in the trustee area is required to be finished within the next hour.

This implies that any user data changes are guaranteed to take effect in the entire system within two hours, hence the two-hour responsiveness upper bound. Comparing with other Internet-wide user credential approaches such as OpenPGP, our responsiveness upper bound is significantly shorter. OpenPGP's user credentials rely on the expiration time of digital certificates to invalidate themselves (see, e.g., RFC 4880: OpenPGP message format, November 2007, http://www.ietf.org/rfc/rfc2440.txt.) in the worst case. The expiration time is typically set to one year, which implies a one-year responsiveness upper bound.

4.4.1.2. Responsiveness Upper Bound to System Data Changes—Two Days.

The changes of authoritative system information (e.g., agent information, trustee or trust area definition) are disseminated to the public through the system broadcast messages. In my prototype implementation, the system is designed to perform daily refreshment for all system broadcast messages. If no changes happen in the corresponding system information, only the signature blocks are refreshed to indicate the freshness of the system information. The signature blocks (as will be illustrated in Section 6.1.4.1) in these messages are set to expire after two days, which implies a two-day responsiveness upper bound. Comparing with similar secure global announcement approaches such as DNS SEC (see, e.g., DNSSEC: DNS security extensions, http://www.dnssec.net/), our responsiveness upper bound is much shorter. In DNSSEC, the refreshment period and lifetime of signatures (for DNS data) are typically on the order of weeks or a month, thereby leading to a much longer responsiveness upper bound.

4.4.2. Bandwidth Requirements.

Here the bandwidth requirements are evaluated in order to achieve the above responsiveness upper bounds. To do this, the topological model of a very large scale IDnet Mesh system as described in Table 4.3 is used.

Denote by B the goodput to transmit the IDnet system protocol messages over an Internet path. The requirements of B are evaluated in order to achieve the above responsiveness and show that the requirements can be easily satisfied.

To achieve the two-hour responsiveness upper bound to user data changes, a user data update created by an home IDnet can be forwarded to all IDnet edge agents in the trustee area within one hour is ensured. Using the topological model shown in Table 4.3 and referring to the format of the user data update message being shown in Section 6.1.4.1, we can infer the minimum goodput B required. The discussion of the inference methodology will be explained in detail in Section 6.2 and, for now, only the result is shown. The result shows: for an home IDnet with 100 million users and assume a workload of 10 changes every 3 years for each user, to guarantee the two-hour responsiveness upper bound for the user data changes, we only need to ensure a goodput B of 11.8 K Bps on each related Internet path for the user data update message initiated from this home IDnet.

TABLE 4.3
Topological model of a very large scale IDnet Mesh system.

Description of the model
1. The structure of each IDnet is a two-level complete 10-ary tree, that is,
each IDnet has 10 level-1 agents as its children and each level-1 agent
has 10 level-2 agents as its children. Therefore, each IDnet has 100
edge agents.
2. Each edge agent is a datacenter that consists of 100 servers.
Therefore, each IDnet has 10,000 edge agent servers.
3. Total number of IDnets in the IDnet Mesh is 40,000.
4. An IDnet can export hashed versions of authentication data to other
IDnets through up to L intermediate (cross-IDnet) hops. L is set to 6.
5. Denote by .D the one-way propagation delay on Internet paths between
two IDnets' central nodes, between an IDnet's central node and each
of its level-1 agent, or between a level-1 agent and each of its downstream
level-2 agent. D is set to 1 sec.
Rationale for the model parameter settings
Item 1 and 2 are set by referring to the largest replica server system
on the current Internet - Google platform (see, e.g., David Carr,
How Google works, Baseline Magazine, July 2006). The Google
platform has its servers distributed across tens of datacenters across
the world. Therefore each IDnet is set in the model to have a comparable
geographical span and number of servers as the Google platform.
Item 3 is set by referring to the total number of autonomous systems
(AS) on the current Internet because an IDnet and an AS share the
similar administrative domain nature. According to the record of IANA,
there are about 40,000 ASes on the current Internet. Therefore the total
number of IDnets is set in this model to 40,000.
Item 4 is set by referring to the small world phenomenon (see, e.g.,
Henry Kautz, Bart Selman, and Mehul Shah, ReferralWeb: Combining
social networks and collaborative filtering, Communications of the
ACM, vol. 40, pp. 63-65, 1997), which suggests a six degrees of
separation between any two persons in the world. Since the separation
between two IDnets should be less than that between two persons,
therefore the separation upper bound L in this model is set to 6.
Item 5 is set based on typical propagation delays on Internet paths.
The typical propagation delay between two wired endpoints within
the same continent ranges from several ms to several tens of ms;
the typical propagation delay between two wired endpoints across
different continents can span up to several hundreds of ms.
D is conservatively set to 1 second.

To achieve the two-day responsiveness upper bound to system data changes, an IDnet ensures to disseminate all system broadcast messages to its edge agents within one day, for example. To evaluate the minimum goodput B required to ensure this, assume an extreme case that the IDnet's trustee and trust areas include all the 40,000 IDnets. And consider the extreme case (no incremental updates) for the volume of the daily system information updates: (i) 100 agent entry updates, (ii) a trust area update consisting of entries for all 40,000 IDnets, (iii) a trustee area update consisting of entries for all 40,000 IDnets, and (iv) an endorsement update consisting of entries for all 40,000 IDnets. Referring to the message formats being shown in Section 6.1.4.1, the total size of the system broadcast messages that an IDnet needs to refresh within one day in the worst case is 39.9 MB. Using the aforementioned topological model and the inference methodology being shown in Section 6.2, the minimum goodput B=9.5 KBps.

4.4.3. Other Requirements.

4.4.3.1. Signature Generation Time Cost.

To achieve the two-day responsiveness upper bound to system data changes, we ensure to refresh signature blocks in all system broadcast messages daily. The signature generation time is evaluated for this task using the above extreme case. Then the number of signature blocks the IDnet needs to refresh daily is 40,102, including: (i) 100 for the agent entry updates (each corresponds to an edge agent), (ii) 1 for the trustee area update and 1 for the trust area update, and (iii) 40,000 for the 40,000 entries in the endorsement update (each entry corresponds an IDnet).

In the prototype implementation, the IDnet's signature is generated using the RSA algorithm with 2048-bit keys. As shown in the micro-benchmark results in FIG. 9(a), each RSA signing operation for 2048-bit keys takes 8.13 ms on the test machine using a single thread. Therefore, 40,102×8.13 ms=326 sec CPU time daily are dedicated to signature generation. If multi-threading is used, the signature generation time can be more than halved on the same machine.

4.4.3.2. Reliability Factors.

In addition to the bandwidth requirements and signature generation time as evaluated above, the following two reliability factors were also considered: (i) possible connectivity failures on Internet paths, and (ii) possible IDnet system faults.

The current Internet only provides a best effort service which does not guarantee the connectivity. To ensure the timely forwarding of protocol messages, this factor is to be considered in addition to the bandwidth requirements. According to Craig Labovitz, Abha Ahuja, Abhijit Bose, and Farnam Jahanian, Delayed Internet routing convergence, in ACM SIGCOMM '00, Stockholm, Sweden, August 2000, Internet path connectivity problems can usually be recovered within 20 minutes. Therefore expanded the time required to finish forwarding the user data update message is expanded to one hour to address this.

An IDnet's system equipment may experience software or hardware faults that impede the timely dissemination of system broadcast messages, which could affect the service availability. Therefore, it is particularly useful to ensure a high reliability for the timely dissemination of system broadcast messages. For this reason, the time required to finish the dissemination of system broadcast messages is expanded to one day. This should be sufficient to recover system faults through either automated failovers or human technical support in most cases.

4.5. User Protocol Performance

As introduced in Section 2.6.2, the IDnet user protocol is designed (i) for a user to perform identity validation through an IDnet edge agent, and (ii) for a user to retrieve an IDnet's authoritative system information (e.g., agent information, trustee or trust area definition) from its edge agents.

The performance of the IDnet user protocol depends on how the protocol is actually used in context of each specific application. In Section 6.1.5, examples are shown of such use cases in context of two typical applications—the Web application and the Email application in the trust zone. Meanwhile, the performance of the IDnet user protocol in such use cases is evaluated.

Here is a summary of the results of the performance evaluation that will be shown in Section 6.1.5. Denote by RTT the average round trip time on an Internet path between (i) a user and an IDnet edge agent, (ii) a user and a local DNS, (iii) a user and a Web site, or (iv) a user and an Email server. RTT is typically several ms to several hundreds of ms. Denote by D the transmission delay for a user to receive an update of an IDnet's trust area information. D varies between several ms to several sec depending on the update message size. Then the results are as follows:

Time overhead in Web application: The time overhead incurred by identity validation in context of the Web application is 4 RTT in the worst case and 3 RTT in the best case. In both cases, only 2 RTT of the overhead is incurred for every validation, the rest is amortized across a day.

Time overhead in Email application: The time overhead incurred by identity validation at the sender side is 9 RTT+D in the worst case and 2 RTT in the best case for the Email application. In both cases, only 1 RTT of the overhead is incurred for every validation, the rest is amortized across a day. At the receiver side, the time overhead is 1 RTT for both the worst and the best cases and is amortized across a day.

Space overhead in Email application: When applying the identity validation to the Email application, a sender needs to attach additional data to an Email. This results in 1.33 KB space overhead per Email. To the best of our knowledge, the Email traffic accounts for 1˜1.5% of total Internet traffic today (see, e.g., http://blog.wired.com/27bstroke6/2008/04/ddos-packets-ar.html) and the average Email message size is of the order of tens of kilobytes (see, e.g., “Google answers: What is the average size of an email message?”, http://answers.google.com/answers/threadview?id=312463). Therefore, this space overhead is relatively small.

### 5. RELATED WORK

5.1. Digital Certificate.

Digital certificate is a useful technique related to user identity solutions. It can certify the public key that associates with a specific user and verify the user's ownership of the corresponding private key. However, as pointed out in C. Ellison and B. Schneier, “Ten risks of PKI: What you're not being told about public key infrastructure”, Computer Security Journal, vol. 16, no. 1, pp. 1-7, 2000, it is hard to design an effective Internet-wide user identity solution based on the digital certificate itself. The key difficulty lies in that digital certificate is hard to preserve user privacy on the public Internet. This is because the public key is a fixed value, which allows others to easily track the user and link together his actions, thereby breaching his privacy. We can treat a user identity solution as the answer to the question Who are you? There can be two different ways to answer it as exemplified below:

Answer 1: I'm an accountable user. My name is William Smith.

Answer 2: I'm an accountable user.

The digital certificate based solutions answer the question in the first way, which exposes a user's privacy, while the IDnet mesh answers it in the second way. Indeed, in many cases when Internet users are asking the question who are you, what they really want to know is just whether you are accountable or not. They do not care much about what your actual name (or real identity) is. So the second way can both well answer this question and preserve user privacy.

In most cases, before a digital certificate can be useful, we first bind the digital certificate to the owner's digital identity (see, e.g., C. Ellison and B. Schneier, “Ten risks of PKI: What you're not being told about public key infrastructure”, Computer Security Journal, vol. 16, no. 1, pp. 1-7, 2000). But the question is what an effective representation of the owner's digital identity is. If the owner is a Web site, there is no problem; the domain name or other self-certifying name of the Web site can be used as its digital identity. However, when the owner is the individual Internet user that is supposed to be anonymous, the answer becomes hard. Indeed, the IDnet Mesh is answering this question.

5.2. Anonymous Credential Systems.

Anonymous credential systems such as Jan Camenisch and Anna Lysyanskaya, “An efficient system for non-transferable anonymous credentials with optional anonymity revocation”, in EUROCRYPT, 2001, vol. 2045 of LNCS, pp. 93-118; Jan Camenisch and Anna Lysyanskaya, “Signature schemes and anonymous credentials from bilinear maps”, in CRYPTO, 2004, vol. 3152 of LNCS, pp. 56-72, and Jan Camenisch and Els Van Herreweghen, “Design and implementation of the idemix anonymous credential system”, in ACM CCS '02, Washington, D.C., November 2002 can authenticate a user while retaining his anonymity at the same time. They are the best means of providing privacy for users. Their central technology is based on the group signature cryptography (see, e.g., D. Chaum and E. van Heyst, “Group signatures”, in EUROCRYPT, Brighton, UK, April 1991; M. Bellare, D. Micciancio, and B. Warinschi, “Foundations of group signatures: Formal definitions, simplified requirements, and a construction based on general assumptions.”, in EUROCRYPT, Warsaw, Poland, May 2003; D. Boneh, X. Boyen, and H. Shacham, “Short group signatures”, in CRYPTO, 2004, vol. 3152 of LNCS, pp. 41-55; Aggelos Kiayias and Moti Yung, “Group signatures with efficient concurrent join.”, in EUROCRYPT, 2005, vol. 3494 of LNCS, pp. 198-214), which can verify a user for his membership of an organization, while at the same time making authentication transactions carried out for the same user unlinkable.

The IDnet Mesh shares some flavor of an anonymous credential system in that it also verifies a user for his membership of an organization (e.g., the home IDnet), while preserving user privacy at the same time. But the way that it preserves the user privacy is different. The anonymous credential systems are designed to offer the anonymity authentication transactions (at different times) for the same user at the same place are unlinkable. Whereas, IDnet Mesh is designed to offer pseudonymity—authentication transactions for the same user across different places are unlinkable.

Although the anonymous credential systems apparently offer a higher degree of privacy which is tempting, they are not the systems that are compatible with Web sites' current practice. This is because most Web sites have to maintain accounts for their users, which inevitably makes the same user's transactions (at different times) at its place linkable. Therefore, such sites can at most offer the pseudonymity rather than the anonymity, e.g., though a user's transactions (at different times) at the same place are linkable, his transactions across different places are unlinkable. Therefore, the IDnet Mesh has actually provided the best practice on retaining user privacy at such sites.

Moreover, group signatures based approaches have a major limitation efficient membership revocation for large groups still remains an open question (see, e.g., Dawn Song and Gene Tsudik, “Quasi-efficient revocation of group signatures”, in Financial Cryptography '02, Southampton, Bermuda, March 2002; Jan Camenisch and Anna Lyasyanskaya, “Dynamic accumulators and application to efficient revocation of anonymous credentials”, in CRYPTO, 2002, vol. 2442 of LNCS, pp. 61-76; Lan Nguyen, “Accumulators from bilinear pairings and applications”, in CT-RSA, 2005, vol. 3376 of LNCS, pp. 275-292; Dan Boneh and Hovav Shacham, “Group signatures with verifier-local revocation”, in ACM CCS, Washington D.C., 2004, pp. 168-177). Therefore, the technique that underlies anonymous credential systems is not applicable for a large scale system like the IDnet Mesh, which is designed to serve potentially billions of Internet users.

Research on anonymous credential systems has also defined the term accountability. However, what such research means by accountability is the ability to revoke a user's anonymity, e.g., to downgrade from anonymity to pseudonymity. This is very different from the definition of accountability for the IDnet Mesh system, in which a type-1 accountability means the ability to deanonymize a user from his digital identity to his real identity; and a type-2 accountability means the assurance that a user cannot perform Sybil attacks.

5.3. ID-Based Cryptography.

ID-based cryptography (see, e.g., Dan Boneh and Matthew Franklin, “Identity-based encryption from the Weil pairing”, SIAM Journal on Computing, vol. 32, no. 3, pp. 586-615, 2003) is a type of public-key cryptography in which the public key of each entity can be the publicly known identity value of the entity, e.g., the domain name of a Web site, the email address of a user. One distinct advantage of this cryptography is that we no longer need a public key infrastructure (PKI) for distributing the public keys of entities, since each entity can simply use its identity as the public key. Schemes of ID-based cryptography are constructed based on bilinear pairing and exploits a novel map-to-point hash function (see, e.g., Dan Boneh, Ben Lynn, and Hovav Shacham, “Short signatures from the Weil pairing”, in Advances in Cryptology-Asiacrypt 2001, LNCS 2248, pp. 514-532; Paulo Barreto, Hae Y. Kim, and Scopus Tecnologia S. A, “Fast hashing onto elliptic curves over fields of characteristic 3”, in Cryptology ePrint Archive, Report 2001/098, http://eprint.iacr.org/2001/098/) that can map the entity's identity value to a point on an elliptic curve.

For the IDnet Mesh, an idea introduced in the ID-based cryptography is referenced to come up with a first working scheme for the pseudonymous public keys (PPK) approach that uses the point adaptation (Section 3.2.2). In the PPK scheme with point adaptation, the ID-based cryptography's idea of mapping an entity's identity to a point (through a map-to-point hash function) is contemplated. In this way, different public keys of the same user are constructed that corresponds to the identities of different parties. However, as further study has shown, a PPK scheme can also be constructed using the private key adaptation (Section 3.2.6), in which a regular hash function can be used instead of the inefficient map-to-point hash function as in the point adaptation, thereby improving the performance. In addition, the PPK is not restricted to use only the bilinear pairing based schemes as the ID-based cryptography is. It can be constructed using any elliptic curve cryptography that is based on the difficulty of the ECDLP (elliptic curve discrete logarithm problem).

The ID-based cryptography has an inherent key escrow issue which is considered to be a major limitation that impedes the wide adoption of this technology. A trusted third party, called the private key generator (PKG), holds a master private key, based on which it generates the corresponding private key for each entity. Therefore, the PKG actually escrows the private keys of all entities, which is undesirable for most cases. By contrast, in the PPK approach of the IDnet Mesh, a similar key escrow issue can be completely eliminated as shown in Section 3.2.3 due to the fundamentally different cryptographic design of PPK comparing with the ID-based cryptography.

5.4. Kerberos Cross-Realm Authentication.

Kerberos (see, e.g., “Kerberos”, http://web.mit.edu/Kerberos/) is a network authentication protocol originally designed to authenticate principals within the same realm. However, it can also be configured such that principals in one realm can authenticate to principals in another realm. This is called cross-realm authentication.

Kerberos 5 supports an additional variant of this called transitive cross-realm authentication. In traditional cross-realm authentication, realms have to be fully meshed—each pair of realms that wish to authenticate need to share a cross-realm secret. This secret is used to prove identity when crossing the boundary between realms. This means in a group of N realms,

$$\frac{N ( N - 1 )}{2}$$

secrets will need to be exchanged in order to cover all possible cross-realm authentication paths. By contrast, in transitive cross-realm authentication, we can define a path of realms connected via cross-realm secrets and use this path to hop between realms until we get credentials in the desired realm. In this way, the number of direct exchanges can be significantly reduced.

IDnet Mesh shares a flavor of the Kerberos' transitive cross-realm authentication in that it also supports the authentication across administrative boundaries and does not require the realms to be fully meshed. The path of IDnets along which a home IDnet exports authentication data to another IDnet in the trustee area is an analog of the path that connects two realms in Kerberos. As such, the number of direct cross-realm exchanges in the system can be significantly reduced and the system can become highly scalable.

However, Kerberos' cross-realm authentication has major vulnerabilities (see, e.g., I. Cervesato, A. D. Jaggard, A. Scedrov, and C. Walstad, “Specifying Kerberos 5 cross-realm authentication”, in Workshop on Issues in the Theory of Security, Long Beach, Calif., 2005, pp. 12-26; Frederick Butler, Iliano Cervesato, Aaron D. Jaggard, Andre Scedrov, and Christopher Walstad, “Formal analysis of Kerberos 5”, Theoretical Computer Science, vol. 367, no. 1, pp. 57-87,2006) in its design. A typical example is that the ticket granting server (TGS) of a remote realm can impersonate a user. When there are many remote realms, this becomes an apparent vulnerability. IDnet Mesh learns from such problems of Kerberos and adopts the novel pseudonymous public key (PPK) based solution to avoid similar pitfalls. Due to the adoption of PPK, an IDnet can only verify a user's identity but cannot impersonate a user's identity, thereby preventing the similar vulnerabilities. Moreover, the PPK can even enable the strict non-repudiation, e.g., no one (including the home IDnet) other than the identity owner can prove the possession of the identity. Whereas in Kerberos, regardless of whether cross-realm authentication is used, at least one realm, e.g., the local realm (where the user registers), is possible to impersonate a user.

In addition, like the digital certificate, Kerberos was never designed to preserve user privacy—it cannot retain the pseudonymity of users across realms. Finally, it is challenging for Kerberos to improve the scalability and reliability of its authentication service by adopting a large scale replication like the IDnet Mesh without raising significant security vulnerabilities.

5.5. Janus and PwdHash.

Eran Gabber, Phillip B. Gibbons, David M. Kristol, Yossi Matias, and Alain Mayer, “On secure and pseudonymous client-relationships with multiple servers”, ACM Transactions On Information and System Security, vol. 2, pp. 42-47,1999 and PwdHash (see, e.g., Blake Ross, Collin Jackson, Nick Miyake, Dan Boneh, and John C. Mitchell, “Stronger password authentication using browser extensions”, in USENIX Security Symposium, Baltimore, Md., 2005, pp. 2-2) are tools that allow a user to distribute hashed username and password to multiple Web sites for authentication. They are similar to IDnet Mesh in the way of exploiting the cryptographic hash to preserve a user's pseudonymity across different sites and to support unified authentication that uses the same root version of authentication data. However, IDnet Mesh differs from them in that it exploits the cryptographic hash not only to provide the pseudonymity and unified authentication, but also to achieve other advantageous goals such as high scalability and high reliability. At the same time, it does so without compromising the feasibility of providing user accountability, which is the fundamental goal of the IDnet Mesh.

Therefore, the IDnet Mesh's design is very different from that of Janus and PwdHash. A typical example is that IDnet Mesh adopts large scale replication of hashed authentication data at trusted intermediaries (e.g., IDnets) rather than exporting such data directly to Web sites, thereby achieving high scalability of the system. However, since the authentication data are stored at intermediaries rather than directly at Web sites and each intermediary can serve many Web sites, a compromised database can have much more severe impact if the compromised data can be used to impersonate users. This is because all Web sites that use the intermediary whose database is compromised can be affected rather than that in Janus and PwdHash a compromised database at a site can only affect the site itself. To solve this security issue, the IDnet Mesh introduces a decent mechanism, e.g., the pseudonymous public key (PPK), for exported authentication data in addition to the cryptographic hash approach. This mechanism ensures that even if a database is compromised, criminals are unable to use the data to impersonate users. And due to the use of PPK, the IDnet Mesh can also offer non-repudiation for the authentication, which is a desirable feature that Janus and PwdHash are unable to provide. In this way, the IDnet Mesh's authentication service can offer high scalability and high security at the same time.

5.6. Unified Authentication Solutions.

Unified authentication solutions such as, for example, OpenID (see, e.g., “OpeniD”, http://openid.net/), Google single sign-on (see “SAML single sign-on (SSO) service for Google apps”, http://code.google.com/apis/apps/sso/sam1_reference_implementation.html, Windows CardSpace (see “Introducing Windows CardSpace”, http://msdn.microsoft.com/en-us/library/aa480189.aspx), and VeriSign unified authentication (see, e.g., “VeriSign unified authentication (white paper)”, http://www.verisign.com/static/016549.pdf) allow a user to register at one place and to authenticate to many other places for applications. This significantly improves a user's online experience, since he does not have to waste time on registration and no longer needs to create and remember different passwords for different sites. The IDnet Mesh inherits this property. With the same piece of user device, e.g., the Internet passport, a user can perform identity validation at many different sites.

However, the IDnet Mesh differs from these counterparts in its authentication semantics. Instead of authenticating a user for access permission to a specific application, the identity validation service authenticates for a claim that is commonly required by applications in the trust zone, that is, whether a user is accountable. Of course, an application provider may also use the identity validation as the authentication method to access its application. But in more general cases, application providers can adopt independent authentication methods and just use identity validation to acquire the user accountability. For example, a Web site can create its own user accounts; it just uses the identity validation service to acquire each user's Sybil resilient alias and bind it to his account.

In addition, IDnet Mesh is also designed to support much higher scalability and reliability for the authentication service than the existing unified authentication solutions. It can scale to reliably serve potentially billions of Internet users and is resilient to distributed denial-of-service (DDoS) attacks. Moreover, IDnet Mesh is the only unified authentication solution that preserve a user's pseudonymity (as explained in Section 3.1.1) comparing with those counterparts. Its service therefore can be widely used at many different places without putting a user's privacy at risk.

5.7. Hardware Token Based Authentication.

Solutions such as VeriSign unified authentication (see “VeriSign unified authentication (white paper)”, http://www.verisign.com/static/016549.pdf), RSA SecurID (see “RSA SecurID”, http://www.rsa.com), VASCO Digipass (see “VASCO Digipass”, http://www.vasco.com), and many other approaches oriented to VPN and e-commerce use hardware tokens to achieve strong authentication. A strong authentication is typically a two-factor authentication (see, e.g., “What is two factor authentication?”, http://www.tech-faq.com/two-factor-authentication.shtml), which authenticates a user based on something he has (e.g., the hardware token), and something he knows (e.g., a password) or something he is (e.g., the user's biometric properties). The hardware token is designed to be tamper-resistant such that it can securely store secret data that is used for authentication. This ensures that others cannot read, alter, or duplicate the secret data without being detected; the only way to get the secret data to impersonate a user is to get the hardware token itself.

Many contemporary hardware tokens are implemented based the smart-card, which is a cheap device that can provide the tamper-resistance. In the IDnet Mesh, the user device, e.g., Internet passport, is such a hardware token. It is designed to support strong authentication for the identity validation service. As my evaluation in Section 4.2 has shown, it is highly feasible to implement the user-side cryptographic algorithms of the identity validation on a contemporary 32-bit smart-card.

5.8. Host Accountability Vs. User Accountability.

Accountable Internet protocol (ALP) (see, e.g., David G. Andersen, Hari Balakrishnan, Nick Feamster, Teemu Koponen, Daekyeong Moon, and Scott Shenker, “Accountable Internet protocol (AIP)”, in ACM SIGCOMM, Seattle, Wash., August 2008) proposes a network architecture that provides accountability as a first-order property; host identity protocol (HIP) (see, e.g., RFC 4423: Host identity protocol (HIP) architecture”, http://www.ietf.org/rfc/rfc4423.txt) provides a network solution that decouples a host's identity from its topological location. Both solutions enable host accountability. However, host accountability is fundamentally different from the user accountability that the IDnet Mesh can provide. Indeed, the key to solving those user management problems introduced above is to enable a regular approach to apply liability. The liability is always applied to users, not hosts. Therefore, host accountability is insufficient. In addition, both HIP and AIP require fundamental changes to the current Internet infrastructure and protocols, and therefore are not incrementally deployable and readily available as the IDnet Mesh solution is.

5.9. Internet Licensing Vs. Trust Zone.

Is Internet access a fundamental human right? Or is it a privilege, carrying with it a responsibility for good behavior? In other words, it is the question of whether a user should acquire an Internet license before he or she can access the Internet. This is a very controversial question confronting policy makers as they try to bring Internet access to the masses while seeking to curb illegal copying of digital music, movies, and video games, etc. See, e.g., “Should online scofflaws be denied Web access?”, The New Yorker Times, April 2009, http://www.nytimes.com/2009/04/13/technology/internet/13iht-piracy13.html.

Someone might misinterpret the IDnet Mesh as a solution that is trying to foster the Internet licensing, while indeed, the IDnet Mesh is completely different from it. The identity validation service provided by the IDnet Mesh does not authenticate a user for the access permission to the Internet. Instead, it only authenticates a user for the access permission to the trust zone, in which the trust and collaboration among online users in supported applications far outweigh other values. Meanwhile, the IDnet Mesh does not make any judgment on whether a user behaves properly or not. It is up to each application provider to make such judgments based on its policies for the application that it provides. The IDnet Mesh simply enables the feasibility for an application provider to react to a misbehaving user. The policies on how to define a misbehaving user and how to react to such a user is independently enacted by each application provider itself.

5.10. DDoS Countermeasures.

Distributed denial-of-service (DDoS) attacks are substantial threats to any public service provided on the Internet. DDoS attacks are usually resource depletion attacks rather than the bandwidth flooding attacks as they were, such that they are much harder to be detected and mitigated. Such attacks aim to deplete a server's CPU, memory, or disk resources by triggering a lot of expensive operations at the server side, e.g., cryptographic operations, database queries, storing TCP states, etc.

As the cost of the transaction in such scenarios falls overwhelmingly on the server, most countermeasure solutions to DDoS attacks are designed to transfer a corresponding cost to the requesting client. Solutions based on proof-of-work (see, e.g., Tuomas Aura, Pekka Nikander, and Jussipekka Leiwo, “DOS-resistant authentication with client puzzles”, in Security Protocols Workshop, 2000, vol. 2133 of LNCS, pp. 170-177; Wu chang Feng, Wu chi Feng, and Antoine Luu, “The design and implementation of network puzzles”, in IEEE INFOCOM, Miami, Fla., March 2005; Martin Abadi, Mike Burrows, Mark Manasse, and Ted Wobber, “Moderately hard, memory-bound functions”, in NDSS, San Diego, Calif., February 2003, pp. 25-39; Adam Back, “Hashcash—a denial of service counter-measure”, Tech. Rep., 2002, http://www.hashcash.org/hashcash.pdf; Bryan Parno, Dan Wendlandt, Elaine Shi, Adrian Perrig, Bruce Maggs, and Yih-Chun Hu, “Portcullis: Protecting connection setup from denial-of-capability attacks”, in ACM SIG-COMM, Kyoto, Japan, August 2007) induce such a cost by challenging the client to solve a computational puzzle. Solutions based on Turing test (see, e.g., Luis von Alm, Manuel Blum, and John Langford, “Telling humans and computers apart automatically”, Communications of the ACM, vol. 47, no. 2, pp. 56-60,2004; Srikanth Kandula, Dina Katabi, Matthias Jacob, and Arthur Berger, “Botz-4-sale: surviving organized DDoS attacks that mimic flash crowds”, in NSDI '05, Berkeley, Calif., May 2005; William G. Morein, Angelos Stavrou, Debra L. Cook, Angelos D. Keromytis, Vishal Misra, and Dan Rubenstein, “Using graphic turing tests to counter automated DDoS attacks against web servers”, in ACM CCS, Washington D.C., October 2003, pp. 8-19; Virgil D. Gligor, “Guaranteeing access in spite of distributed service-flooding attacks”, in Security Protocols Workshop, 2003, vol. 3364 of LNCS, pp. 97-105) do this by using human attention as the cost at the client.

There is another category of solutions proposed by researchers that is based on the concept of capability (see, e.g., Katerina Argyraki and David Cheriton, “Network capabilities: The good, the bad and the ugly.”, in ACM HotNets-IV, College Park, Md., November 2005; Xiaowei Yang, David Wetherall, and Thomas Anderson, “A DoS-limiting network architecture”, in ACM SIGCOMM, Philadelphia, Pa., August 2005; Tom Anderson, Timothy Roscoe, and David Wetherall, “Preventing internet denial-of-service with capabilities”, SIGCOMM Comput. Commun. Rev., vol. 34, no. 1, pp. 39-44, 2004; Hitesh Ballani, Yatin Chawathe, Sylvia Ratnasamy, Timothy Roscoe, and Scott Shenker, “Off by default!”, in ACM HotNets-IV, College Park, Md., November 2005; Abraham Yaar, Adrian Perrig, and Dawn Song, “SIFF: A stateless internet flow filter to mitigate DDoS flooding attacks”, in IEEE Security and Privacy, 2004, pp. 130-143). They are proposing to flip the default access permission to the network or a host from “on” to “off”. However, such solutions are very complex to implement in practice they require major changes in the Internet's basic infrastructure and protocols, and some of them even raise the controversial “Internet licensing” problem.

The IDnet Mesh's online validation service offers a novel and practical DDoS countermeasure solution for application providers by relieving their servers from the expensive cost. Before knowing that a user is accountable, an application server does not have to perform any expensive operations (including the public key cryptography and database operations) or maintain any state for the user as explained in Section 2.5.4.2. It transfers the burden from a single application server to the large IDnet Mesh system that is highly resilient to DDoS attacks.

The IDnet Mesh system itself can be very resilient to DDoS attacks due to the feasibility of large scale replication of its service. The adoption of cryptographic hash and pseudonymous public key (PPK) technology significantly reduces the sensitivity of replicated authentication data, thereby making the large scale replication highly feasible. Cheap computing resources provided by third parties, e.g., leased servers or the Amazon Elastic Compute Cloud (Amazon EC2) to deploy the IDnet Mesh's authentication service can be safely used. Of course, the IDnet Mesh system can also exploit the proof-of-work or Turing test solutions to mitigate DDoS attacks. For example, a client can be challenged with a computational puzzle or a distorted image when the attack level is extremely high.

Finally, the IDnet Mesh can provide such DDoS countermeasure solutions without any change to the existing Internet infrastructure and protocols as the capability based solutions require.

5.11. Cloud Computing.

Cloud computing such as the Amazon Elastic Compute Cloud (Amazon EC2) (see, e.g., “Amazon elastic compute cloud (Amazon EC2)”, http://aws.amazon.com/ec2/) is an innovative business that delivers hosted services over the Internet as the datacenter technologies quickly evolve in recent years. Cloud computing has two distinct characteristics that differentiate it from traditional hosting: (i) It is sold on demand, typically by the minute or the hour. (ii) It is elastic—a customer can have as much or as little of a service as it wants at any given time.

Cloud computing is an excellent service that an IDnet provider can use, in particular, for a provider with weak economy. It allows the IDnet provider to quickly deploy many IDnet agent servers that span wide geographic area. The IDnet provider pays for only as much capacity as is needed, and can bring more online as soon as required. This makes the IDnet provider adapt its expenditure dynamically with the actually load of identity validation service. Moreover, this payfor-what-you-use model is particularly suitable for the DDoS countermeasure. As we can expect, an IDnet provider only needs to significantly raise the capacity of computing resources when its servers are under DDoS attacks, while in most time, it only needs a much smaller capacity of computing resources. By using the cloud computing service, the IDnet provider does not have to spend a lot of money to aggressively over-provision the computing resources in order to meet the peak load happened during DDoS attacks.

The reason that the IDnet Mesh can safely use cloud computing while most other authentication solutions may not is due to its adoption of cryptographic hash and pseudonymous public key (PPK) technology as described in the previous section. As such, the sensitivity of replicated authentication data is significantly reduced, therefore computing resources provided by the third party for the identity validation service can be safely be used.

5.12. Trust Model Comparison.

The trust model of IDnet Mesh shares a flavor of web of trust (see, e.g., William Stallings, “The PGP web of trust”, BYTE, vol. 20, no. 2, pp. 161-162, February 1995) (e.g., OpenPGP's PKI) in that both of them exploit a bottom-up trust propagation process and use decentralized trusts, which is realistic in terms of the trust evolution nature. On the contrary, the X.509 PKI (see, e.g., “ITU-T Recommendation X.509: Information technology—Open systems interconnection—The directory: Public-key and attribute certificate frameworks”) assumes a strict top-down hierarchy of trust which relies on a single self-signed root that is trusted by everyone. The unreality of such a centralized trust structure at a global scale impedes the X.509 PKI from evolving to a global solution. Currently most X.509 PKI systems stay at enterprise scales.

The trust model of IDnet Mesh differs from the web of trust in that it requires each identity provider to explicitly express its trust and prohibits the implicit transitive trust (e.g., if A trusts B and B trusts C, we conclude that A trust C as well). Therefore, it prevents the uncertainty of trust caused by the implicit transitive trust during trust revocation. By contrast, the web of trust fundamentally depends upon the implicit transitive trust for trust propagation, hence it suffers from the uncertainty of trust problem.

Finally, IDnet Mesh's trust model is much more practical to deploy than social-networking based solutions (see, e.g., Alan Mislove, Ansley Post, Krishna P. Gummadi, and Peter Druschel, “Ostra: Leveraging trust to thwart unwanted communication”, in NSDI '08, San Francisco, Calif., April 2008), because it removes the trust burden from individual users and delegates this job to identity providers.

### 6. SYSTEM DETAILS

In this section, details on (i) the prototype implementation of the IDnet Mesh system (Section 6.1), (ii) the analytical model based evaluation methodology for the system performance (Section 6.2), and (iii) approaches to achieve rigorous verification on users' real identities at the home IDnet in practice (Section 6.3) are described.

6.1. Prototype Implementation Details.

Details of the system prototype implementation are described, including implementations of (i) the Internet Passport (Section 6.1.1), (ii) the user database (Section 6.1.2), (iii) the core algorithm of identity validation (Section 6.1.3), and (iv) the IDnet protocols (Section 6.1.4). Two use case examples are described in the context of typical applications to explain how the identity validation service provided by the IDnet Mesh can be applied in practice (Section 6.1.5). In addition, a demo system of the IDnet Mesh is described that integrates all modules being introduced in Sections 6.1.1˜6.1.5 to give a more complete understanding on the system implementation (Section 6.1.6).

6.1.1. Internet Passport

6.1.1.1. Features Summary.

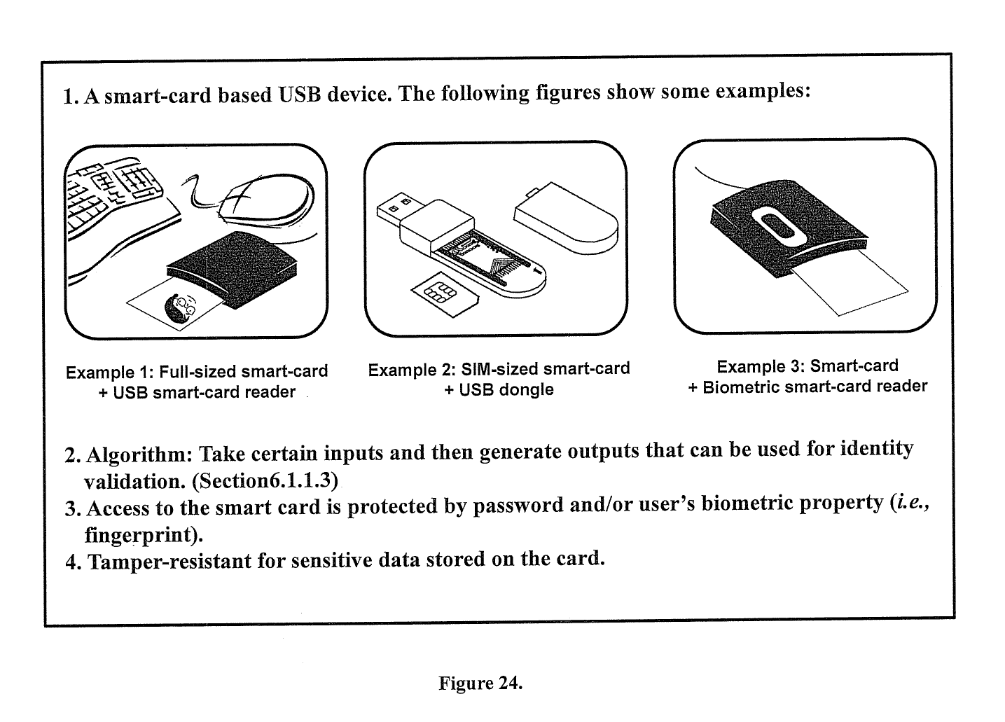

FIG. 24 summarizes the features that an Internet passport is designed to provide.

6.1.1.2. Implementation.

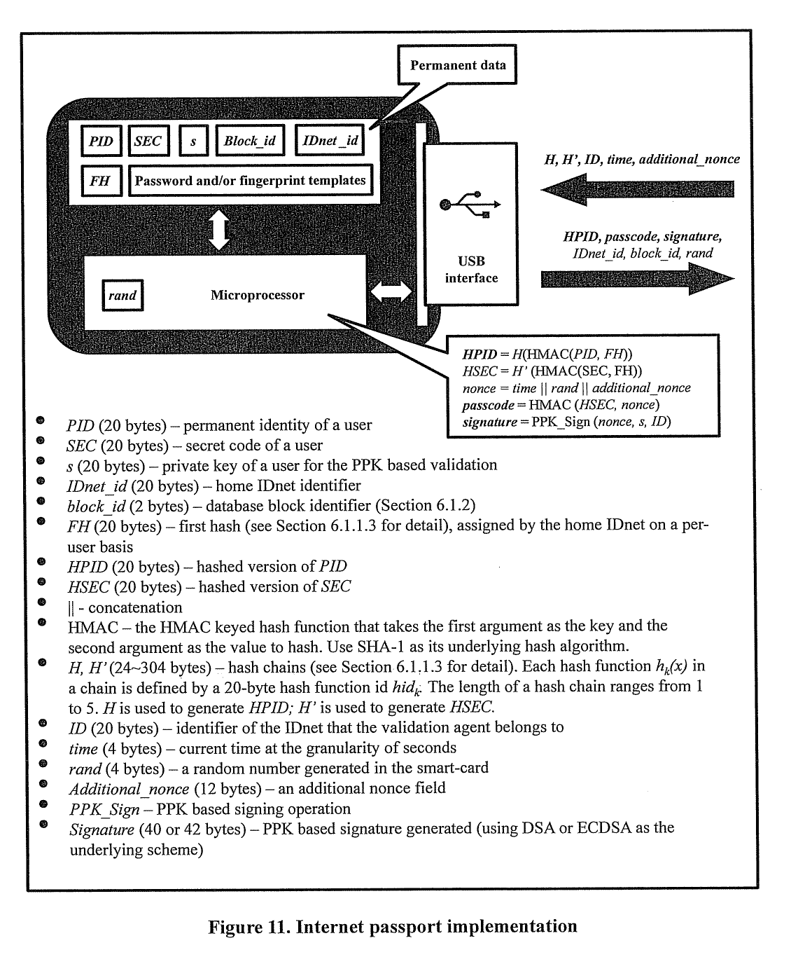

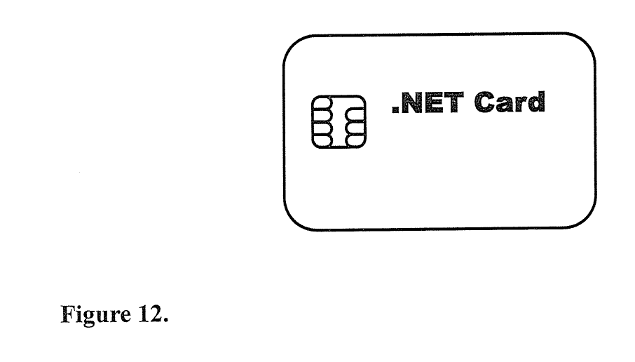

FIG. 11 illustrates the details of the Internet passport in my prototype implementation. Following this specification, a smart-card based implementation and a software simulated implementation are provided. The smart-card based implementation is built upon a type of .NET smart-card (see, e.g., “Feitain .net smart card”, http://ftsafe.com/products/dotNet-Card.html) as shown in FIG. 12. The on-card program is compiled as the .NET framework IL (see, e.g., “Introduction to IL assembly language”, http://www.codeproject.com/KB/msil/ilassembly.aspx). It provides all features depicted in FIG. 11 except the PPK based signing function. Whereas the software simulated Internet passport supports everything. Its PPK based signing is implemented based on DSA and uses private key adaptation, and the code is written in C# using library of .NET framework 2.0.

6.1.1.3. Algorithm.

Table 6.2 Describes the Algorithm Running on the Internet Passport.

TABLE 6.2
Algorithm running on the Internet passport

| | |
|---|---|
| 1. | Take inputs H, H′, ID, time, and additional_nonce |
| 2. | Compute HPID = H (HMAC(PID, FH)) |
| 3. | Compute HSEC = H′(HMAC(SEC, FH)) |
| 4. | Generate random number rand and compute nonce = |
| | time \|\| additional_nonce \|\| rand |
| 5. | Compute passcode = HMAC (HSEC, nonce) |
| 6. | Compute signature = PPK+Sign (nonce, s, ID) |
| 7. | Output HPID, passcode, signature, IDnet_id, block_id, and rand. |

Hash chains H and H′. Take H for example. A hash chain H is equivalent to a composite hash function y=H(x). The function is computed by iteratively applying each hash function hₖ(x) in the chain (k=1˜N). Here N is the length of the hash chain. The minimum length of the hash chain is 1, and the maximum length of the hash chain is 15. Each hash function hₖ(x) is defined by a 20-byte hash function id hidₖ. H is therefore represented by its definition parameters in the following data format:

| | | | | | |
|---|---|---|---|---|---|
| Reserved | N (4 bits) | hid₁ | hid₂ (20 bytes) | . . . | hid_{N} (20 bytes) |
| (28 bits) | | (20 bytes) | | | |

The hash function hₖ(x) is implemented as: hₖ(x)=HMAC(x,hidₖ). And SHA-1 is used as the underlying hash algorithm for the HMAC.

Here is an example for the definition of y=H(x): Suppose N=4, hid₁=23, hid₂=6, hid₃=9, and hid₄=15. Then y=H(x) is computed as follows:

x₁=HMAC(x,23)

x₂=HMAC(x₁,6)

x₃=HMAC(x₂,9)

y=HMAC(x₃,15)

Hash chain H is used to generate HPID, e.g., the hashed version of PID; and hash chain H′ is used to generate HSEC, e.g., the hashed version of SEC.

First hash (FH). When generating HPID and HSEC, an additional hash is first computed before applying the hash chain H or H′ as shown in Table 6.2. This hash is called the first hash. It is constructed the same way as the hash function hₖ(x) and uses the data field FH as its hash function id. FH is stored in the Internet passport and is initialized to 0. It is designed to facilitate the change of a user's hashed PIDs at all places. Such a change might be necessary when a user's pseudonymity at different places is breached. Every time when a home IDnet performs such a change, it increments the user's FH by 1. Then it recomputes hashed PIDs based on the new FH and exports them to edge agents and other IDnets. With FH, it becomes easy to keep track of all old versions of hashed PIDs without costing additional spaces on the Internet passport or in a database.

6.1.2. User Database.

The central node or each edge agent of an IDnet maintains a user database which stores authentication data of user accounts that are either created by the IDnet itself or exported from other IDnets. The authentication data of each user account are represented by a user entry. Each user entry is in form of a 4-tuple {HPID, HSEC, PPK, block_id}. HPID and HSEC are the hashed version of a user's PID and SEC at the central node or edge agent. PPK is the user's pseudonymous public key at this IDnet. block_id is the identifier of the user block The user data of each IDnet stored in the database are divided into large user blocks. Each block contains up to 100,000 user entries. The key design reason for defining the user block is to bound the precomputation time cost for reverse mapping operations. When we want to reverse map the HPID to its PID at the home IDnet, we need to precompute a table that maps each PID to its HPID. With the user blocks, this precomputation only needs to be performed on a block's boundary, which takes less than 3 seconds based on the benchmark result on my test machine. The precomputation time cost is amortized across all reverse mapping operations for HPIDs in the same block and the mapping tables for frequently accessed blocks can be cached. The block_id is 2-byte long, which implies that each IDnet can have up to 64K user blocks. This corresponds to up to 6.5 billion users, which is about the number of the current world population.

The user database is implemented using MySQL. The database includes a number of tables with the same structure. Each table stores up to 16 user blocks for the same IDnet, and therefore can accommodate up to 1.6 million user entries. The name of each table is a 48-character string encoded based on both the IDnet identifier and the block_id. The IDnet identifier is a 20-byte self-certifying flat name generated using SHA-1 hash. The table name encodes the IDnet identifier in the hexadecimal string format with 40 characters. The table name also encodes the high 12 bits of the block_id in the hexadecimal string format with 3 characters. The other 5 characters of the table name is the prefix IDnet.

6.1.3. Core Algorithm.

In this section, details are shown about implementing the IDnet Mesh system's core algorithm, e.g., the identity validation algorithm. Tables 6.3 and 6.4 list the detailed procedures of the algorithms running at the user side and the validation agent side respectively.

The code of the user side algorithm is written in C# and the library provided by .NET framework 2.0 for cryptographic functions is used. The code of the validation agent side algorithm is written in C++ and I use the Crypto++ (see, e.g., “Crypto++ library”, http://www.cryptopp.com/) library for cryptographic functions. For the RSA cryptography, the RSAES-PKCS1-v1_{—}5 for the RSA encryption scheme and RSASSA-PSS for the RSA signature scheme (see, e.g., “RFC 3447: Public-key cryptography standards (PKCS) #1: RSA cryptography specifications version 2.1”, http://www.ietf.org/rfc/rfc3447.txt) are chosen. For the PPK based signature verification performed at the validation agent side, the current implementation supports both the DSA and ECDSA schemes.

TABLE 6.3
Procedure of identity validation algorithm (user side)
At the user side

0. The Internet passport stores PID, SEC, s, PH, IDnet_id, and, block_id.
1. The user chooses a suitable validation agent (denoted by v), and
resolves the corresponding hash chains Hᵥ, H′ᵥ, public key PubKeyᵥ
of this agent, and ID of the IDnet that it belongs to using the
IDnet user protocol.
2. The user inputs Hᵥ, H′ᵥ, ID, time, and additional_nonce into the
Internet passport. In return, the Internet passport outputs HPIDᵥ,
passcode, signature, IDnet_id, block_id, and rand as
explained in Section 6.1.1.2 and 6.1.1.3.
3. The user generates the temporary identity TID using the following
equations:
nonce = time || additional_nonce || rand
TID = RSA_Encrypt(IDnet_id || block_id || HPIDᵥ || context || nonce ||
sym_key, PubKeyᵥ)
RSA_Encrypt - RSA encryption operation
context (20 bytes) - service context. For online validation, it can be used
to encode service parameters. For offline validation, it is the SHA-1
fingerprint of the message or data object to certify and to deliver.
sym_key (32 bytes) - symmetric key. It can be used to encrypt
additional data.
4. The user sends TID, passcode, and signature to the validation agent.

6.1.4. IDnet Protocols

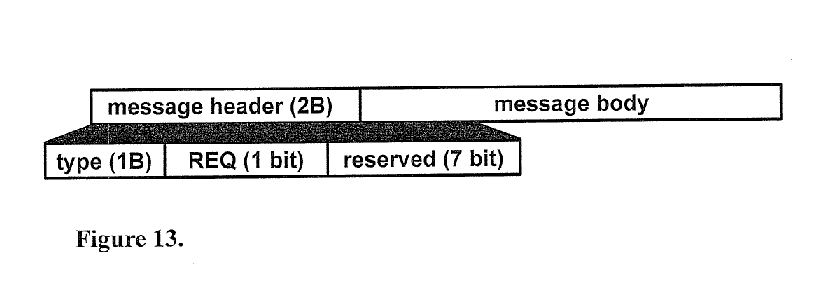

The IDnet Mesh system defines two types of protocols—IDnet system protocol and IDnet user protocol, as introduced in Section 2.6. In the prototype implementation, both protocols share the same general message format as shown in FIG. 13. Each message consists of a 2-byte message header and a variable length message body. The message header includes two fields: (i) type code, which specifies the message type, and (ii) REQ bit, which indicates whether the message is a request.

6.1.4.1. IDnet System Protocol.

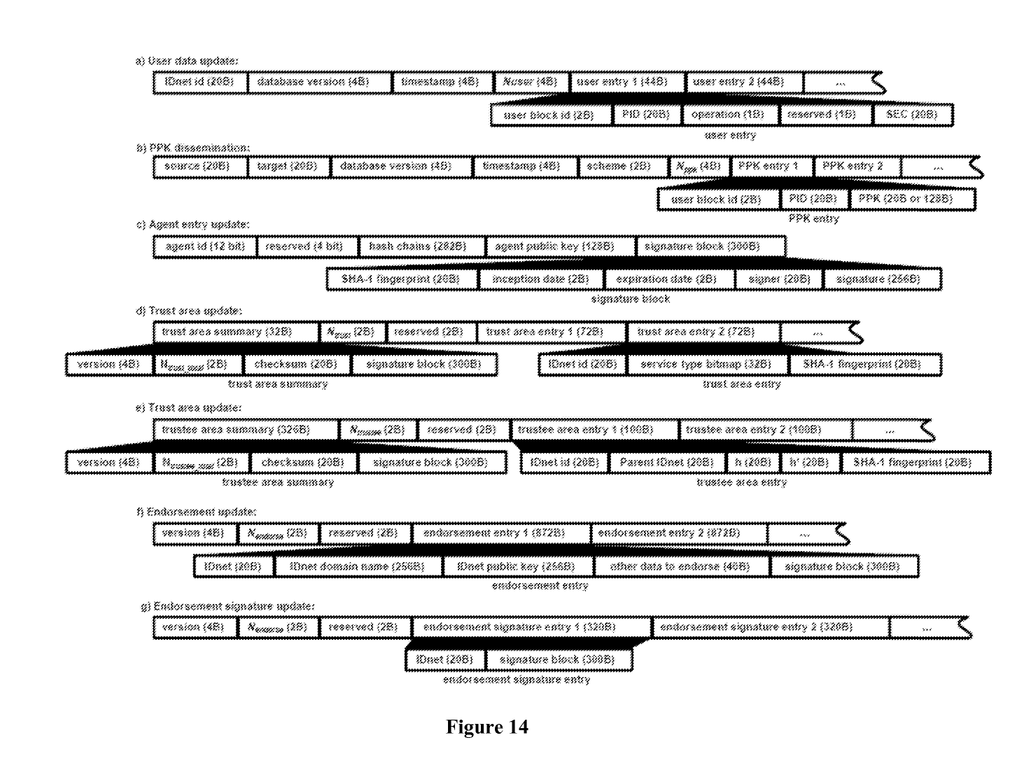

Table 6.5 summarizes 7 types of IDnet system protocol messages. FIG. 14 depicts the message body format for each of them. This includes the user data update message and the 5 types of system broadcast messages as introduced in Section 2.6.1. In addition, it also includes a PPK dissemination message, which is designed to distribute users' PPKs. All IDnet system protocol messages are implemented using TCP.

TABLE 6.4
Procedure of identity validation algorithm (validation agent side)
At the validation agent side

5. Upon receiving the TID, passcode, and signature from the user, the
validation agent first decodes TID using the following equations to restore
IDnet_id, block_id, HPIDᵥ, context, and time, etc.
(IDnet_id || block_id || HPIDᵥ || context || nonce || sym_key) =
RSA_Deerypt(TID, PriKeyᵥ)
(time II additional_nonce II rand) = nonce
PriKeyᵥ - private key of the validation agent v.
6. The validation agent checks whether the time field differs less than
30 seconds from its own clock. If not, it returns reject for the validation.
7. The validation agent queries its user database to fetch the user's HSECᵥ
and PPK based on IDnet_id, block_id, and HPIDᵥ.
If the user entry is not found, it returns reject as the validation result.
8. The validation agent regenerates the passcode the same way as the
user does and checks whether it is the same as the passcode provided
by the user. If not, it returns reject.
passcode = HMAC(HSECᵥ, nonce)
9. The validation agent verifies the signature based on the user's PPK.
true or false = Verify(nonce, signature, PPK)
Verify - signature verification operation of either DSA or ECDSA scheme
(It takes the first parameter as the message, the second parameter
as the signature, and the third parameter as the public key.)
10. If this is an online validation, the validation is done and the
validation agent returns OK.
11. For offline validation, the validation agent generates a 128-byte
digital signature V_signature using the following equation.
The signature certifies the association between the TID and context.
The validation agent then returns the signature to the user.
V_signature = RSA_Sign(TID || context, PriKeyᵥ)
RSA_Sign - RSA signing operation

TABLE 6.5
IDnet system protocol messages

| | | | |
|---|---|---|---|
| Protocol message name | Type code | REQ | Body size (bytes) |

1. User data messages:

| | | | |
|---|---|---|---|
| User data update | 0h | 0 | 32 + 44 Nᵤₛₑᵣ |
| | | | ECDSA: 32 + 44Nₚₚₖ |
| PPK dissemination | 1h | 0 | DSA: 32 + 150Nₚₚₖ |

2. System broadcast messages:

| | | | |
|---|---|---|---|
| Agent entry update | 10h | 0 | 712 |
| Trust area update | 11h | 0 | 330 + 72Nₜᵣᵤₛₜ |
| Trustee area update | 14h | 0 | 330 + 100Nₜᵣᵤₛₜₑₑ |
| Endorsement update | 12h | 0 | 8 + 872N_{endorse} |
| Endorsement signature update | 13h | 0 | 8 + 320N_{endorse} |

User data update consists of a list of user entries that need to be updated for an IDnet whose identifier is indicated by the field IDnet id. Each user entry contains the hashed version of a user's PID and SEC. The update initiates from the home IDnet's central node and later propagates to edge agents of all IDnets within the trustee area. The propagation paths are: (i) from an IDnet's central node to other IDnets' central nodes, (ii) from an IDnet's central node to all its level-1 agents, and (iii) from a level-1 agent to all its level-2 agents, and so on. At each propagation hop, an additional hash is applied to the PID and SEC fields in each user entry.

PPK dissemination consists of a list of PPK entries. Each PPK entry contains a user's pseudonymous public key PPK at a specific target IDnet (whose identifier is indicated by the target field) within the trustee area. The size of each PPK is either 20 bytes or 128 bytes, which corresponds to the signature scheme of 160-bit ECDSA or 1024-bit DSA respectively. The PPK dissemination is sent from the home IDnet (whose identifier is indicated by the source field) to the target IDnet along the same path as the corresponding user data update is propagated.

Agent entry update is designed to announce edge agent information. It contains an agent entry, which consists of the identifier, hash chains, and public key associated with a specific edge agent. In addition, it includes a signature block which certifies the entry. The signature block includes: (i) an SHA-1 fingerprint for the entry data, (ii) the inception date and expiration date of signature, (iii) the signer, which is the IDnet identifier, and (iv) a 2048-bit RSA signature provided by the IDnet. The signature block is updated every day and expires after two days. An IDnet updates agent entries every day. If no changes happen to an edge agent's information (which is the common case), only the signature block needs to be updated.

Trust area update is designed to announce an IDnet's trust area definition. It includes a trust area summary and a list of trust area entries. The former is a short digest for the trust area definition. The latter lists all IDnets in the trust area. Each trust area entry corresponds to one IDnet. It consists of an IDnet identifier and a service type bitmap. The service type bitmap can be used to define the types of services that the specified IDnet is trusted for. If all bits of this bitmap are set to zero, the specified IDnet will be revoked from the trust area. An IDnet disseminates a trust area update to all its edge agents every day. The update is usually incremental—it only includes those IDnets whose information has been changed.

Trustee area update is designed to announce an IDnet's trustee area definition. Its format is similar to that of the trust area update. It consists of a list of trustee area entries. Each trustee area entry provides information of an IDnet, including its parent IDnet in the trustee area, and the cross-IDnet hash functions h and h′ with which the parent IDnet exports hashed authentication data to it.

Endorsement update and endorsement signature update are designed to announce and certify information about each IDnet in the trust and trustee areas. The latter is a compact version of the former. In general cases, an IDnet broadcasts daily to its edge agents an endorsement update, which includes IDnets whose information has been changed, and an endorsement signature update, which includes the remaining IDnets. The endorsement update consists of a list of endorsement entries, each of which certifies the identifier, domain name, and public key of an IDnet.

6.1.4.2. IDnet User Protocol.

Table 6.6 summarizes IDnet user protocol messages. As introduced in Section 2.6.2, they are divided into two categories—identity validation messages and system broadcast messages.

TABLE 6.6
IDnet user protocol messages

| | | | |
|---|---|---|---|
| Protocol message name | Type code | REQ | Body size (bytes) |

1. Identity validation messages:

| | | | |
|---|---|---|---|
| Online validation request | 30h | 1 | 446 |
| Online validation response | 30h | 0 | 310 |
| Offline validation request | 31h | 1 | 190 |
| Offline validation response | 31h | 0 | 256 |

2. System broadcast messages:

| | | | |
|---|---|---|---|
| Agent entry request | 32h | 1 | 4 |
| Agent entry response | 32h | 0 | 718 |
| Endorsement entry request | 33h | 1 | 24 |
| Endorsement entry response | 33h | 0 | 878 |
| Trust area summary request | 34h | 1 | 4 |
| Trust area summary response | 34h | 0 | 330 |
| Trustee area summary request | 35h | 1 | 4 |
| Trustee area summary response | 35h | 0 | 330 |
| Trust area list request (TCP) | 36h | 1 | 4 |
| Trust area list response (TCP) | 36h | 0 | 334 + 72Nₜᵣᵤₛₜ |
| Trustee area list request (TCP) | 37h | 1 | 4 |
| Trustee area list response (TCP) | 37h | 0 | 334 + 100Nₜᵣᵤₛₜₑₑ |

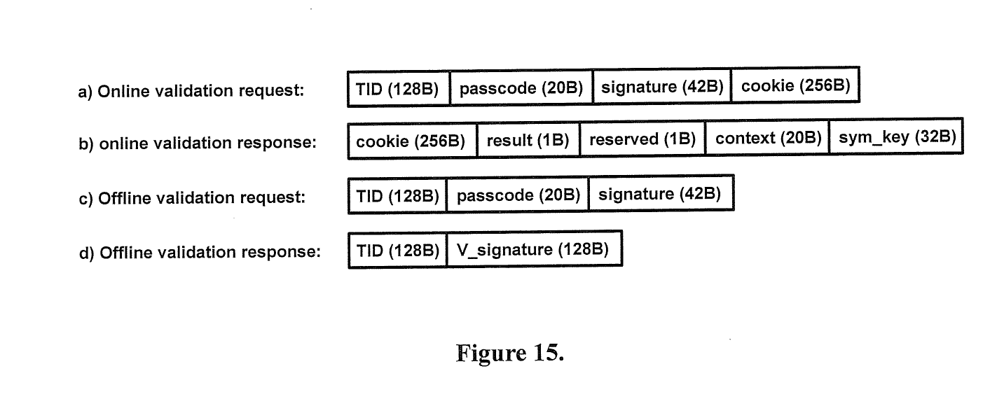

The identity validation messages define the request and response formats for online and offline validations. The formats are illustrated in FIG. 15. The cookie field in the online validation request/response can be used to encode identifier and states associated with the service session. With the cookie, an application provider (e.g., a Web site) does not have to maintain any state for a service session until the validation completes. All four types of identity validation messages are implemented using UDP.

The system broadcast messages enable users to fetch and refresh authoritative system information from IDnet edge agents: (i) Agent entry request/response are designed for a user to fetch and refresh the agent entry for the edge agent that the request is sent to. (ii) Endorsement entry request/response are designed for a user to fetch and refresh the endorsement entry for a specified IDnet in the trust and trustee areas. (iii) Trust area summary request/response, trust area list request/response, trustee area summary request/response, and trustee area list request/response are designed for a user to obtain an IDnet's trust and trustee area updates.

Most system broadcast messages of the IDnet user protocol are implemented using UDP. And only the following four types of messages use TCP: trust area list request/response, and trustee area list request/response. These four types of messages can also be implemented using a P2P system instead of in the client-server mode as in my prototype implementation. This would allow them to easily scale even when there is an extraordinary large number of concurrent requests. Note that since the data carried in the responses are signed by the IDnet, the authenticity of the data is guaranteed even if we use the P2P system.

6.1.5. Use Case Examples.

In this section, use case examples are shown in the context of two typical applications—the Web application and the Email application in the trust zone. It is explained how the IDnet user protocol can be integrated in such applications to support identity validation. Meanwhile, the protocol performance in terms of time overhead and space overhead is evaluated.

TABLE 6.7
Use case example of Web application
Web: Online validation

| Worst case: 4 RTT (2 RTT is amortized across a day) | | |
|---|---|---|
| 1. Send a pre-service request to the Web site (denote by b). | 1 | RTT |
| b responds with a list of preferred IDnets represented | | |
| by their IDnet identifiers. | | |
| 2. Choose a validation agent (denote by v) from one of the | — | |
| candidate IDnets. The candidate IDnets are resolved by taking | | |
| an intersection between the trustee area of the home IDnet | | |
| (denote by Iₕₒₘₑ) and the list of preferred IDnets | | |
| that b has provided. | | |
| 3. Do the following in parallel: | 1 | RTT |
| 1) Denote by V the IDnet that v belongs to. Fetch V's | (1 | RTT) |
| endorsement entry from an edge agent of Iₕₒₘₑ | | |
| (through endorsement entry request/response). | | |
| 2) Fetch v's agent entry from v (through agent entry | (1 | RTT) |
| request/response). | | |
| 4. Verify the integrity of v's agent entry based on V's public | — | |
| key provided in the above endorsement entry. | | |
| 5. Generate TID, passcode, and signature. Then send a (UDP) | 0.5 | RTT |
| service request to b together with the TID, passcode, | | |
| signature, and v's IP. | | |
| 6. b relays the TID, passcode, and signature to v in form | 1 | RTT |
| of the online validation request and performs the online | | |
| validation using v. | | |
| 7. b responses to the service request based on the online | 0.5 | RTT |
| validation result provided by v. | | |
| Best case: 3 RTT (1 RTT is amortized across a day) | | |
| 1. Do the following in parallel: | 1 | RTT |
| 1) Update V's endorsement entry from an edge agent of Iₕₒₘₑ | (1 | RTT) |
| 2) Update v's agent entry from v. | (1 | RTT) |
| 2. Steps 5-7 of the worst case. | 2 | RTT |

The time overhead is represented by the measures RTT and D, which are defined as follows: RTT is the average round trip time on an Internet path between (i) a user and an IDnet edge agent, (ii) a user and a local DNS, (iii) a user and a Web site, or (iv) a user and an Email server. RTT is typically several ms to several hundreds of ms. D is the transmission delay for a user to receive a trust area list response message. It varies between several ms to several sec depending on the update message size.

TABLE 6.8
Use case example of Email application

| Email: Offline validation (sender side) | | |
|---|---|---|
| Worst case: 9 RTT + D | | |
| (8 RTT + D is amortized across a day) | | |
| 1. Resolve the trust area of the receiver. | 5 RTT + D | |
| 1) Resolve the primary delegate (denote by B, refer to | (1 | RTT) |
| Section 2.5.1) of the receiver's Email provider | | |
| (e.g., Gmail, hobnail) via the Email provider's server. | | |
| 2) Select an edge agent of B based on B's domain name. | (2 | RTT) |
| (Refer to Table 6.9 Select an edge agent of an IDnet other | | |
| than home IDnet for this process. Note that the step | | |
| of fetching B's endorsement entry can be skipped | | |
| since the sender can resolve B's domain name and | | |
| public key through the above step.) | | |
| 3) Fetch the trust area update of B from the above agent | (2 RTT = D) | |
| (through trust area list request/response). | | |
| 2. Choose an IDnet (denote by V) among the intersection | — | |
| between the trust area of B and the trustee area of the home | | |
| IDnet (denote by Iₕₒₘₑ) | | |
| 3. Select an edge agent (denote by v) of V. | 3 | RTT |
| (Refer to Table 6.9 for this process.) | | |
| 4. Do offline validation via v and get v's signature | 1 | RTT |
| (denote by V_signature). | | |
| 5. Send the Email message together with the TID, | — | |
| V_signature, and v's agent entry. | | |
| (Note that time cost for this step is not overhead.) | | |
| Best case: 2 RTT (1 RTT is amortized across a day) | | |
| 1. Do the following in parallel: | 1 | RTT |
| 1) Verify that B is still the primary delegate of the | (1 | RTT) |
| receiver's Email provider. | | |
| 2) Update B's trust area summary from an edge agent of B | (1 | RTT) |
| (through trust area summary request/response). | | |
| 3) Update V's endorsement entry from an edge agent | (1 | RTT) |
| of Iₕₒₘₑ | | |
| 4) Update v's agent entry from v. | (1 | RTT) |
| 2. Steps 4-5 of the worst case. | 1 | RTT |
| Email: Offline validation (receiver side) | | |
| Both worst case and best case: 1 RTT | | |
| (amortized across a day) | | |
| 1. Fetch V's endorsement entry from an edge agent of B. | 1 | RTT |

| | |
|---|---|
| 2. Verify the integrity of the Email using the signature | — |
| and the agent entry attached to the Email. | |

TABLE 6.9
Process of selecting an edge agent of an IDnet other than the home IDnet
Select an edge agent of an IDnet (denote by I) other than home
IDnet (denote by Iₕₒₘₑ)

| Worst case: 3 RTT (amortized across a day) | | |
|---|---|---|
| 1. Fetch the endorsement entry of I from an edge agent of | 1 | RTT |
| Iₕₒₘₑ (through endorsement entry request/response) | | |
| to get I's domain name and public key. | | |
| 2. Resolve an edge agent i of I via local DNS based on | 1 | RTT |
| I's domain name | | |
| 3. Fetch i's agent entry (through agent entry request/response) | 1 | RTT |
| from i. | | |
| 4. Verify the integrity of the agent entry. | — | |
| Best case: 1 RTT (amortized across a day) | | |
| 1. Do the following in parallel: | 1 | RTT |
| 1) Update I's endorsement entry from an edge agent of Iₕₒₘₑ. | (1 | RTT) |
| 2) Update i's agent entry from i. | (1 | RTT) |

Denote by Iₕₒₘₑ the home IDnet of a user; denote by B the primary delegate of a user's Email provider. The time overhead does not include the following operations from the user's perspective: (i) selecting an edge agent of Iₕₒₘₑ or B (this includes to resolve the edge agent via a local DNS based on Iₕₒₘₑ or B's domain name, to download and to verify the edge agent's agent entry), and (ii) downloading Iₕₒₘₑ or B's trustee area update from the above agent and verifying it. Both operations can be preprocessed automatically once a user's computer connects to the Internet.

The time overhead for transmitting any system broadcast messages of the IDnet user protocol is amortized across a day. This is because those authoritative system announcements, e.g., data carried in the system broadcast messages, can be changed at most once a day. Moreover, all such authoritative system announcements are very likely to remain unchanged over longer time scales, which makes them good candidates for caching. Therefore, in the best case, what the daily updates (at the user's computer) actually do is simply refreshing the signature blocks and verifying that the cached system announcement data are still valid.

6.1.5.1. Web: Online Validation.

The Web application is a typical example where online validation can be applied. Table 6.7 shows such a use case example. It also summarizes the corresponding time overhead incurred by the identity validation in both the worst case and the best case. The best case results from the effective use of caching (e.g., system announcement data are already cached and still valid).

As we can see, the time overhead incurred by the identity validation in the Web application is 4 RTT in the worst case and 3 RTT in the best case. In both cases, only 2 RTT of the overhead is incurred for every validation, the rest is amortized across a day.

6.1.5.2. Email: Offline Validation.

Email application is a typical example where offline validation can be applied. Table 6.8 shows such a use case example and summarizes the corresponding time overhead.

As we can see, the time overhead incurred by the identity validation at the sender side is 9 RTT+D in the worst case and 2 RTT in the best case. In both cases, only 1 RTT of the overhead is incurred for every validation, the rest is amortized across a day. At the receiver side, the time overhead is 1 RTT for both the worst and the best cases and is amortized across a day.

When using the offline validation for the Email application, a sender needs to attach the following data to an Email: TID (128 bytes), SHA-1 fingerprint (20 bytes) of the Email message, the signature (128 bytes) provided by the validation agent v, and the agent entry (712 bytes) of v. With Base64 encoding, these data result in 1.33 KB space overhead per Email. Email traffic accounts for 1˜1.5% of total Internet traffic today (see, e.g., http://blog.wired.com/27bstroke6/2008/04/ddos-packets-ar.html) and the average Email message size is of the order of tens of kilobytes (see, e.g., “Google answers: What is the average size of an email message?”, http://answers.google.com/answers/threadview?id=312463). Therefore, this space overhead is relatively small.

6.1.6. Putting Everything Together—a Demo System.

To get a more complete understanding on the system implementation, a demo system has been developed in context of the Web application. It integrates all modules that have been introduced so far from Section 6.1.1 to Section 6.1.5. In addition to these modules, a number of auxiliary systems and tools have been built that are useful for this demo, including (i) a demo Web site which plays the role of an application provider that uses the IDnet Mesh's service, (ii) a demo version of the IDnet Mesh system consisting of three IDnets and six edge agents, (iii) a Web-based tool to manage this demo version of IDnet Mesh system and its registered users, and (iv) GUI tools to operate the Internet passport.

6.1.6.1. Client Software and Device.

Consider, for example, that you are a user who has been issued an Internet passport from a specific home IDnet. With this Internet passport, you can access all application providers in the trust zone. Then what kind of software for the Internet passport do you need to install on your computer in order to do this? The client software, AuthAgent, that was built for this demo system is answering this question.

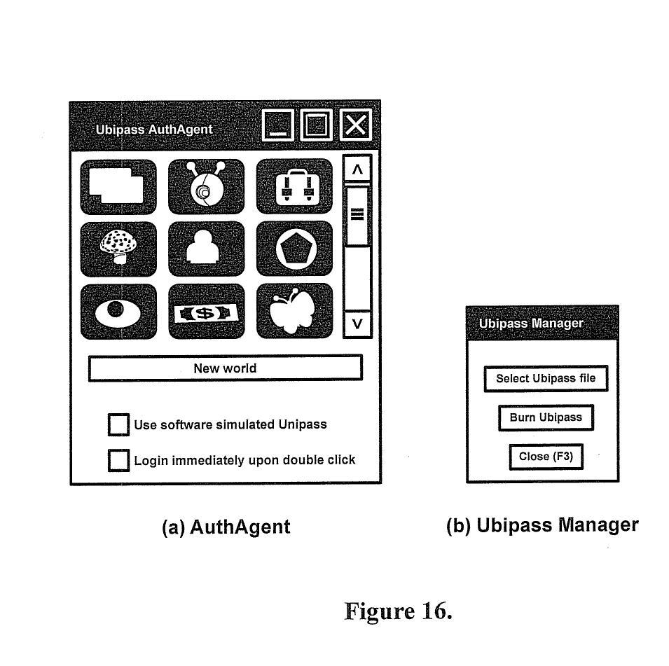

FIG. 16 shows how the AuthAgent software looks like. This software provides a unified user interface for a user to do identity validation at any application providers in the trust zone. Each application provider (see, e.g., Facebook, Second Life, Citibank, etc.) is represented by a card displayed in the GUI. By double-clicking on a card, the AuthAgent will launch the corresponding application program for you (e.g., open a login page in the Web browser, or launch an online game client software) and start the identity validation process. The user can then perform the identity validation with a piece of client device, Ubipass, which is a .NET smart-card based implementation of the Internet passport in this demo system.

In addition to the AuthAgent, the client software also includes a Ubipass Manager, which can either run as a stand-alone program or be spawned by the AuthAgent as an attached process. The Ubipass Manager is designed to operate the Ubipass through a smart-card reader. It can communicate with the AuthAgent through a UDP socket to support the identity validation. It can also be used as a stand-alone management tool for Ubipass, e.g., to burn the Ubipass or to change the password that protects the Ubipass.

6.1.6.2. Demo Application Provider.

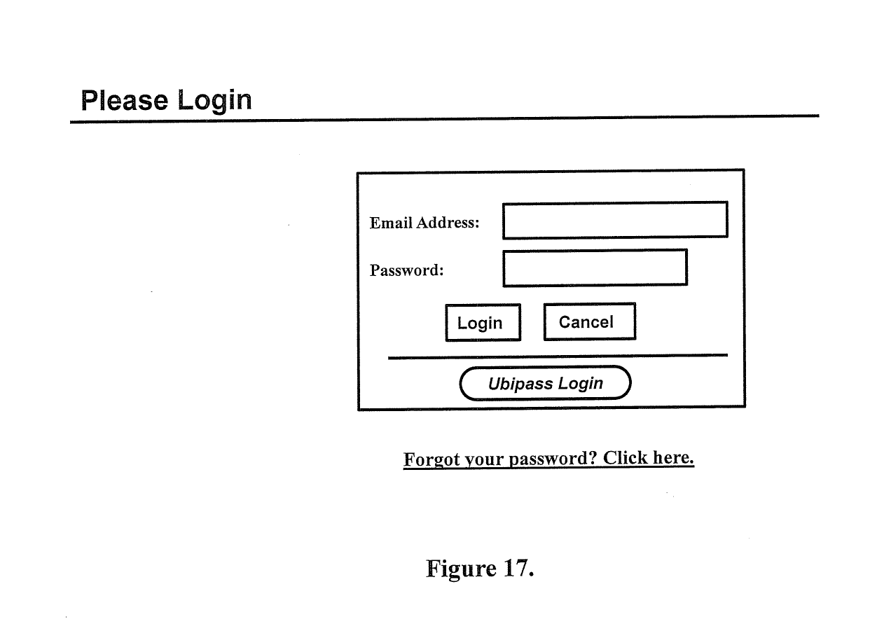

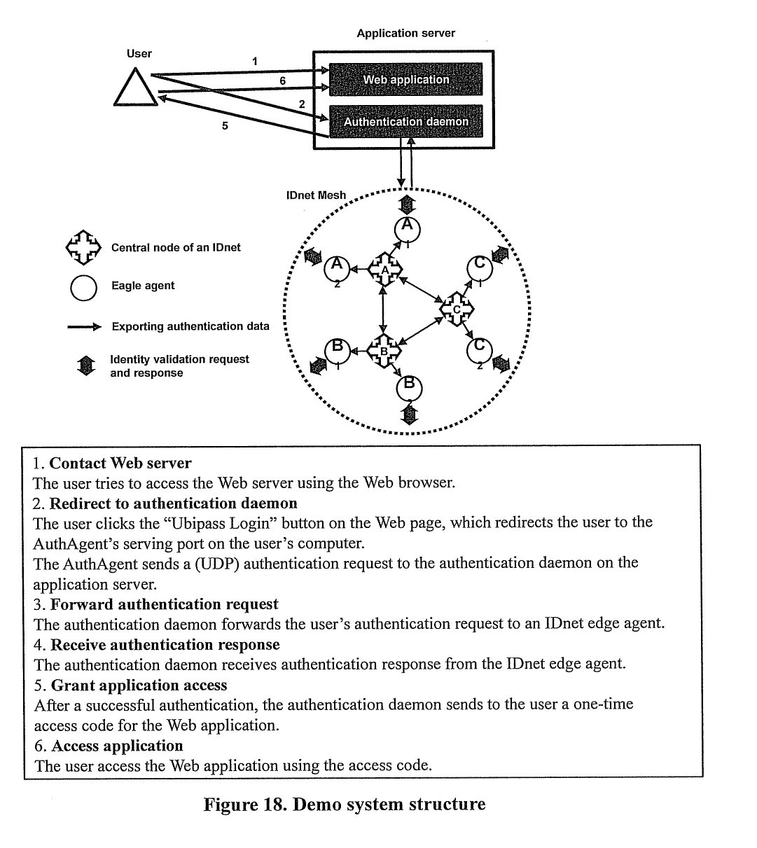

One of those cards in the AuthAgent's GUI corresponds to a demo application provider, which is a Web site that was created by one of the named inventors herein. By double-clicking on this card, the Web browser will open a login page of this site as shown in FIG. 17. A user can login to the site either in a traditional way, e.g., by typing an email address and a password, or alternatively, by clicking on the Ubipass Login button to accomplish the login without having to type anything. When the Ubipass Login button is clicked, the Web browser will send an HTTP request to the AuthAgent (working like a local Web server), which will in turn communicate with the authentication daemon (see FIG. 18) on a remote application server for the authentication.

6.1.6.3. Demo System Structure.

FIG. 18 illustrates the overall structure of this demo system. It also explains how the user authentication at the demo application provider is processed.

In addition to the user and the demo application provider, the system includes a demo IDnet Mesh system that consists of three IDnets IDnet A, IDnet B, and IDnet C. Each IDnet has two edge agents, and therefore there are a total of six edge agents in this IDnet Mesh system. The three central nodes and six edge agents of these IDnets are emulated on two physical machines. The two physical machines are connected through the local area network. The user can select any one of the six edge agents to perform the authentication (e.g., the identity validation).

6.1.6.4. IDnet Management Tool.

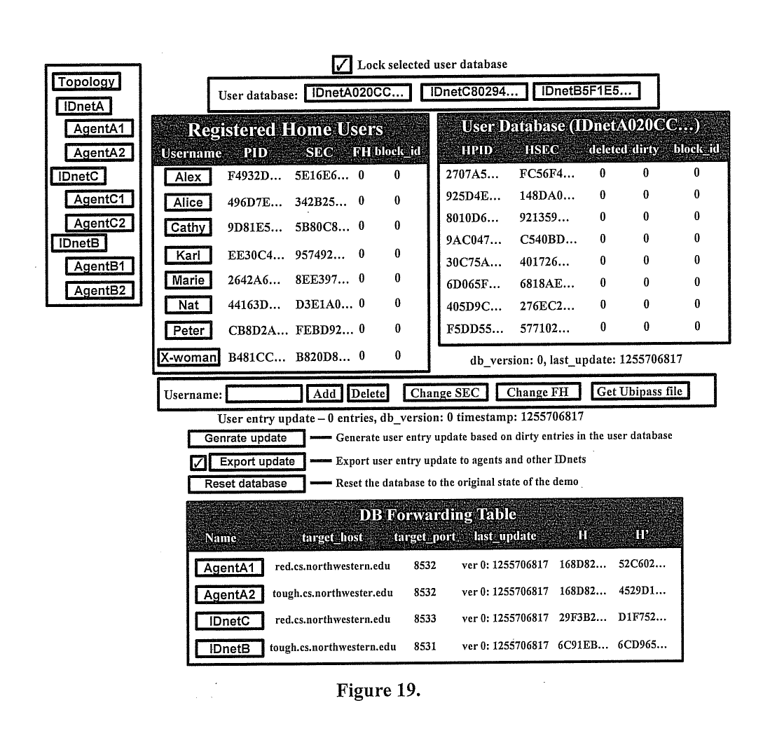

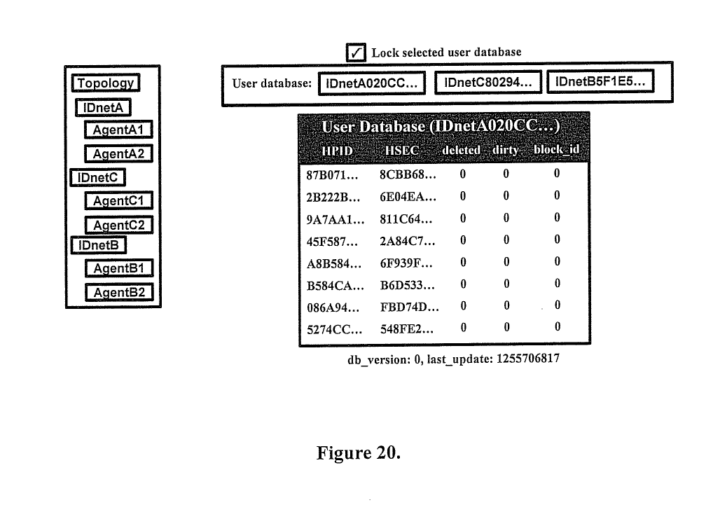

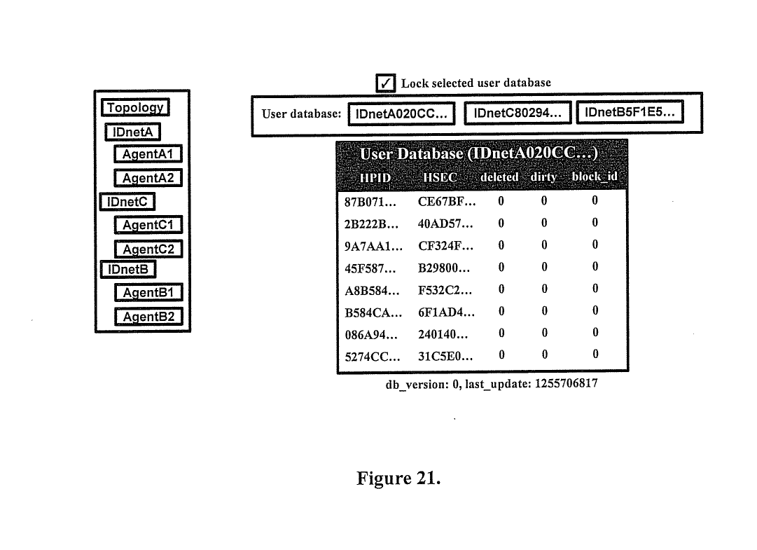

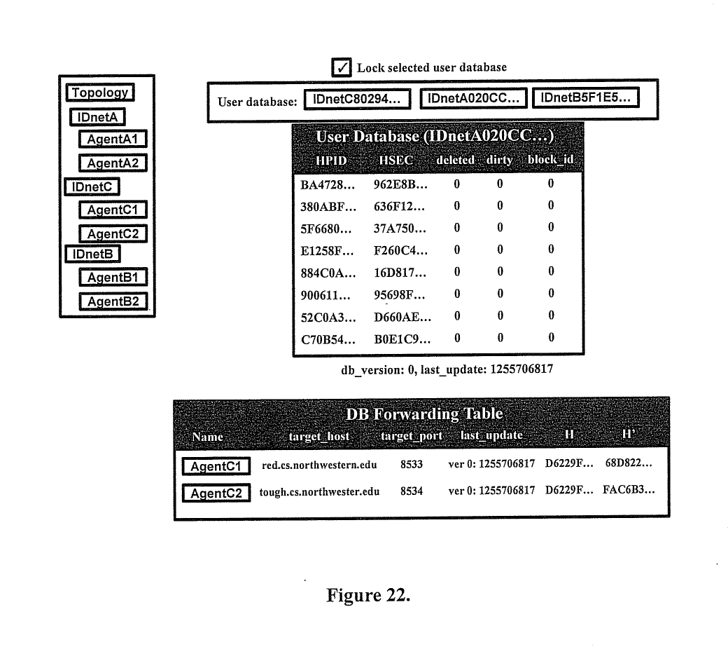

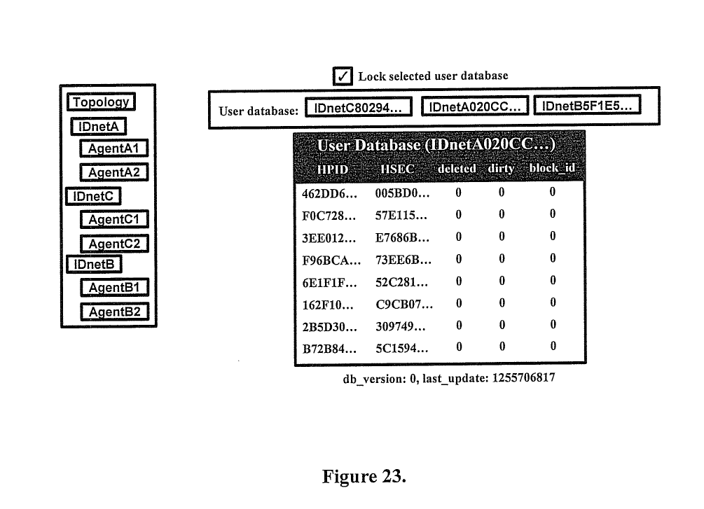

To manage this demo version of IDnet Mesh, a convenient Web-based tool was developed. FIGS. 19-23 show some examples of the Web interface of this management tool.

Consider FIG. 19, for example, which displays the Web interface for managing IDnet A's user database at IDnet A's central node. It shows the user database at the upper right part. Meanwhile, since this is the database for IDnet A's own users (e.g., home users), we can also do routine user maintenance through this interface, e.g., to register a new user, to change a user's SEC, or to change a user's first hash FH. In addition, it also allow us to download a Ubipass file of a specific user, with which we can burn the user's Ubipass hardware using the aforementioned Ubipass Manager software.

After the user data are modified locally, we can click on the Generate update button to create the user data update (see Section 2.6.1 and Section 6.1.4.1) and export the update to IDnet A's edge agents and to the remaining two IDnets. The lower part of the Web interface shows the database forwarding table, which tells how the user data update will be exported.

FIGS. 6.10 and 6.11 show the Web interface for monitoring the same user database at the two edge agents of IDnet A. Note that the two agents are exported with the same hashed version of HPID for the same user but different hashed versions of HSEC. FIGS. 6.12 and 6.13 show the Web interface for monitoring the same user database (e.g., that of IDnet A) at IDnet C's central node and edge agent.

6.2. Analytical Model Based Evaluation Methodology

In this section, the methodology to infer the bandwidth requirements for achieving the system's responsiveness upper bounds that was introduced in Section 4.4.1. is explained. As described in Section 4.4.2, the inference methodology is based on the analytical model of a very large scale IDnet Mesh system shown in Table 4.3. For convenience, Table 4.3 is replicated here as Table 6.10.

6.2.1. Message Dissemination Time.

From the analytical model, two equations are derived for computing the message dissemination time of IDnet system protocol (i) from an IDnet central node to all edge agents within the same IDnet, and (ii) from an IDnet central node to all edge agents of all IDnets within the trustee area.

Denote by B the goodput to transmit the IDnet system protocol messages over an Internet path. Denote by T₁ the time that it takes to disseminate a system protocol message from an IDnet central node to all edge agent servers within the same IDnet. Denote by S the message size. Denote by d the total queuing at each edge agent to forward the message to all the 100 edge agent servers. Using the topological model described in Table 6.10 we can get:

$${T}_{1} = 2 \times \frac{10 S}{B} + 2 D + d . \qquad ( 6.1 )$$

Here,

$$2 \times \frac{10 S}{B}$$

corresponds to the total transmission time, which is (i) the time to sequentially send the message from IDnet central node to the 10 level-1 agents plus (ii) the time to sequentially send the message from each level-1 agent to the 10 downstream level-2 agents. 2D corresponds to the total propagation delay for the two levels of communication channels.

For the value of d, suppose we use a linear logical topology for the message forwarding to the 100 servers at each edge agent. Assume the size of each packet is 1,500 bytes, and the transmission bandwidth between two servers is 10 MBps (which is a conservative assumption). Then the queuing delay of one packet is about 0.15 ms. Therefore, d becomes 100×0.15 ms=15 ms.

T₁ does not include the TCP connection establishment time. We can assume that the TCP communication channels between an IDnet central node and a level-1 agent, and between a level-1 agent and a level-2 agent, are pre-established and kept alive all the time. T₁ also does not include the processing time for hashing—when disseminating a user data update, we need to perform HMAC-SHA1 based hashing for each user entry carried in the message. However, the hashing can be performed at line speed, hence is ignored here. Suppose B=MBps, then the transmission time for each user entry is 4.4 μs. Whereas the time to hash a user entry is only 1.3 μs.

Denote by T₂ the time that it takes to disseminate a system protocol message from an IDnet central node to all edge agent servers of all IDnets within the trustee area. Then:

$${T}_{2} = \frac{6 S}{B} + 6 D + {T}_{1} = \frac{26 S}{B} + 8 D = d \qquad ( 6.2 )$$

TABLE 6.10
Topological model of a very large scale IDnet Mesh system

Description of the model
1. The structure of each IDnet is a two-level complete 10-ary tree,
that is, each IDnet has 10 level-1 agents as its children and each
level-1 agent has 10 level-2 agents as its children.
Therefore, each IDnet has 100 edge agents.
2. Each edge agent is a datacenter that consists of 100 servers.
Therefore, each IDnet has 10,000 edge agent servers.
3. Total number of IDnets in the IDnet Mesh is 40,000.
4. An IDnet can export hashed versions of authentication data to
other IDnets through up to L intermediate (cross-IDnet) hops.
L is set to 6.
5. Denote by D the one-way propagation delay on Internet paths
between two IDnets' central nodes, between an IDnet's central
node and each of its level-1 agent, or between a level-1 agent
and each of its downstream level-2 agent. D is set to 1 sec.
Rationale for the model parameter settings
Item 1 and 2 are set by referring to the largest replica server system
on the current Internet - Google platform (see, e.g., David Carr, “How
Google works”, Baseline Magazine, July 2006).
The Google platform has its servers distributed across tens of datacenters
across the world. Each IDnet is therefore set in the model to have a
comparable geographical span and number of servers as the Google
platform.
Item 3 is set by referring to the total number of autonomous systems
(AS) on the current Internet because an IDnet and an AS share the
similar administrative domain nature. According to the record of IANA,
there are about 40,000 ASes on the current Internet. The total
number of IDnets in this model is set to 40,000.
Item 4 is set by referring to the small world phenomenon (see, e.g.,
Henry Kautz, Bart Selman, and Mehul Shah, “ReferralWeb:
Combining social networks and collaborative filtering”,
Communications of the ACM, vol. 40, pp. 63-65, 1997), which
suggests a six degrees of separation between any two persons
in the world. Since the separation between two IDnets
should be less than that between two persons, the separation
upper bound L in this model is set to 6.
Item 5 is set based on typical propagation delays on Internet paths.
The typical propagation delay between two wired endpoints within
the same continent ranges from several ms to several tens of ms;
the typical propagation delay between two wired endpoints across
different continents can span up to several hundreds of ms.
D is conservatively set to 1 second.

Here

$$\frac{6 S}{B}$$

is the total transmission time for the cross-IDnet message forwarding for up to 6 hops. 6D is the total propagation delay for the cross-IDnet forwarding channels.

6.2.2. Bandwidth Requirement for User Data Update Message.

As described in Section 4.4.2, to achieve the two-hour responsiveness upper bound to user data changes. We ensure that a user data update created by an home IDnet can be disseminated to all IDnet edge agents in the trustee area within one hour. Here the minimum goodput B required to ensure this is evaluated.

Assume the following scenario for a home IDnet with 100 million users: (i) The Internet passport for each user expires after three years (similar to a credit card); therefore each user needs to renew the Internet passport every three years. (ii) On average, each user loses track of his or her Internet passport once during the three years such that the user has to reclaim the Internet passport once. (iii) To be conservative, it is assumed that on average each user has his or her user data updated 8 times for other possible reasons during the three years.

Based on the worldoad associated with the above scenario (e.g., 10 data changes every 3 years for each user) and the user data update message format shown in Section 6.1.4.1, we can get the message size S of each user data update paced at one-hour intervals to be 1.60 MB. Based on the representation of T₂ in Equation (6.2), the minimum goodput B can be computed as follows:

$$B = \frac{26 S}{{T}_{2} - 8 D - d} . \qquad ( 6.3 )$$

Letting T₂=1 hour, S=1.60 MB, D=1 sec, and d=15 ms, we can get the minimum goodput B=11.8 KBps. This means that for such a huge IDnet with 100 million home users and with the above workload for user data updates, to guarantee the two-hour responsiveness upper bound for the user data changes, we only need to ensure a goodput B of 11.8 KBps on each related Internet path for the user data update message initiated from this IDnet.

6.2.3. Bandwidth Requirement for System Broadcast Messages

As described in Section 4.4.2, to achieve the two-day responsiveness upper bound to system data changes, an IDnet ensures to disseminate all system broadcast messages to its edge agents within one day. To evaluate the minimum goodput B required to ensure this, assume an extreme case that the IDnet's trust and trustee areas include all the 40,000 IDnets. And consider the extreme case (no incremental updates) for the volume of the daily system data updates: (i) 100 agent entries for the 100 edge agents, (ii) a trust area update consisting of 40,000 trust area entries, (iii) a trustee area update consisting of 40,000 trustee area entries, and (iv) an endorsement update consisting of 40,000 endorsement entries. Based on the formats of system broadcast messages shown in Section 6.1.4.1, then the total size of the system broadcast messages S=39.9 MB. Based on the representation of T₁ in Equation (6.1), the minimum goodput B can be computed as follows:

$$B = \frac{20 S}{{T}_{1} - 2 D - d} . \qquad ( 6.4 )$$

Letting T₁=1 day, S=39.9 MB, D=1 sec, and d=15 ms, then the minimum goodput B=9.5 KBps.

6.3. Real Identity Binding Approaches

As introduced in Section 2.2.1, the assumption of the IDnet Mesh's model to enable the two types of accountability is that the home IDnet holds a user's real identity. More precisely, the word hold here actually means to bind a user's home account with his or her real identity rather than requiring the home IDnet to possess the user's real identity information. As long as each home account can map to a unique physical user, the binding is done. In this section, it is described how such real identity binding can be accomplished in practice.

6.3.1. Bootstrapping Real Identity Binding Via Existing Feeder

Let's call any organization that possesses a user's real identity the identity feeder, or feeder for short. In practice, there are a lot of feeders, for example: (i) a city clerk's office, (ii) any business that does real identity registration for their customers, e.g., a bank, a phone company, a cable TV company, an electric company, or (iii) any community that does rigorous identity verification for their members, e.g., a school (for the students), a company (for the employees), a conference Web site (for authors that have papers published), the PlanetLab community (see, e.g., “PlanetLab”, http://www.planet-lab.org/), etc.

An IDnet provider P can achieve real identity binding by exploiting existing feeders. For example, P can distribute Internet passports to users via the feeders. Each feeder will ensure that it gives only one Internet passport to each user and record the serial number of the Internet passport associated with each user. The user can then activate the Internet passport online, after which P will export the corresponding user data to the IDnet Mesh. Once an Internet passport has been distributed to a user such that P becomes the home IDnet of the user, no further involvement of the feeder is needed (unless a crime happens). The user will contact P directly for any user account maintenance service, e.g., to renew an Internet passport, to reclaim an Internet passport, or to change the SEC. The IDnet can use the (Internet passport based) identity validation to identify and validate each user for such maintenance service.

One subtlety here is for reclaiming the Internet passport. Since the context for reclaiming is that the user loses track of an Internet passport, hence he or she wants to revoke it and get a new one. Therefore, P cannot use the Internet passport based identity validation. To solve this, P may additionally issue each user a revocation code along with the Internet passport. The revocation code can be sealed, e.g., on a plastic card, for safety. When reclaiming the Internet passport, the user can unseal the card and show the revocation code to prove his or her identity. P may also have the user register some secret questions upon activating the Internet passport, such that answers to the secret questions can be used as a validation method to further improve the security.

Of course, a feeder itself can become a home IDnet if it wants to. In particular, take a cell phone company for example and consider using the cell phone (instead of a computer) as the user terminal. The Internet passport based approach is quite easy to deploy in this context since the company can simply embed the Internet passport functionality into the SIM card of a user's cell phone. Moreover, the user's computer might contact the cell phone through a Bluetooth or a USB interface, such that the user can perform identity validation for applications on the computer as well.

6.3.2. Real Identity Verification by IDnets Themselves.

In addition to exploiting existing feeders to bootstrap the real identity binding, it is also possible for IDnets to register users' real identities directly by themselves. The fundamental feasibility of this approach lies in that the IDnet Mesh actually provides a platform for different IDnets to trade accounts. Each IDnet only needs to create unique accounts for a small subset of users by performing rigorous verification on a user's real identity while it can acquire a large number of unique accounts by linking from other IDnets through the platform. For example, suppose there are 1000 IDnets; each IDnet creates 100 unique accounts by themselves and contributes them to the IDnet Mesh; as a result, each of them can acquire as many as 99,900 additional unique accounts in return. While creating unique accounts for all 100,000 users by an IDnet itself is an enormous job that few would think possible, to create unique accounts for only a small subset, e.g., 100 of the 100,000 users, is usually an achievable task. To perform the rigorous verification on a user's real identity at an IDnet, the following expediency may be adopted:

Assume that a user is applying for a home account at an IDnet provider that he or she trusts most. The provider can have the user fill out his or her real identity information online at the provider's website. In case of minors, this application is fulfilled by the user's parent or legal guardian. The provider mails to the user a paper-based application form. The form contains an unforgeable reference code and the real identity information that the user has provided. The user brings this form to a public notary agency that the provider recognizes to get his or her real identity information notarized. The user then mails the notarized form back to the provider to finish the application.

This expediency provides a high threshold against frauds. A misbehaving user has to forge a notary officer's signature and/or a notary agency's seal (which is a felony) in order to lie about his real identity. Meanwhile, the user has to use a real postal address of himself or someone that he knows (e.g., a friend) to receive the application form, which provides an effective clue to trace who he is.

There can also be other expediencies. For example, an identity assurance platform, MyID.is (see, e.g., “MyID.is”, http://www.myid.is/), uses the credit card statement as a tool to verify a user's real identity. It charges a random amount of fee (e.g., between $2 and $5) to the user's credit card. The user should submit the precise amount later when he receives the monthly statement to prove the credit card ownership, hence the real identity. Another similar site, Trufina.com (see, e.g., “Trufina”, http://www.trufina.com/), exploits public records databases to do the identity verification.

### 7. CONCLUSION

It is highly feasible to deploy an Internet-wide trust zone based on the described IDnet Mesh system: (i) The IDnet Mesh can provide the two types of user accountability for applications in the trust zone through a common identity validation service. (ii) The identity validation service is scalable to serve potentially billions of Internet users. (iii) The service preserves a user's pseudonymity, thereby protecting the user's privacy in the best practice. (iv) By exploiting the pseudonymous public keys based signature approach, the system can achieve strict non-repudiation for the identity validation service. (v) It is highly feasible to implement the smart-card based Internet passport for the proposed algorithm to counter identity theft. (vi) The system can guarantee to revoke a user's credentials from the entire IDnet Mesh and to disseminate authoritative system information to the public within a short time period even in the worst case. (vii) The IDnet Mesh system is DDoS resilient; meanwhile, it is also capable to protect application providers in the trust zone from DDoS attacks.

At a low level, the proposed pseudonymous public keys technique is in itself an substantial contribution to modern cryptography. Coupled with the cryptographic-hash-based approach, it offers the central enabling technology of the pseudonymous authentication. While the cryptographichash-based approach offers efficient prescreening for the authentication, the pseudonymous public keys enables non-repudiation for the authentication. As such, an Internet-wide user authentication solution that demands pseudonymity, high security, and high scalability all at the same time becomes feasible for the first time.

The present application makes reference to U.S. patent application Ser. No. 12/569,401, filed Sep. 29, 2009; U.S. Patent Application No. 61/103,672, filed Oct. 8, 2008; and U.S. Patent Application No. 61/351,721, filed Jun. 4, 2010. The above-referenced applications are hereby incorporated by reference herein in their entirety.

Certain embodiments of the invention may comprise a machine-readable storage having stored thereon, a computer program having at least one code section for communicating information within a network, the at least one code section being executable by a machine for causing the machine to perform one or more of the steps described herein.

Accordingly, aspects of the present invention may be realized in hardware, software, firmware or a combination thereof. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention. The computer program may be stored or executed from, for example, one or more nontransitory memory devices or one or more nontransitory storage devices.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

1. A method of authentication, comprising:
registering a first account at an identity provider;
providing authentication data including user's hashed permanent identifier and user's hashed secret code to a plurality of service providers from the identity provider, wherein user's permanent identifier and user's secret code are hashed using a different hash function, wherein each of the service providers receives a different user's hashed permanent identifier;
locally authenticating user's authentication request at the respective service provider that receives the user's authentication request;
securing the authentication data at the respective service provider such that the authentication data at the respective server can be used to verify the user's authentication request, but cannot be used to generate the user's authentication request; and
replicating the secured authentication data on replica servers associated with the respective service provider to improve online service scalability without compromising user's identity at the other service providers.

2. The method of claim 1, comprising creating a second account at the respective service provider.

3. The method of claim 1, comprising forming a trusted zone including the identity provider and the plurality of service providers, wherein a single registering of the first account with the identity provider allows access to services provided by the respective service providers.

4. The method of claim 1, wherein a user device comprises a memory and a processor, wherein the memory stores user's permanent identifier and user's secret code, and wherein the processor is configured to perform hash functions on the user's permanent identifier and the user's secret code.

5. The method of claim 4, wherein the user device is portable and USB-compliant.

6. The method of claim 4, wherein the user device includes a smart card and a smart card reader.

7. The method of claim 4, wherein the user device includes a biometric reader.

8. The method of claim 4, wherein the user device is configured to generate the user's authentication request.

9. The method of claim 1, wherein authentication data has been secured using pseudonymous public keys based authentication that enables authentication to achieve pseudonymity and non-repudiation at the same time.

10. The method of claim 1, wherein the first account that is registered at the identity provider becomes a master key with which to access the service providers.

11. A user authentication system, comprising:
an identity provider;
a plurality of service providers; and
a physical token that generates a user's authentication request,
wherein a first account is registered at an identity provider,
wherein the identity provider provides authentication data including user's hashed permanent identifier and user's hashed secret code to the plurality of service providers,
wherein user's permanent identifier and user's secret code are hashed using a different hash function, wherein each of the service providers receives a different user's hashed permanent identifier,
wherein the respective service provider, that receives the user's authentication request from the physical token, locally authenticates the user's authentication request at the respective service provider,
wherein the authentication data is secured at the respective service provider such that the authentication data at the respective server can be used to verify the user's authentication request, but cannot be used to generate the user's authentication request, and
wherein the secured authentication data is replicated on replica servers associated with the respective service provider to improve online service scalability without compromising user's identity at the other service providers.

12. The system of claim 11, wherein the respective service provider creates a second account at the respective service provider.

13. The system of claim 11, wherein a trusted zone is formed including the identity provider and the plurality of service providers, wherein a single registering of the first account with the identity provider allows access to services provided by the respective service providers.

14. The system of claim 11, wherein the physical token comprises a memory and a processor, wherein the memory stores user's permanent identifier and user's secret code, and wherein the processor is configured to perform hash functions on the user's permanent identifier and the user's secret code.

15. The system of claim 14, wherein the physical token is portable and comprises a USB interface.

16. The system of claim 14, wherein the physical token includes a smart card and a smart card reader.

17. The system of claim 14, wherein the physical token includes a biometric reader.

18. The system of claim 14, wherein each service provider has full control of every respective authentication transaction without the intervention of any third party while still using a network-wide single sign-on solution.

19. The system of claim 11, wherein authentication data has been secured using pseudonymous public keys based authentication that enables authentication to achieve pseudonymity and non-repudiation at the same time.

20. The system of claim 11, wherein the first account that is registered at the identity provider becomes a master key with which to access the service providers.
